(19) United States
(12) Patent Application Publication
(10) Pub. No.: US 2010/0096491 A1
(43) Pub. Date: Apr. 22, 2010

(54) ROCKET-POWERED ENTERTAINMENT VEHICLE

(75) Inventors: Granger Whitelaw, Red Bank, NJ (US); Michael R. D'Angelo, Orlando, FL (US); Peter H. Diamandis, Santa Monica, CA (US)

Correspondence Address: PEACOCK MYERS, P.C., 201 THIRD STREET, N.W., SUITE 1340, ALBUQUERQUE, NM, 87102, US

(73) Assignee: Rocket Racing, Inc., Orlando, FL (US)

(21) Appl. No.: 12/511,939

(22) Filed: Jul. 29, 2009

Related U.S. Application Data
(63) Continuation-in-part of application No. 11/932,698, filed on Oct. 31, 2007.
Application No. 11/932,698 is a continuation of application No. 11/875,745, filed on Oct. 19, 2007.
Application No. 11/875,745 is a continuation of application No. 11/538,014, filed on Oct. 2, 2006.
(60) Provisional application No. 61/084,345, filed on Jul. 29, 2008.
(60) Provisional application No. 61/096,244, filed on Sep. 11, 2008.

(51) Int. Cl. B64B 1/36; B64C 15/02; B64D 1/20; H04N 7/18; G08B 21/00

(52) U.S. Cl. 244/15; 244/73 R; 40/213; 725/75; 340/946

(57) ABSTRACT

A rocket-powered vehicle used for entertainment, namely races, exhibitions, competitions, and revenue-generating events.

### CROSS-REFERENCE TO RELATED APPLICATIONS

This application claims priority to and the benefit of the filing of U.S. Provisional Patent Application Ser. No. 61/084,345, entitled “Methods and Apparatuses for Construction, Operation and Use of Rocket Powered Aircraft”, filed on Jul. 29, 2008, and the specification thereof is incorporated herein by reference.

This application also claims priority to and the benefit of the filing of U.S. Provisional Patent Application Ser. No. 61/096,244, entitled “Multi-Role Rocket Powered Vehicle”, filed on Sep. 11, 2008, and the specification thereof is incorporated herein by reference.

This is also a continuation-in-part application of U.S. patent application Ser. No. 11/932,698 entitled “Collection and Distribution System”, filed Oct. 31, 2007, which is a continuation-in-part application of U.S. patent application Ser. No. 11/875,745 entitled “Rocket-Powered Vehicle Racing Reality System”, filed Oct. 19, 2007, which are continuations-in-part applications of U.S. patent application Ser. No. 11/538,014, entitled “Aerial Vehicle Racing Information System”, filed Oct. 2, 2006; and the specifications and claims of those applications are incorporated herein by reference.

### COPYRIGHTED MATERIAL

©2004-2006, Rocket Racing, Inc. A portion of the disclosure of this patent document and of the related applications listed above contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of Invention (Technical Field)

Embodiments of this invention relate generally to rocket-powered entertainment vehicles, racing competitions, display methods and systems related to racing competitions, and methods for generating revenue with respect to racing competitions. More particularly, embodiments of the present invention relate to rocket-powered vehicles and racing competitions comprising racing methods, rocket-powered vehicles, spaceports, methods of observer interaction, methods of pilot navigation, methods of providing separation between rocket powered vehicles, safety monitoring, adaptive display, and virtual participation in a rocket-powered vehicle racing competition and related apparatus. In addition, embodiments of the invention relate to integrated avionics and simulation systems that combine the real world with the virtual word in real-time, and allow for variable porting, such as a hybrid format, to a wide variety of viewing and interactive display formats and architectures.

2. Description of Related Art

Car racing is a well-established industry with such variants as the INDIANAPOLIS 500 races, NASCAR races and FORMULA-1 races. These racing competitions include a pre-specified car design, a specially designed track and direct viewing of the race by the general public in a stadium setting. Automobile races have been extremely successful in attracting very large corporate sponsorship and significant revenue from broadcast rights. These races have also lead to significant breakthroughs in automotive design and performance. Car racing, however, appeals to a limited audience that primarily comprises race enthusiasts.

Yacht racing is also a well-established industry with variants such as the LOUIS VUITTON AMERICA'S CUP competition. Similar to car racing, yacht racing competitions involve a pre-specified yacht design, a specially designed track and direct observation by the general public. Yacht races have also been extremely successful in attracting corporate sponsorship and significant revenue from broadcast rights, and have lead to significant breakthroughs in boating design and performance.

Manned rocket launches have traditionally been high visibility events that garner tremendous public interest beyond enthusiast groups, but which have never attracted significant sponsorships or media/broadcast rights. This is because rocket launches typically cannot be ‘scheduled’, as their actual launch time and date depend on when the payload and rocket are ready for deployment, and on weather conditions. Launch delays are commonplace and lead to great difficulty when scheduling network broadcast time. Networks may only pay for the broadcast of events that they know may occur as scheduled (e.g., football games, Olympic events, etc.). With regard to sponsorships, sponsors enjoy regularity and repeatability in the events that they sponsor (e.g., car races, golf classics, etc.). They also enjoy standardization in the event and in the location of their logos on the hardware or participants. They may require that the events have network coverage in order to extend the value of their sponsorship dollars to millions of viewers worldwide. Further, they desire that the events involve people (e.g., heroes) that participate in the events, which can make the launch of satellites by unmanned rockets uninteresting and inconsequential to the public.

Unfortunately, conventional manned rockets have been government owned and operated (e.g., the U.S. Space Shuttle and the Russian Soyuz), which do not actively market sponsorships. To promote the development and flight of rocket-powered vehicles able to provide low-cost commercial transport of humans into space outside of government sponsorship, the non-profit X PRIZE foundation has established the X PRIZE COMPETITION. The X PRIZE COMPETITION is a competition with a US $10,000,000 prize directed to jump starting the space tourism industry through competition between the most talented entrepreneurs and rocket experts in the world. The $10 million cash prize was awarded on Oct. 4, 2004 to Mojave Aerospace Ventures for being the first team that privately financed, built and launched a rocket-powered vehicle able to carry three people to 100 kilometers (62.5 miles), returned the rocket-powered vehicle safely to Earth, and repeated the launch with the same vehicle within two weeks.

FIG. 1 illustrates the X PRIZE COMPETITION. As shown, the winning team launches a manned rocket-powered vehicle 2 to an altitude greater than 100 km twice within a two-week period. Rocket-powered vehicle 2 may be launched at a location and a time of the respective team's choosing. The competition is a “first to accomplish” competition, in which the winning team is the first one to accomplish the established criteria. Although the X PRIZE COMPETITION is an excellent introduction into the realm of privately owned rocket-powered vehicles, it does not lend itself to public involvement in a competition atmosphere and to the marketing interest of other competitions, such as car racing and yacht racing competitions.

### BRIEF SUMMARY OF THE INVENTION

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 illustrates a prior art rocket-powered vehicle competition;

FIG. 2 illustrates a rocket-powered vehicle competition according to an embodiment of the invention;

FIG. 3 illustrates a method for racing rocket-powered vehicles in the rocket-powered vehicle competition of FIG. 2;

FIG. 4 illustrates a perspective view of a portion of a spaceport according to an embodiment of the invention for use with the rocket-powered vehicle competition of FIG. 2;

FIG. 5 illustrates a top-view diagram of the spaceport of FIG. 4;

FIG. 5A illustrates a portion of the spaceport diagram of FIG. 5;

FIG. 6 illustrates a rocket-powered vehicle according to an embodiment of the invention;

FIG. 7 illustrates a diagram of a flight system and a ground system according to embodiments of the invention;

FIG. 8 illustrates a diagram of the telemetry unit assembly of FIG. 7;

FIG. 9 illustrates a rocket-powered vehicle competition according to another embodiment of the invention;

FIG. 10 illustrates a method for racing rocket-powered vehicles;

FIG. 11 illustrates a top-view diagram of a portion of a spaceport according to an embodiment of the invention;

FIG. 12 illustrates a display for use with a spaceport;

FIG. 13 illustrates a telemetry computer according to an embodiment of the invention;

FIGS. 14A and 14B illustrate rocket-powered vehicle competitions according to embodiments of the invention;

FIG. 14C illustrates a top view diagram of a support station of a spaceport supporting the rocket-powered vehicle competitions of the present invention;

FIG. 15 illustrates a method for racing rocket-powered vehicles in the rocket-powered vehicle competitions of the present invention;

FIG. 16 illustrates a rocket-powered vehicle embodiment of the invention;

FIG. 17 illustrates another rocket-powered vehicle embodiment of the invention;

FIGS. 18A, 18B and 18C illustrate a rocket-powered vehicle with and without seeding its rocket plume;

FIG. 19 illustrates a display of a rocket-powered vehicle for use with the rocket-powered vehicle embodiment;

FIG. 20 illustrates a diagram of a spectator server for use with a rocket-powered vehicle competition of the invention;

FIG. 21 illustrates a spectator computing device for use with a rocket-powered vehicle competition of the invention;

FIG. 22 illustrates a flight vehicle with depictions of building blocks that enable the collection, capture, processing and display of data that merges the real world with the virtual, which can be used along with the rocket-powered vehicle competitions of the invention;

FIG. 23 illustrates a system level approach to data management using wireless telemetry links (capture, processing and display) beginning with airborne vehicles and migrating along multiple paths that can include delivery of such real-time information over the Internet to fans worldwide, which can be part of an integrated rangeless air racing maneuvering instrumentation system;

FIG. 24 illustrates a photograph of Spaceship One and White Knight from the X Prize Competition in October 2004;

FIGS. 25A, B, C and D illustrate views of a rocket-powered vehicle race of an embodiment of the present invention;

FIG. 26 illustrates connectivity of technology modules for cockpit-based and ground-based augmented reality systems;

FIG. 27 illustrates the cockpit-based augmented reality system;

FIG. 28 illustrates the ground-based augmented reality system;

FIG. 29 illustrates a block diagram of an embodiment of the present invention;

FIG. 30 shows a rocket-powered plane or vehicle of the present invention;

FIG. 31 shows a wingless rocket-powered vehicle of the present invention;

FIG. 32 shows a back view of a rocket-powered vehicle comprising propellant storage and delivery components;

FIG. 33 shows a side view of a rocket-powered vehicle of the present invention comprising spherical netting for a spherical propellant storage tank;

FIG. 34 shows a front view of the spherical netting;

FIG. 35 illustrates an embodiment of the present invention comprising a rocket plane secured in an upright position on a trailer;

FIG. 36 shows a side view of a rocket-powered vehicle being secured and transported in a tilted position on a trailer;

FIG. 37 shows propellant tanks attached to a rocket-powered vehicle of the present invention;

FIG. 38 shows a rocket-powered vehicle of the present invention in flight;

FIG. 39 shows a top perspective view of a rocket-powered vehicle of the present invention;

FIG. 40 shows a back perspective view of a rocket powered vehicle of the present invention;

FIG. 41 illustrates a graph of a propellant load with 1400-lbm and no throttle back of the present invention;

FIG. 42 illustrates a graph of a propellant load with 1400-lbm and throttle back after boost and climb of the present invention;

FIG. 43 illustrates a graph of a sled test of the present invention;

FIG. 44 illustrates a graph of fuel pressure, liquid oxygen (LOX) pressure, and chamber pressure over time of the present invention; and

FIG. 45 illustrates rocket-powered vehicle of the present invention.

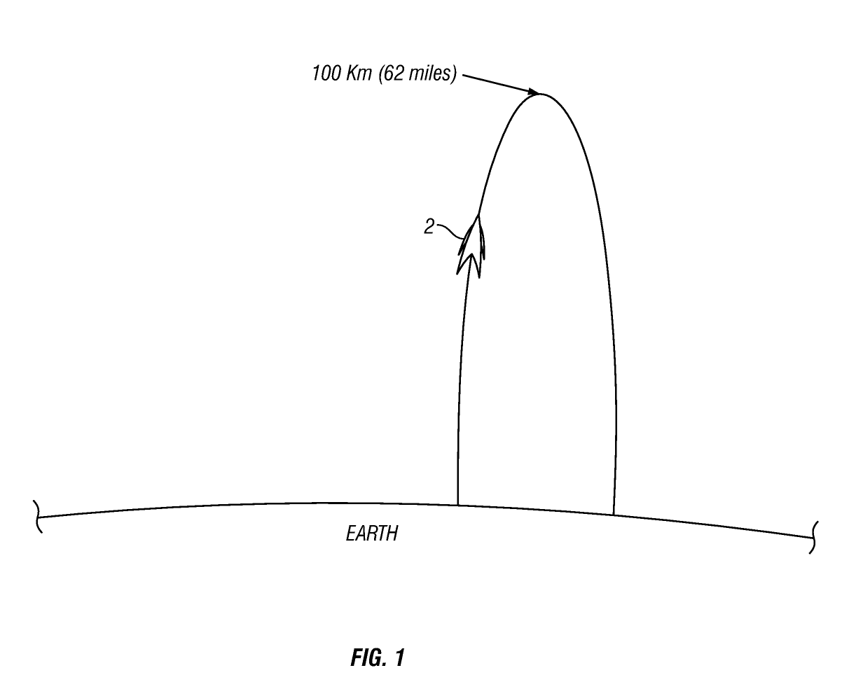

### DETAILED DESCRIPTION OF THE INVENTION

The various aspects of the invention may be embodied in various forms. The following description shows, by way of illustration, various embodiments in which aspects of the invention may be practiced. It is understood that other embodiments may be utilized and structural and functional modifications may be made without departing from the scope of the present invention.

The term “aerial vehicle” as used throughout the specification and claims is intended to include any and all vehicles capable of traveling through air or through space, including but not limited to airplanes, rockets, jet-powered aircraft, rocket-powered aircraft, rocket-powered vehicles, combinations thereof, and the like.

For purposes of the specification and claims, “rocket plane” or “rocket-powered vehicle” is defined as an airborne vehicle comprising a rocket, including but not limited to space shuttles, spaceships, rocket ships, space vehicles, air ships, and combinations thereof. Although the descriptions herein relate to rocket-powered vehicles, the invention is also useful for other aerial vehicles.

The term “video” as used throughout the specification and claims includes any type of motion picture, including but not limited to those stored on digital and analog mediums.

### INDUSTRIAL APPLICABILITY

The invention is further illustrated by the following non-limiting examples.

### Example 1

### Rocket-Powered Vehicle Competition

Although multiple embodiments of the present invention describe a preferred minimum height of 100 km, the multiple embodiments of the present invention are not to be construed as limited to this height. Rather the multiple embodiments of the present invention can comprise any distance from about 1 km to about 250 km, or any other distance further described herein. In embodiments of the present invention, this distance is preferably from about 255 km to about 200 km and more preferably from about 50 km to about 150 km. Further, the term “rocket” as used throughout the specification and claims is used to maintain simplicity and is intended to include not only rocket-powered vehicles, but also jet-powered and propeller driven vehicles. In addition, disclosures made herein relating to rocket fuel or its components are also intended to include jet fuel, or any other vehicle fuel, and/or their components. Although embodiments of the present invention preferably relate to manned vehicles, unmanned and/or remote-controlled vehicles also provide desirable results.

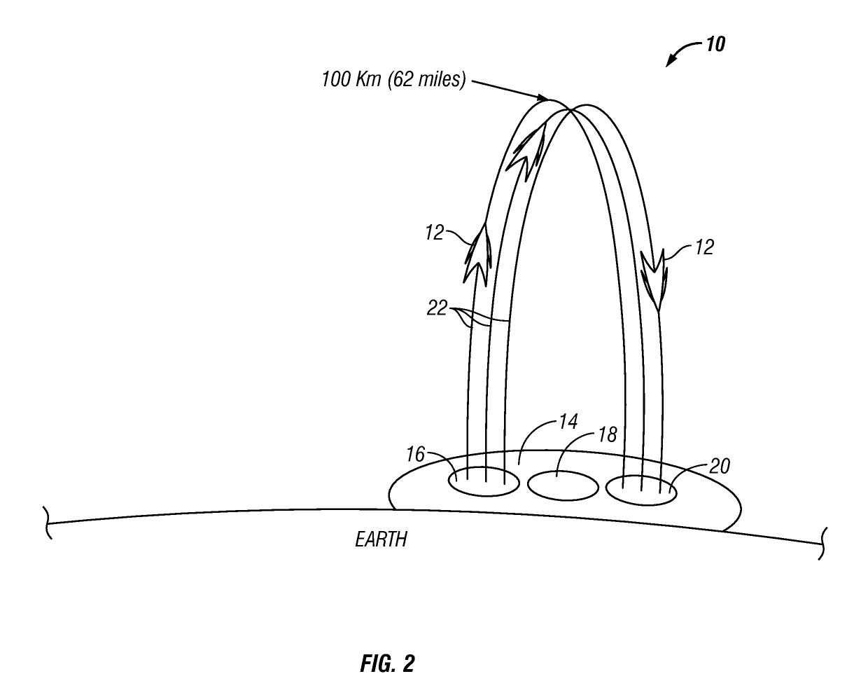

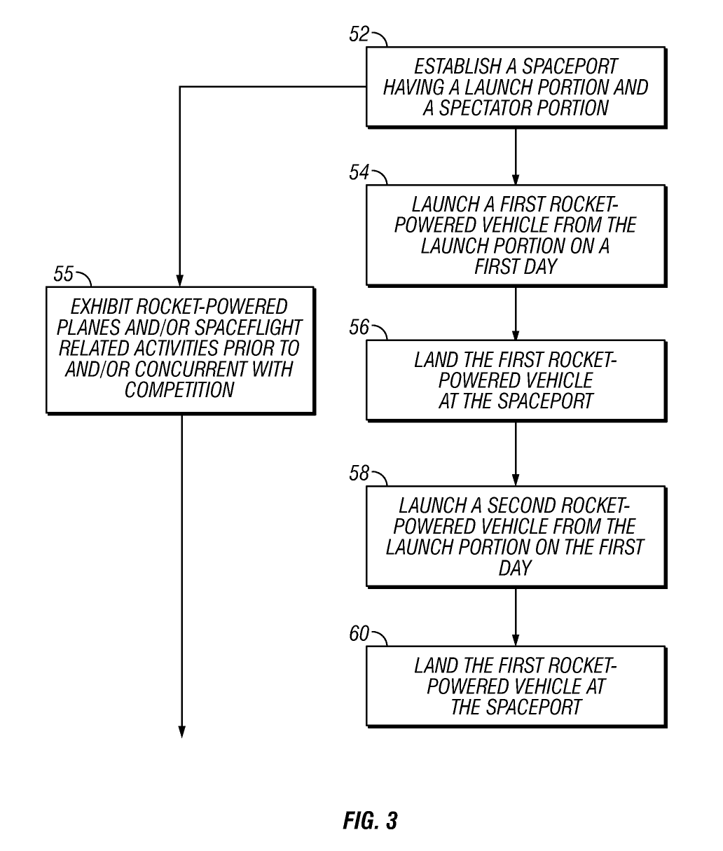

Referring now to FIGS. 2 and 3, rocket-powered vehicle competition 10 and block diagram of FIG. 3 for racing rocket-powered vehicles are generally shown according to an embodiment of the invention. As illustrated in FIG. 2, rocket-powered vehicle competition 10 generally comprises rocket-powered vehicles 12 and spaceport 14 having launch portion 16, spectator portion 18 and landing zone 20. During competition with each other, rocket-powered vehicles 12 follow flight paths 22, which may include generally parabolic trajectories or other trajectories as appropriate.

An embodiment of the present invention relates to rocket-powered vehicle competition wherein two or more rocket-powered vehicles race. FIG. 3 illustrates a block diagram according to an embodiment of the invention for racing rocket-powered vehicles that comprise portions which optionally occur as part of a rocket-powered vehicle competition. The term “racing”, as used herein, refers to a plurality of rocket-powered vehicles or teams competing according to pre-determined criteria.

The following is one embodiment for practicing a rocket-powered vehicle competition. In this embodiment, the competition may occur as a periodic event occurring at a single spaceport, or it may also or alternatively occur at other intervals and at a plurality of spaceports. Winners of the competition may be presented with cash awards and a trophy, which can optionally be held by the winning team until the next competition. A panel of judges (not shown) may oversee the competition to make sure the rules of the competition are being upheld by participants.

A panel of judges (not shown) may be in charge of scoring during the event. The panel of judges may authorize teams of one or more rocket-powered vehicles 12 to enroll in the competition based on certain pre-determined criteria discussed later. Each team may have one or more rocket-powered vehicles 12 and associated crewmembers with which to perform racing activities.

The panel of judges may include an odd number of independent judges, and the total number of judges each year may be twice the number of teams registered plus a chief judge. The chief judge preferably oversees and coordinates the activities of the judges and reports the results. Any decision rendered by not less than two thirds of the judges may be final and binding on the teams. The timing of the appointment of judges may be 60 days before the first launching day of the competition.

The judges may monitor all flight attempts and vehicles during the competition, and the teams optionally agree to cooperate fully with the judges in monitoring flight attempts and competition requirements. Any challenge to a judge's independence or impartiality is preferably deemed waived by the parties if not made timely and prior to 30 days of the event. The judges should be unbiased and not belong or be affiliated with any of the competing teams.

In one embodiment of the present invention, the panel of judges is optionally in charge of taking necessary measurements during the competition in order to evaluate each team's progress. If a team wishes to make an appeal of a decision made by the judges, they may fill out a redress form within one hour of that decision. A hearing may be held for the requests one hour after the landing of the last launch of that day.

The following describes an optional set of rules for the competition according to an embodiment of the present invention. This set of rules can of course be altered to provide more desirable results for alternative embodiments of the present invention as will be observed by those skilled in the art upon practicing the present invention.

In an embodiment of the present invention, all stages of each team's rocket-powered vehicle preferably return and safely land within a landing zone. Failure to do so may result in the respective team's disqualification from the flight.

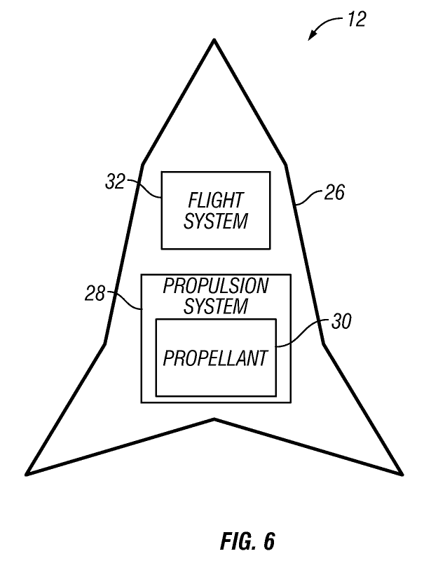

In one embodiment of competition 10, the terms “vehicle,” “ship,” or “rocket-powered vehicle” refers to all stages or parts of the launch system (e.g., tow vehicles, balloons, descent chutes, etc.). Exemplary rocket-powered vehicles 12 are described later along with FIG. 6.

In an embodiment at the present invention, judges may postpone launches due to weather conditions, accidents or hazardous situations at their discretion. Judges may declare the duration of postponement within five minutes. The Judges may provide an update half way through the postponement with an option to end the postponement or declare an extension.

In an embodiment at the present invention, in advance of the competition, all teams may submit the weather condition restrictions of their vehicles they deem safe and unsafe to launch. A team can petition the judges for a launch delay due to weather, however, the judges may base their decision on the weather conditions submitted in advance by the team.

### Example 2

### Rocket Powered Vehicle

Referring now to FIG. 6, rocket-powered vehicle 12, according to an embodiment of the present invention, is illustrated for use with rocket-powered vehicle competition 10 and the block diagram of FIG. 3. Rocket-powered vehicle 12 is a human-carrying, rocket powered, reusable vehicle, which may include aviation stages (not shown) and is capable of traveling at supersonic speeds. A significant portion of a flight for rocket-powered vehicle 12 should be powered by rocket engines, such as the take-off portion of flight. Each team may provide a document that describes the general nature and configuration of its vehicle, propellants, vehicle non-propellant mass, take-off and landing modes, and its intended flight plans.

As shown in FIG. 6, rocket-powered vehicle 12 generally comprises vehicle 26, propulsion system 28 comprising propellant 30, and flight system 32. Vehicle 26 is capable of carrying one or more human occupants (not shown) during flight. Flight system 32 monitors and/or controls flight conditions. Propulsion system 28 provides rocket-propulsion to vehicle 26 via propellant 30. Propellant 30 may include a variety of rocket fuels, such as an oxidizer (e.g., liquid oxygen, nitrogen tetroxide, nitrous oxide, air, hydrogen peroxide, perchlorate, ammonium perchlorate, etc.) plus a fuel (e.g., light methane, hydrazine-UDMH, kerosene, hydroxy-terminated polybutadiene (HPTB), jet fuel, alcohol, asphalt, special oils, polymer binders, solid rocket fuel, etc.).

Sensors 36 optionally include a variety of sensing equipment such as accelerometers, altimeters, velocimeters, gimbals, transponders, global positioning systems (GPS) and position sensors, etc., which may include one or more cameras 38, for recording and/or transmitting images during flights. Cameras 38 may be positioned to view both inside and outside vehicle 26. For instance, cameras 38 may be directed toward crewmembers inside vehicle 26 and down toward the earth. Mode switches 40 may be used as necessary to select data feeds received from various sensors and provide it to recording equipment (not shown) or to transmitter 42 for transmission to ground system 44.

In embodiments of the present invention, each team of the competition may carry telemetry unit 34 on any of their competing rocket-powered vehicles. Telemetry unit 34 preferably provides an integrated device that is independently calibrated and verified before and after qualifying flights. Each telemetry unit 34 may receive data from at least two externally mounted cameras 38 and two internally mounted cameras 38, and is preferably connected to associated video recording hardware (not shown) and transmitting hardware. The telemetry unit weight and volume may be counted towards the crew requirement mass if desired.

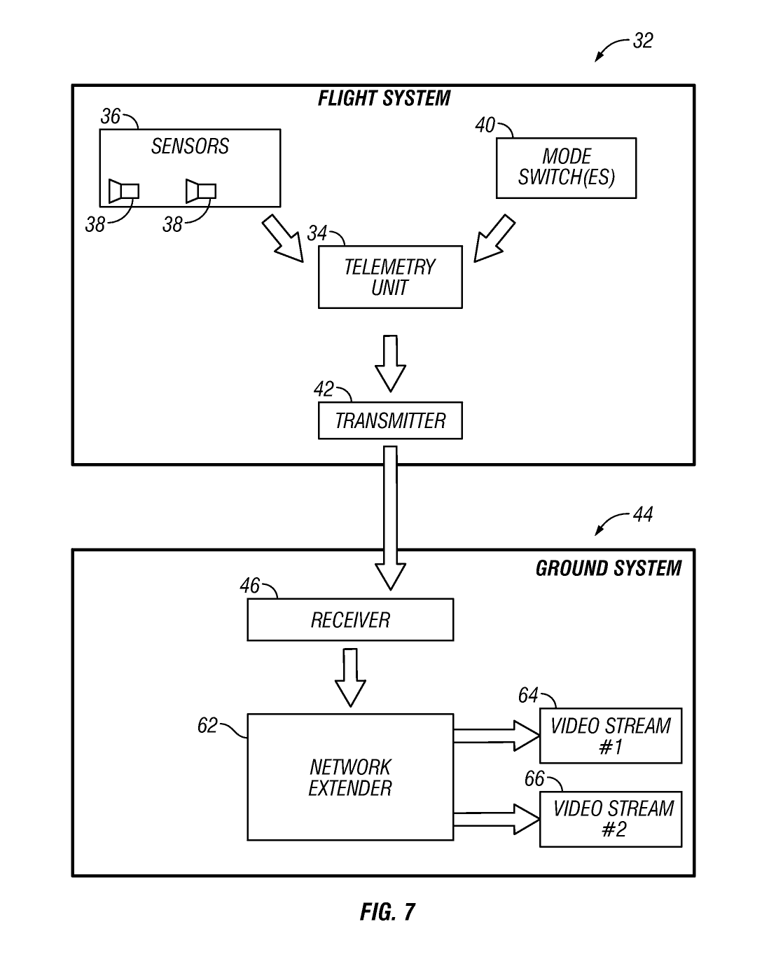

As shown in an embodiment of the present invention illustrated in FIG. 7, data may be sent from rocket-powered vehicle 12 to ground system 44 via transmitter 42, which may be a C-band omni-directional transmitter or other RF transmitter. Transmitter 42 may be directed to receiver 46 of ground system 44, including but not limited to, a C-band satellite dish, to provide substantially real-time monitoring of flights. Receiver 46 may be mounted on an antenna gimbal (not shown) to permit it to track rocket-powered vehicles 12 during flight for strong reception of signals transmitted therefrom. Network extender 62 converts the signals received, which may be two or more video streams 64 and 66. For example, two or more Electrical Ground Support Equipment (EGSE) video streams may be provided during flights of rocket-powered vehicles 12.

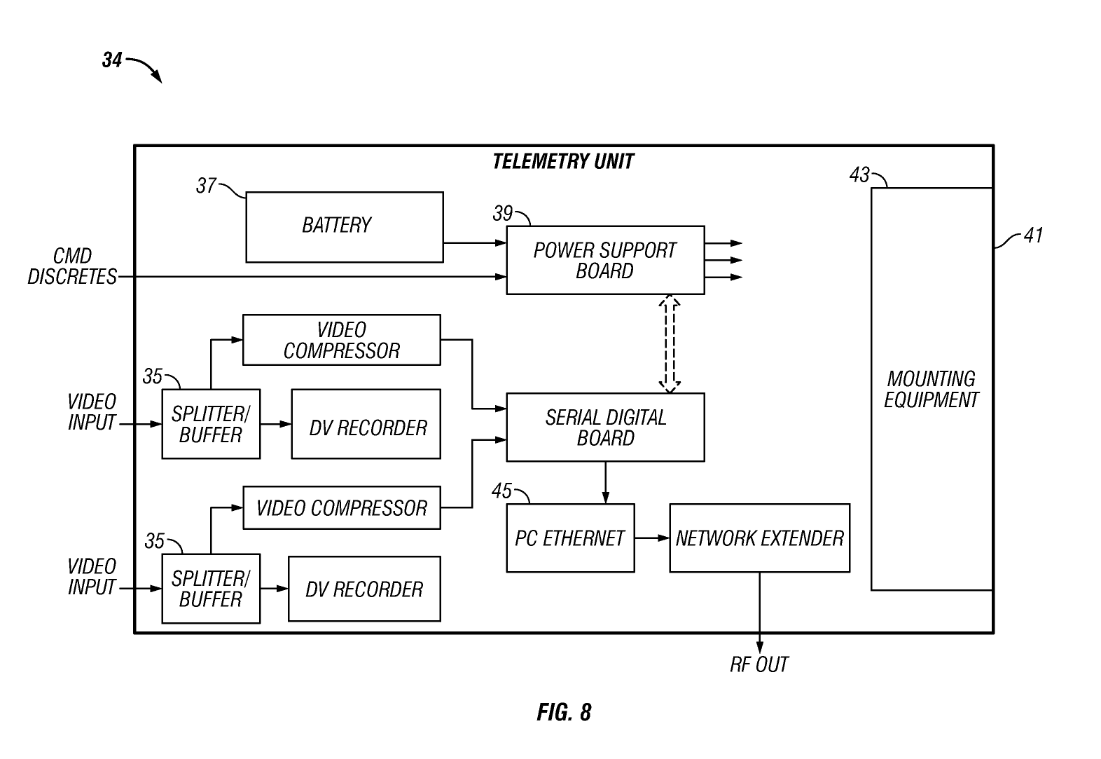

FIG. 8 illustrates an embodiment of the present invention wherein telemetry unit 34 is preferably used with flight system 32. Telemetry unit 34 is a substantially integrated unit with its own power supply 37 that can receive data from sensing equipment, process the data, store it and provide outputs to external equipment. The power supply may be 28V battery 37 that powers power support board 39, which in turn provides power of various voltages to processing equipment (e.g., CPU) (not shown). Telemetry unit 34 may include chassis 41, such as a U-slot chassis, for containing the components of the telemetry unit, which may be conduction-cooled to reduce power consumption requirements compared with a fan-cooled system. Chassis 41 may be connected to mounting equipment 43 that is preferably standardized for installation in any of rocket-powered vehicles 12, such as 19″ rackmount equipment. Telemetry unit 34 receives inputs from sensing equipment, such as video feed from cameras 38 (see FIG. 7), which it processes and/or stores. For instance, it may convert video feed from cameras 38 into a compressible digital format (e.g., MPEG), which is optionally stored in a digital video recorder and transmitted to ground system 44 (see FIG. 7). Telemetry unit 34 may connect with flight system 32 of the respective rocket-powered vehicle to receive appropriate command inputs and provide outputs, such as RF video output. Telemetry unit 34 may include a network interface, such as PC Ethernet card 45, for interfacing with the flight system and/or for providing data to the judges at completion of qualifying flights.

### Example 3

### Spaceport

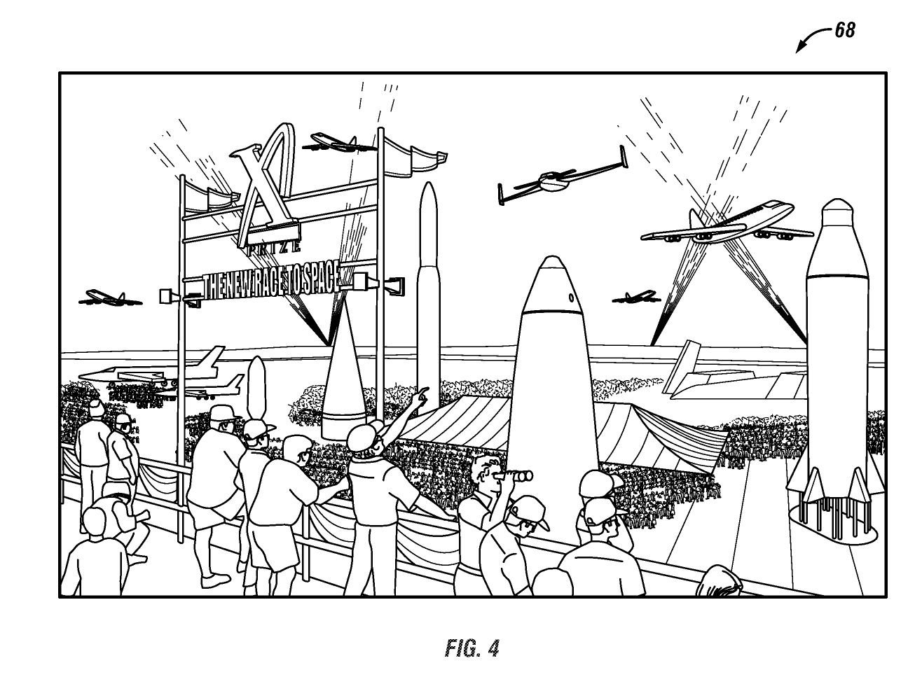

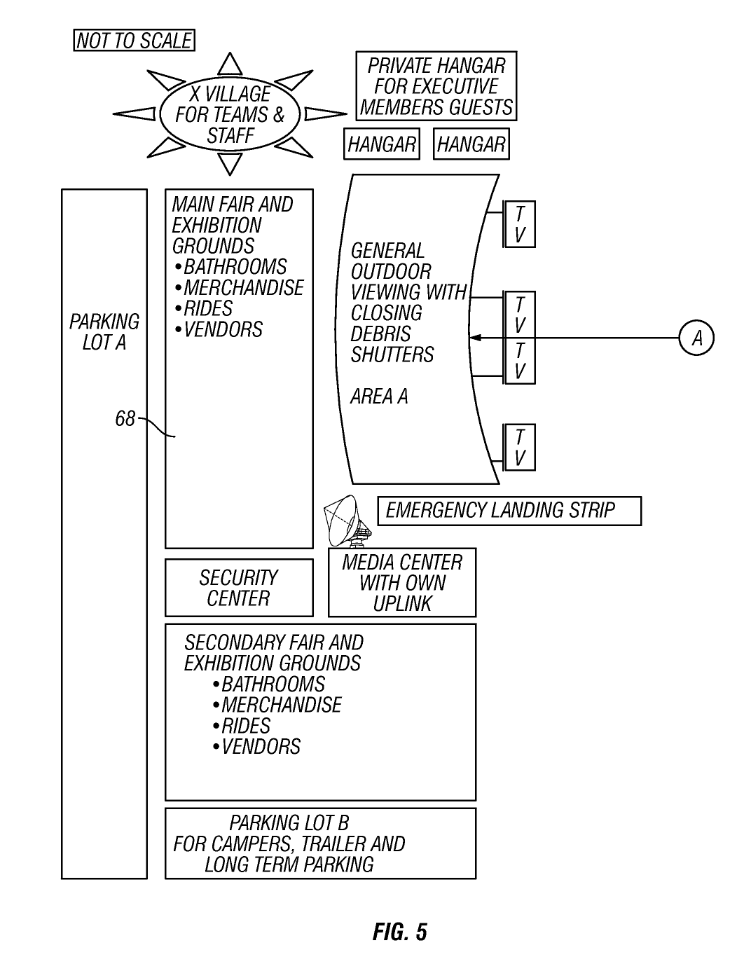

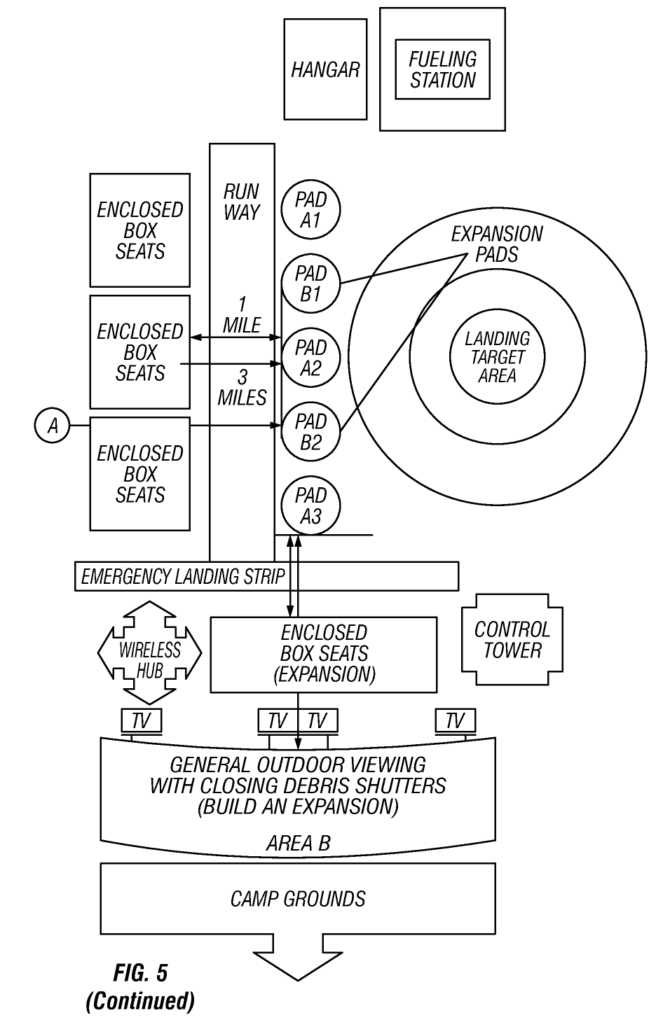

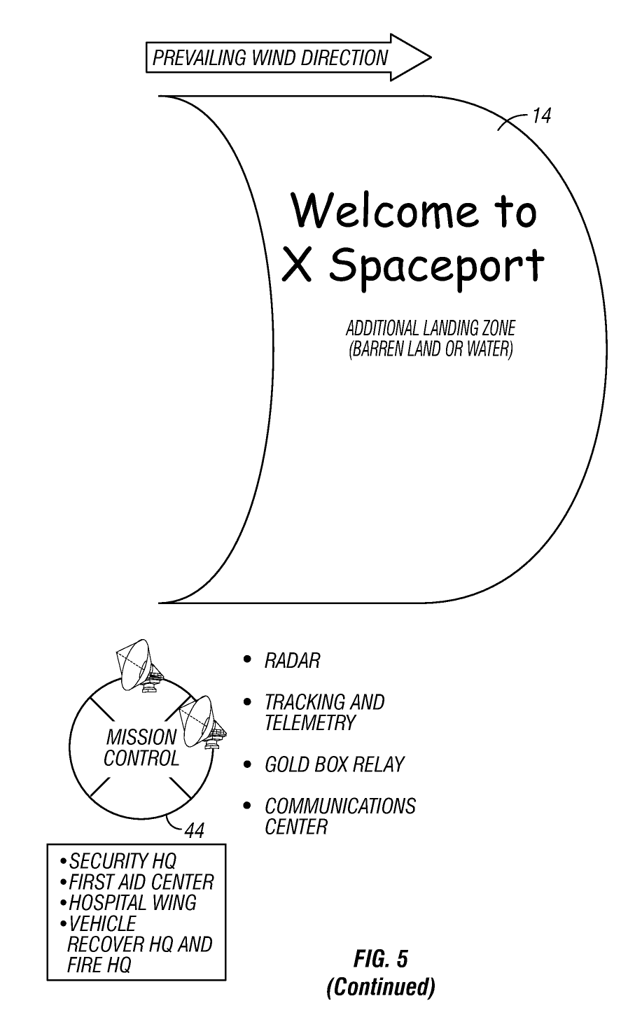

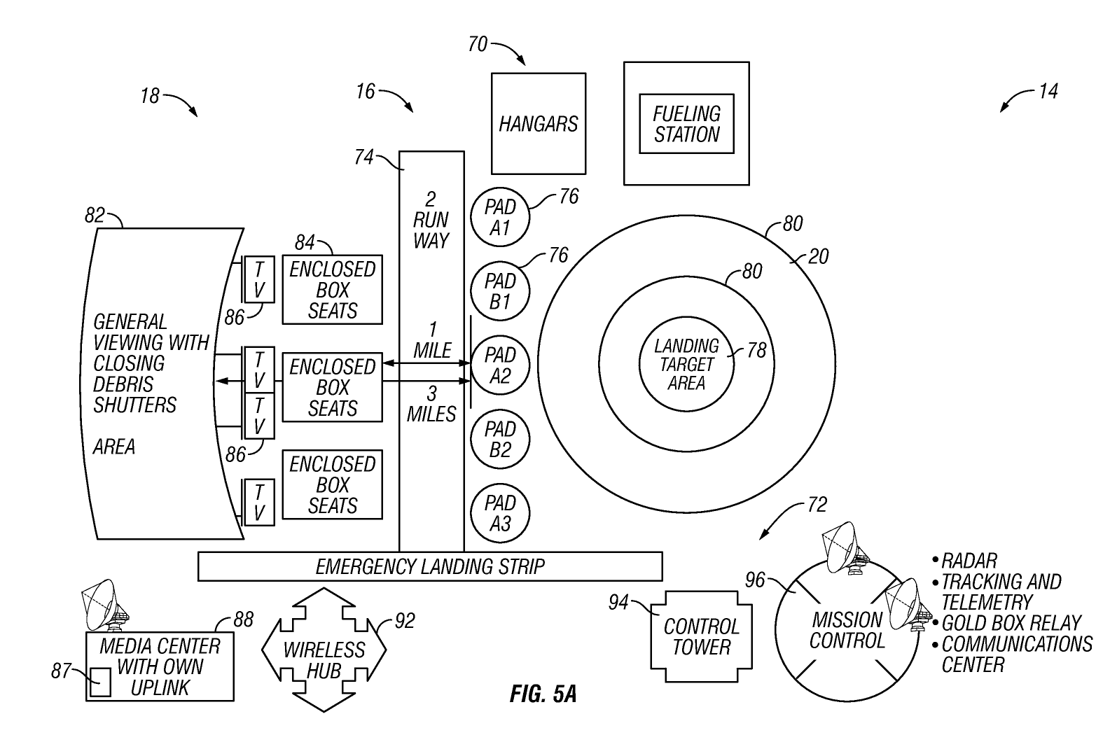

Referring now to FIGS. 4, 5 and 5a, spaceport 14 is generally illustrated. In this embodiment of the present invention, spaceport 14 provides a pre-determined location from which rocket-powered vehicles 12 can takeoff and land, and from which spectators may view rocket-powered vehicle competition 10. FIG. 4 is a perspective view of fair and exhibition grounds portion 68 of spaceport 14, which permits spectators to evaluate exhibits and view takeoff and/or landing of rocket-powered vehicles 12 occurring in distant portions of spaceport 14. FIG. 5 is top-view diagram of spaceport 14, and FIG. 5A shows portions of the diagram of FIG. 5. Spaceport 14 may be located in a remote area, such as in the deserts of Nevada and/or New Mexico, in which an exclusive, controlled airspace may be maintained during rocket-powered vehicle competition 10.

In the embodiment of the invention illustrated in FIG. 5A, spaceport 14 generally comprises launch portion 16, spectator portion 18, landing zone 20, maintenance/storage areas 70, and control facilities 72. Launch portion 16 may include two-way runway 74 to permit rocket-powered vehicles 12 to launch that use winged aircraft for takeoff, and for landing winged aircraft as needed. Launch portion 16 also comprises pads 76 from which vertical takeoff of rocket-powered vehicles 12 may occur. Landing zone 20 optionally comprises landing target area 78 with target overshoot areas 80. As discussed above, competitors may be evaluated on how close they land their respective rocket-powered vehicle 12 to a target (e.g., bulls eye marker (not shown)) located within landing target area 78.

Spectator portion 18 may include a variety of facilities and areas that are appropriate for the general public, such as fair grounds, exhibition grounds, campgrounds, etc. Further, spectator portion 18 may include viewing facilities located close enough to launch portion 16 and landing zone 20 to permit direct viewing of rocket-powered vehicles 12 as they takeoff and land during competitions. Spaceport 18 preferably comprises general viewing area 82 and box seats viewing area 84. General viewing area 80 is preferably located a relatively safe distance from launch pads 76 and landing zone 20. Viewing area 82 may be located about two to five miles from launch pads 76, and for better viewing, general viewing area 82 may be located from about two to five miles from launch pads 76. From these distances, spectators can directly view the launch of rocket-powered vehicles 12 with or without viewing aids (including but not limited to binoculars) without significant risks from launch failures. Viewing area 80 may be located a greater distance from landing zone 20 than from launch portion 16 due to the generally increased safety risk associated with landing rocket-powered vehicles 12 compared with launching them. To further enhance safety, general viewing area 82 may include debris shutters (not shown), which may be closed quickly in the event of an actual or anticipated unsafe incident (e.g., rocket-powered vehicle crash).

Box seats viewing area 84 is preferably located closer to launch portion 16 and landing zone 20 than general viewing area 80, which increases the risk to the spectators located in this area. As such, box seats viewing area 84 may be enclosed to protect spectators therein, and may provide viewing via view ports made of shatter-resistant transparent materials. To enhance viewing in spectator portion 18, televisions 86 may be provided that show close views of rocket-powered vehicles 12 during launch and landing or at other times, and to show information about competition 10. Televisions 86 may also show substantially real-time status of rocket-powered vehicles 12 during the competitions. For example, televisions 86 may show a graphical representation of a competing rocket-powered vehicle 12 at its present location as it advances along its flight path 22 so that spectators may monitor its progress as it occurs. This information may be obtained via information acquired by the rocket-powered vehicle's telemetry unit 34 (see also FIG. 8). Televisions may also show views from cameras 38 on respective rocket-powered vehicle 12. FIG. 8 also shows details of one embodiment of telemetry unit 34 including but not limited to: splitter buffer 35, battery 37, power support board 39, PC Ethernet 45, and monitoring equipment 41 and 43.

Information shown on televisions 86 may be provided from media center 88 and/or from mission control 96 (discussed later). Media center 88 processes and collates information for display on television 86 and for providing it to spectators at other locations, media outlets, etc. As such, media center 88 may have its own satellite uplink (not shown) for sharing information related to rocket-powered vehicle competition 10. Media center 88 may include a server or other computer 87, which creates graphical representations of the status of rocket-powered vehicles 12 in relation to their flight paths 22, other rocket-powered vehicles, and/or virtual pylons. The term virtual pylon as used herein means a three-dimensional location above the earth's surface. For example, a three-dimensional location may be identified by the judges (e.g., 3-dimensional geographical coordinates for a point in space) as a virtual pylon that rocket-powered vehicle 12 should encounter within a given distance in order to meet a criterion of passing through the virtual pylon. Computer 87 may use location information provided by telemetry units 34 of each rocket-powered vehicle 12 via ground system 44 to provide substantially real-time status and location information to the spectators. Media center 88 may also provide information to a wireless hub 92 for dissemination to spectators located at spaceport 14 and/or for transmission to others via the Internet. For example, spectators may be able to access information personally that is provided on televisions 86 and/or other information via wireless hub 92. For instance, a first spectator may be able to monitor progress of a first team via wireless hub 92 while a second spectator monitors progress of a second team via wireless hub 92. In one configuration, televisions 86 display a virtual crash when a team fails to maneuver around a required virtual pylon.

Much of the information provided to spectators is preferably provided via control facilities 72. Control facilities 72 include control tower 94 and mission control 96. Control tower 94 provides a birds-eye view of spaceport 14 to operational control personnel, such as aircraft controllers, to assist command and control of competition 10. Mission control 96 comprises equipment such as RADAR, tracking and telemetry equipment, ground system 44 (illustrated in FIG. 7), and communications equipment. Mission control illustrated in FIGS. 5 and 5A may include ground system 44. Information transmitted from rocket-powered vehicles 12 to ground system 44 (see FIG. 7) enables command and control to monitor and verify flight paths 22 of respective rocket-powered vehicles 12. The information may also be communicated to spectators via televisions 86 and/or wireless hub 92, such as rocket-powered vehicle location and video feeds. FIG. 7 also shows sensors 36, telemetry unit 34, mode switches 40, transmitter 42, receiver 46, network extender 62, video streaming 64 and 66.

Spaceport 14 provides a controlled venue, which when combined with rocket-powered vehicle competition 10 occurring over a defined time period, creates an exciting atmosphere that appeals to a broad cross-section of the public and to corporate sponsors, and which increases interest in the development of public space travel. To further promote a festive atmosphere at rocket-powered vehicle competitions 10, spaceport 14 may support spaceflight-related activities that keep spectators engaged and provide hands-on experiences to involve them personally in the public spaceflight industry.

For example, spaceport 14 participating in rocket-powered vehicle competition 10 may support an overall mix of events and activities focused on those areas that directly compliment the public spaceflight industry. As such, a Public Spaceflight Exhibition (not shown) may be included in rocket-powered vehicle competition 10 to provide spectators the opportunity to participate in sub-orbital flights, parabolic (zero gravity) flights, and high-fidelity simulations that build public excitement as well as public acceptance of this market arena. In another embodiment, integrating public spaceflight related rides and unique astronaut training opportunities greatly enhances the competition. For a fee, spectators are preferably able to experience the sensations of space flight in rides and simulators. For instance, the Zero Gravity Corporation (ZERO-G) may provide parabolic flights in its Boeing 727 airplane and offer customers a number of parabolas, each with 30 seconds of zero-g time. ZERO-G has the capacity to carry more than 100 paying passengers per day. Additional weightlessness experiences may include neutral buoyancy simulations, which are essentially large water tanks that re-create a spacewalk in a spacesuit. Simulations of the launch and re-entry of rocket-powered vehicles 12 may be provided by a centrifuge to simulate the gravitational forces that rocket-powered vehicles 12 experience. Additionally, a full-motion interactive flight simulator, similar to the ones used for airline and military flight training, may provide additional spaceflight experiences.

Further, rocket-powered vehicle competition 10 optionally incorporates an astronaut training facility akin to SPACE CAMP that simulates the full astronaut training experience. In addition, an Air and Rocket Show segment of rocket-powered vehicle competition 10 is optionally provided to provide further entertainment and draw large numbers of spectators. The Exhibition can optionally include a demonstration of Unlimited Class Vehicles, which are piloted non-X PRIZE class rockets and rocket-powered vehicles 12. A thrilling exhibition of rocket vehicles may also be featured during the air show. For example, XCOR Aerospace's rocket powered Long EZ airplane can be a featured attraction. These exciting ships, although not directly eligible for rocket-powered vehicle competition 10, may nonetheless provide an exciting and memorable demonstration of the endless possibilities and unique applications of rocket propulsion. Additionally, the teams may optionally be given the opportunity to display mock-up or partially constructed vehicles.

### Example 4

### Rocket-Powered Vehicle Competition with Virtual Pylons

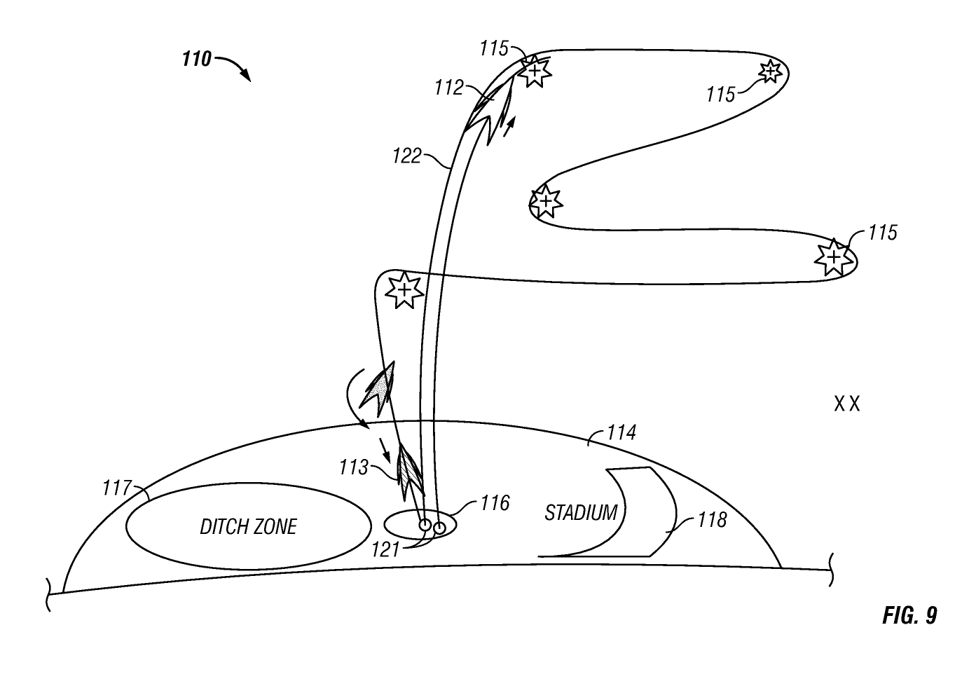

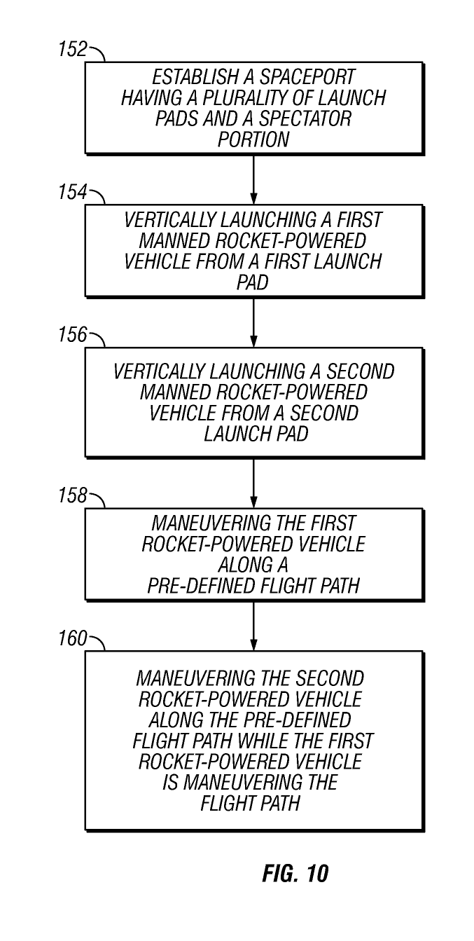

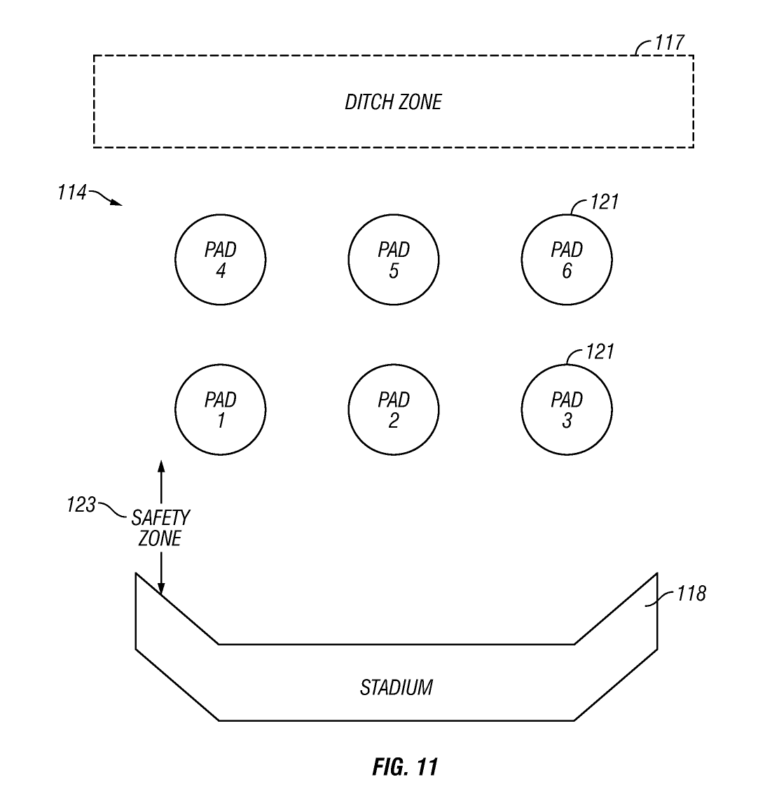

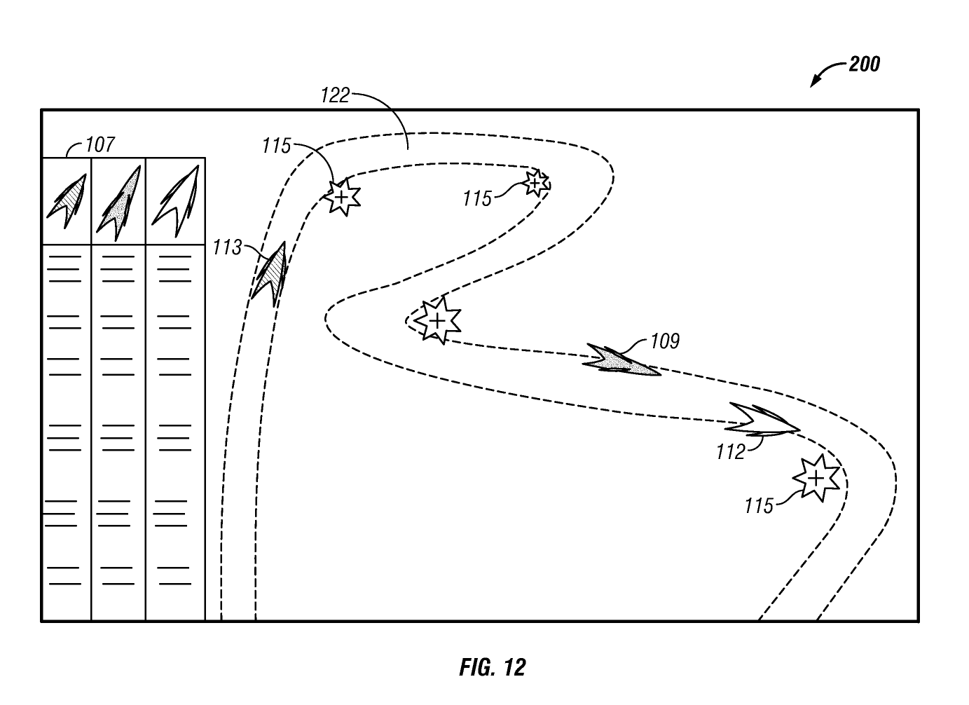

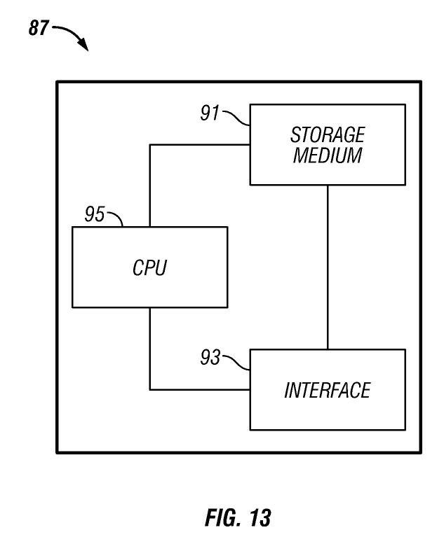

Referring now to FIGS. 9-13, further embodiments of the invention are generally illustrated, a rocket-powered vehicle competition 110 (FIG. 9), a block diagram of an embodiment of the present invention is generally depicted in FIG. 10, spaceport 114 (FIG. 11), display 200 (FIG. 12) and telemetry computer 87 (FIG. 13). Aspects of these further embodiments are preferably the same as previously discussed embodiments, except as discussed hereafter. Referring now to FIGS. 9 and 10, rocket-powered vehicle competition 110 and a block diagram for racing rocket-powered vehicles is generally illustrated according to one embodiment of the invention. As illustrated in FIG. 9, rocket-powered vehicle competition 110 generally comprises rocket-powered vehicles 112, 113 and spaceport 114 having launch portion 116, spectator portion 118 and ditch zone 117. Launch portion 116 preferably provides an area for substantially vertical takeoff and landing of rocket-powered vehicles 112 and 113. During competition with each other, rocket-powered vehicles 112 and 113 follow pre-determined flight path 122, which is established according to virtual pylons 115. Pre-determined flight path 122 may include a wide variety of flight paths such as substantially vertical flight paths, parabolic flight paths, etc. In addition, pre-determined flight path 122 may include several turns that require rocket-powered vehicles 112 and 113 to perform several maneuvers. Further, a significant portion of pre-determined flight path 122 may be within direct viewing of spectators located at stadium 118 in the spectator portion. For example, flight path 122 may include virtual pylons 115 located between about 500 feet and 53,000 feet. Rocket-powered vehicles 112 and 113 maneuvering at these altitudes may be directly viewed by spectators at stadium 118 using binoculars and telescopes. Further, flight path 122 may include a plurality of sets of virtual pylons 115 located at different altitudes with safe distances disposed there between, which provides a range of altitudes that are located a relatively safe distance from stadium 118 without being too far away for viewing.

Rocket-powered vehicle competition 110 may also optionally include racing of two or more rocket-powered vehicles 112 and 113 substantially simultaneously on the same flight path 122 (i.e., racecourse). Flight path 122 may be formed and navigated using virtual pylons 115. For example, each rocket-powered vehicle 112 or 113 may be provided with the three-dimensional locations of virtual pylons 115 prior to and/or during rocket-powered vehicle competition 110. Flight path 122 may also optionally include virtual tunnels described by three-dimensional locations, within which rocket-powered vehicles 112 and 113 should remain during the race. Optionally, rocket-powered vehicles 112 and 113 and/or team may be provided with its own virtual tunnel within which it should remain during the race. Thus, in various combinations, flight path 122 may include virtual pylons 115, racecourse virtual tunnels, and individual team/vehicle virtual tunnels located within a racecourse virtual tunnel. In one embodiment, the pilots of rocket-powered vehicles 112 and 113 may then navigate their respective rocket-powered vehicles around, through and/or proximate to virtual pylons 115 according to the race criteria and flight path 122 data. The pilots may use global positioning technology to determine their precise three-dimensional location with respect to virtual pylons 115 and flight path 122. Each rocket-powered vehicle's three-dimensional position during the race may be provided to telemetry unit 34 during competition and may be transmitted to ground system 44 for monitoring by the judges and spectators. FIG. 9 shows an example in which rocket-powered vehicles 112 and 113 are required to maneuver around virtual pylons 115 within a pre-determined distance based on flight path 122 data. It is contemplated that RADAR or other location tracking systems may be used in addition to global positioning systems in order to track and maneuver rocket-powered vehicles 112 and 113 in relation to virtual pylons 115 and flight path 122 data.

FIG. 10 illustrates a possible block diagram for racing rocket-powered vehicles according to an embodiment of the present invention (for example, as graphically illustrated in FIG. 9), which generally comprises: establishing a spaceport having a plurality of launch pads and a spectator portion 152; vertically launching a first manned rocket-powered vehicle from a first launch pad 154; vertically launching a second manned rocket-powered vehicle from a second launch pad 156; maneuvering the first rocket-powered vehicle along a pre-defined flight path 158; and maneuvering the second rocket-powered vehicle along the pre-defined flight path while the first rocket-powered vehicle is maneuvering the flight path 160.

In an embodiment, rocket-powered vehicles 112 and 113 preferably race by competing with one another according to pre-determined criteria and along the same three-dimensional flight path 122. In this embodiment, at least two rocket-powered vehicles preferably launch and land from spaceport 114 within view of stadium 118 and competing along flight path 122 at substantially the same time. First rocket-powered vehicle 112 vertically launches from launch portion 116 and second rocket-powered vehicle 113 also preferably launches from launch portion 116 at substantially the same time or within a short time period after the launch of rocket-powered vehicle 112 on the same day. Both rocket-powered vehicles 112 and 113 preferably maneuver along flight path 122 and vertically land at launch portion 116. Depending on the pre-determined criteria for the competition, rocket-powered vehicles 112 and 113 optionally repeat flight path 122 several times via several launches and landings.

FIG. 11 shows a top view of spaceport 114 for use with rocket-powered vehicle competition 110. Safety zone 123 is preferably provided such that launch pads 121 are provided a safe distance from stadium 118. Although any number of launch pads may exist as desired, in one embodiment, there is preferably at least six launch pads to support at least six rocket-powered vehicles in a single competition. Ditch zone 117 is preferably provided at a greater distance from stadium 118 than launch pads 121. Ditch zone 117 is preferably a relatively large area located away from personnel and structures where rocket-powered vehicles 112 and 113 may be directed in the event of an emergency. Stadium 118 may be located from about a quarter of a mile to about ten miles from launch pads 121, and is preferably located from about one mile to about two miles from launch pads 121.

Stadium 118 is preferably a large arena designed to hold a large number of spectators. For instance, in one embodiment, stadium 118 may be able to hold about 1 million spectators. Stadium 118 may be a semicircle design that provides good viewability of launch pads 121 to most spectators located therein. To provide safe premises in the event of an emergency, a bunker (not shown) may be provided or stadium 118 may be substantially built within a bunker. Other safety mechanisms may exist, such as protective louvers that may be rapidly closed to provide protection, or protective transparent materials that shield spectators from debris in the event of a rocket-powered vehicle crash or collision. To improve viewability of rocket-powered vehicle competition 110, stadium 118 may include multiple high-definition displays that show various views of rocket-powered vehicles 112 and 113. Further, seats within stadium 118 may include personal displays, which individual spectators may control to view status of the competition, information about various rocket-powered vehicles, etc. As described above with spaceport 14 in FIGS. 5 and 5A, rocket-powered vehicle information, video feeds, graphical representations of flight status, etc. may be provided to displays via telemetry unit 34, ground system 44, mission control 96, media center 88, wireless hub 92, etc.

FIG. 12 illustrates an embodiment of sample display 200 that may used with spaceports 14 and 114. Display 200 may be shown on personal displays installed in stadium 118, televisions within the spaceports, personal display devices (e.g., PDAs) in communication with wireless hub 92 (see FIG. 5A), etc. The example illustrated on display 200 is a graphical representation corresponding with an embodiment of rocket-powered vehicle competition 110. As illustrated, representations of rocket-powered vehicles 109, 112 and 113 competing in rocket-powered vehicle competition 110 are shown. Their locations in display 200 substantially represent their real-time location based on information from their respective telemetry units 34 and/or mission control 96. Their locations show their progress along racecourse virtual tunnel 122 in relation to pylons 115 and in relation with each other. Pylons 115 may change color or otherwise indicate when a respective rocket-powered vehicle passes pylon 115. For instance, pylon 115 may blink red when rocket-powered vehicle 109, 112, or 113 is close to the three-dimensional location in space represented by pylon 115. When rocket-powered vehicle 109, 112, or 113 passes the three-dimensional location based on radar tracking, GPS coordinates, etc., pylon 115 preferably may turn to a solid green color and remain that way until another rocket-powered vehicle approaches.

FIG. 13 shows telemetry computer 87 that generates graphical displays showing status of rocket-powered vehicle competition 110, information about rocket-powered vehicles, video feeds, etc. For instance, telemetry computer 87 may generate display 200 shown in FIG. 12. Telemetry computer 87 may be a server or other computing device. In general, telemetry computer 87 comprises interface 93, CPU 95 and storage medium 91, such as a hard drive, a network accessible storage location, local memory, etc. Interface 93 may include one or more interfaces, such as a wired network interface, a wireless network interface, and the like. Storage medium 91 stores software for instructing CPU 95 to generate displays, such as display 200, based on information received via interface 93. For example, telemetry computer 87 may optionally receive location information for each rocket-powered vehicle from ground system 44 (see FIG. 7) via telemetry unit 34. The location information may be based on sensors within respective rocket-powered vehicles 109, 112, and 113, such as global positioning sensors. Telemetry computer 87 may also receive location information for rocket-powered vehicles 109, 112, and 113 from mission control 96 (see FIG. 5A) determined via RADAR or other tracking and telemetry systems.

Based on the location information received for rocket-powered vehicles 109, 112, and 113, which may be received on a substantially constant, real-time basis from each competing rocket-powered vehicle, CPU 95 generates a graphical display such as display 200 showing the location of each competitor rocket-powered vehicle. In one embodiment, the graphical display may be a three-dimensional display. As illustrated in FIG. 12, the display generated by telemetry computer 87 may include virtual pylons 115 and racecourse tunnel 122, and show rocket-powered vehicles 109, 112, and 113 in relation to them. The virtual pylons 115 and racecourse information may be stored in storage medium 91 or provided via interface 93. As also illustrated in FIG. 12, telemetry computer 87 optionally displays supplemental information 107 about each rocket-powered vehicle, such as specifications, payload, team information, etc.

In addition to being shown on displays within spaceports 14 and 114, displays generated by telemetry computer 87 may be provided to spectators via the Internet or wireless hub 92 (see FIG. 5A). Further, telemetry computer 87 may act as a central repository to store and collate information about competitions 10 and 110 prior to, during and/or after they occur, and to provide that information to spectators, judges and/or the public. For instance, using a computing device (not shown) in communication with wireless hub 92, a spectator may be able to navigate a three-dimensional graphical display of the race as it is occurring using data from telemetry computer 87. The spectator may be able to zoom in and out of portions of a graphical representation of the racecourse shown on their computer to view progress of specific rocket-powered vehicles. They may also be able to switch between video feeds from one or more rocket-powered vehicles provided to telemetry computer 87 via telemetry units 34 for rocket-powered vehicles 109, 112, and 113. Thus, telemetry computer 87 may permit spectators to actively monitor the competition and the progress of all participants on a substantially real-time basis.

Rocket-powered vehicle competition 110, and spaceport 114 provide an exciting event with which spectators may feel a sense of participation. This is partially because racecourse tunnel 122 is a closed flight path within direct viewing by spectators (e.g., via eyesight, binoculars and telescopes) and via equipment (e.g., graphical representations of race status). To enhance the level of excitement further, rocket-powered vehicle competition 110 may require rocket-powered vehicles 112 and 113 to complete multiple laps on racecourse 122. This may include staying on the ground for periods of time to re-fuel and prepare rocket-powered vehicles 112 and 113 for further flight and multiple takeoffs and landings, which provide many opportunities for spectators to view varied aspects of the competition. Spectators may also be able to view rocket-powered vehicles 112 and 113 on their respective launch pads prior to the beginning of the competition.

Rocket-powered vehicles 112 and 113 (as well as rocket-powered vehicles 12 in competition 10) may be controlled by the human occupants; although, certain aspects may be computer controlled as determined by race criteria (e.g., blast off may be largely computer controlled). This makes the competition very exciting to spectators and provides “heroes” that may be created of exceptional pilots. Add to that the excitement of supersonic, rocket-propelled rocket-powered vehicles competing with one another substantially simultaneously, and a thrilling competition is created that should appeal to a large segment of society and attract corporate sponsors.

### Example 5

### Rocket-Powered Vehicle Competition with Direct Racing Between Participants

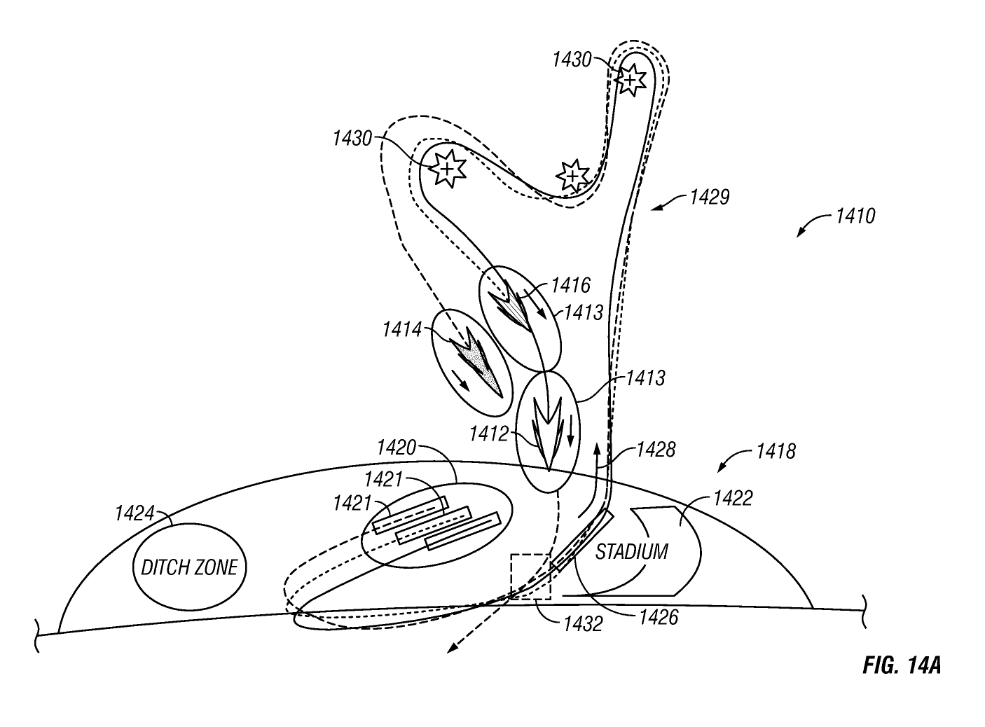

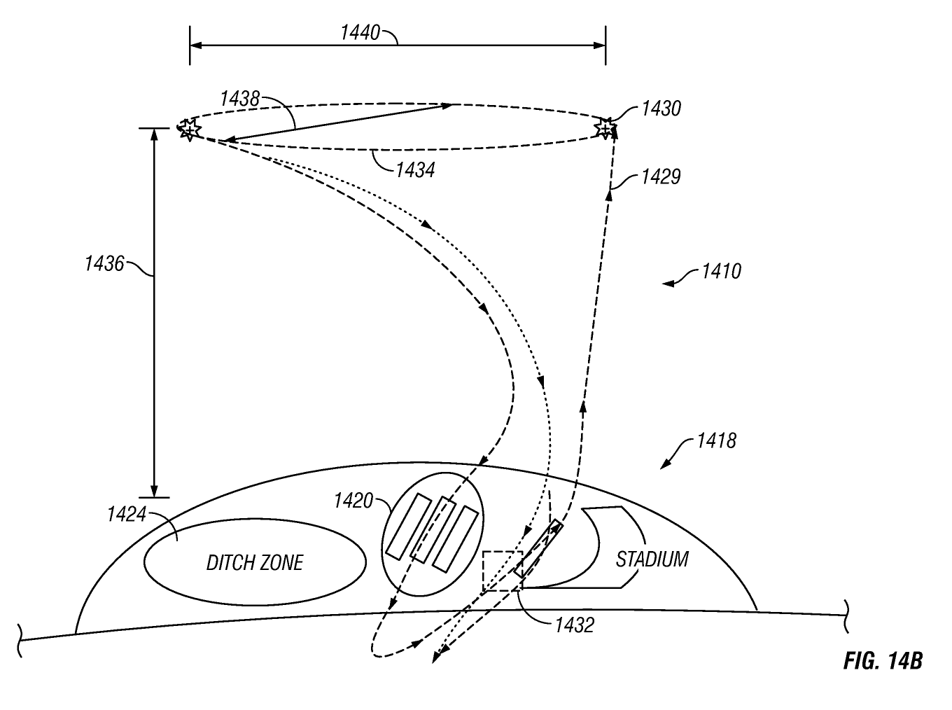

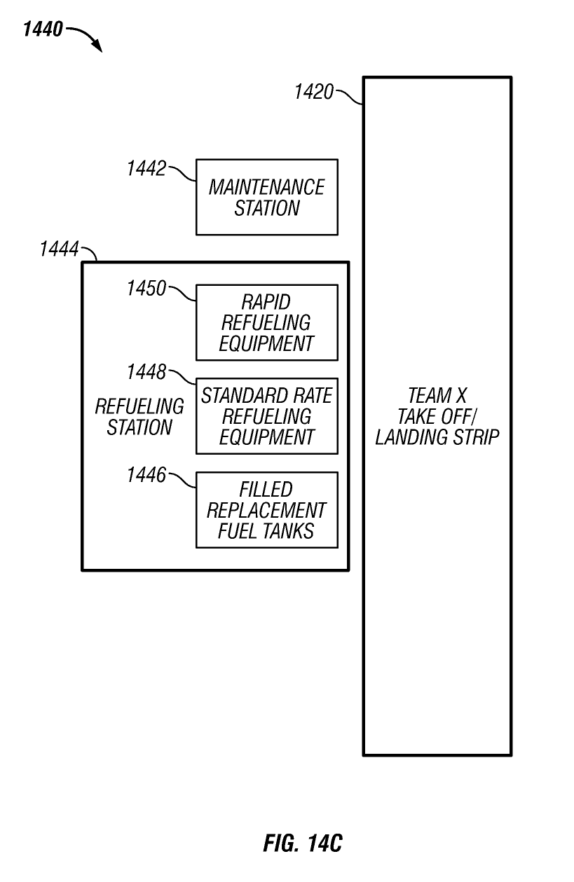

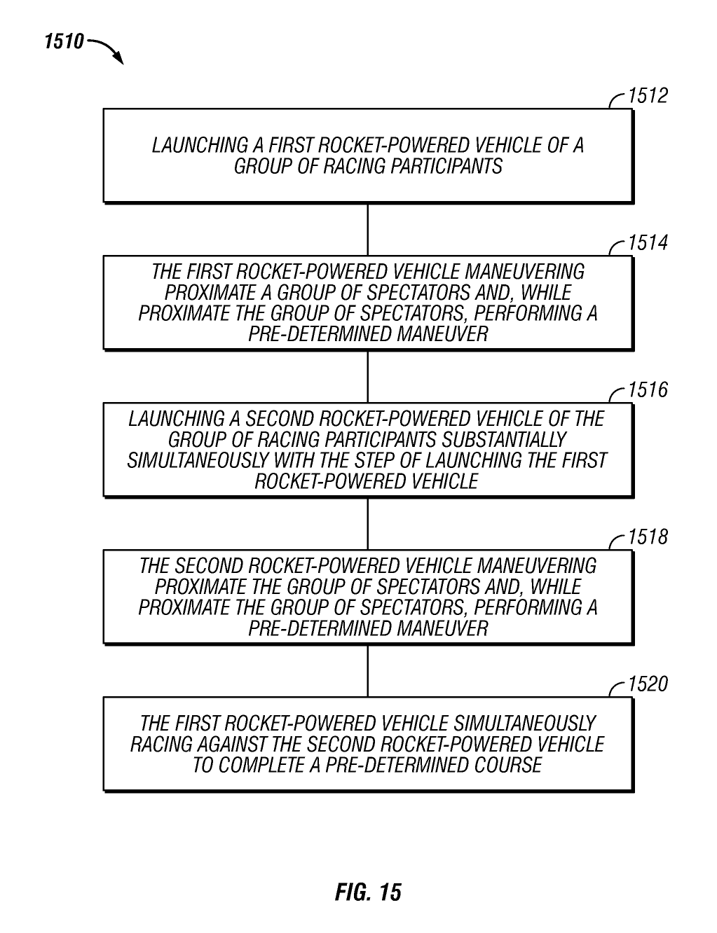

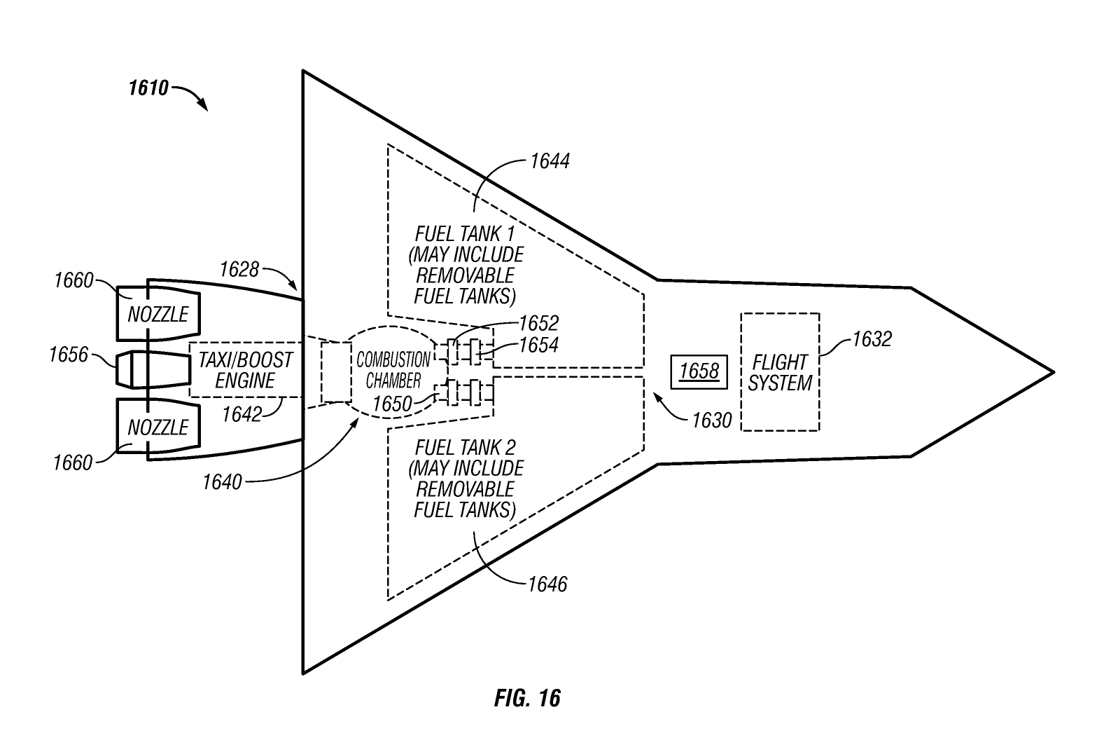

Referring now to FIGS. 14A-C, 15 and 16, rocket-powered vehicle competition 1410 (FIGS. 14A and 14B), rocket-powered vehicle racing method 1510 (FIG. 15), rocket-powered vehicle (FIG. 16) 1610 and spaceport 1418 (FIGS. 14A-C), further embodiments of the invention are generally illustrated. Aspects of these further embodiments are generally the same as previously discussed embodiments, except as discussed hereafter. As shown in FIG. 14A, rocket-powered vehicle competition 1410 generally comprises rocket-powered vehicles 1412, 1414 and 1416, and spaceport 1418 having launch and/or landing portion 1420, spectator portion 1422, a ditch zone 1424 and a touch strip 1426.

Rocket-powered vehicle competition 1410 provides a high level of excitement for spectators and participants alike via direct, head-to-head racing between the race participants to be the first to complete a race course. The exciting atmosphere can be further enhanced for the spectators through various aspects of the racing method that may be practiced alone or in a variety of combinations comprising: vertical take-offs near spectator portion 1422; visual and audible mechanisms for clearly identifying participant rocket-powered vehicles; pre-determined racing parameters comprising rapid refueling and limited fuel quantity, engine burn time and/or thrust options; rocket-powered vehicle configurations based on the parameters and strategic options for the participants in response to the parameters (e.g., choices involving fuel quantity and thrust management); spectator interactivity with the race participants; and user participation in real-time races via virtual rocket-powered vehicles.

In the embodiment illustrated in FIG. 15, rocket-powered vehicle competition 1410 preferably comprises: Launching a first rocket-powered vehicle of a group of racing participants 1512; the first rocket-powered vehicle maneuvering proximate a group of spectators and, while proximate the group of spectators, performing a pre-determined maneuver 1514; launching a second rocket-powered vehicle of the group of racing participants substantially simultaneously with the step of launching the first rocket-powered vehicle 1516; the second rocket-powered vehicle maneuvering proximate the group of spectators and, while proximate the group of spectators, performing a pre-determined maneuver 1518; the first rocket-powered vehicle simultaneously racing against the second rocket-powered vehicle to complete a pre-determined course 1520. The steps of 1514 and 1518 are optionally performed closer to the spectators than the respective launch location of each rocket-powered vehicle. This can permit the spectators to have a relatively close view of an exciting maneuver, such as vertical take-off, which they may not be able to view as closely as they could otherwise view due to safety or logistical considerations. Such a maneuver location can also permit the spectators to directly view significant portions of the race that they may otherwise not be able to view or that they may be required to view remotely (e.g., via a display). For instance, the maneuver may include the participants proceeding past a finish line or through a finish gate to complete the race. Direct spectator observation of the race completion preferably heightens the excitement of the event. In another example, each rocket-powered vehicle is optionally required to perform a vertical take-off maneuver close to the spectators at a spectator portion, which is preferably an exciting maneuver to observe due to the firing of the rockets and the rapid ascent of the rocket-powered vehicle. In addition, each rocket-powered vehicle may be required to perform a touch-and-go maneuver at a touch strip proximate the spectators while flying horizontally after its launch, after which it can perform a vertical take-off maneuver in view of the spectators. These maneuvers preferably permit the spectators to share in the excitement of launch and vertical take-off, while being protected from the greater risks associated with vehicle launch and landing at the airstrips. The rocket-powered vehicles may be required to perform various maneuvers proximate the spectators as part of landing, take off, refueling, race completion, or at other portions in the race.

In an alternative embodiment, groups of two or more preferably race along the same course. Optionally, the racing may be performed in “heats” where small groups of participants race to qualify, the winners of which progress to the next level. The racing may optionally be performed as comprehensive racing between all participants. The rocket-powered vehicles may be launched abreast or in a staggered fashion, which can be advantageous for logistical and safety reasons. As illustrated in FIG. 14A, the rocket-powered vehicles optionally launch and land in a horizontal manner similar to conventional fixed wing aircraft along airstrip 1421 of launch portion 1420, which may be a single airstrip, a plurality of shared airstrips, or a plurality of participant-specific airstrips. After launch, each rocket-powered vehicle can turn its flight path 1428 to a substantially vertical flight path 1429 and fire its rockets for vertical take-off. The rocket-powered vehicles can land on a landing strip by gliding in a manner similar to conventional fixed wing aircraft. Rocket-powered vehicles that can fly in both horizontal and vertical configurations is advantageous for racecourses requiring repeated take off and landing. An example of a rocket-powered vehicle that can fly in both configurations is illustrated in FIG. 16.

Racecourses 1429, as illustrated in FIGS. 14A and 14B, are preferably three-dimensional racecourses similar to racecourse tunnel 122 of FIG. 10, with the addition of the required touch-and-go maneuver in front of the spectators followed by a rocket relight. Racecourses 1429 are formed via racecourse data that may include markers for virtual pylons 1430, one or more racecourse tunnels identifying flight envelopes for the competition, and one or more team/vehicle-specific tunnels within racecourse tunnels that identify flight envelopes for individual vehicles. As illustrated, the racecourse may also include one or more physical gates 1432. The markers may be fixed or they may be varied from lap to lap, or race to race. The race may include laps around the racecourse; laps from point to point, such as around track 1434 illustrated in FIG. 14B formed via one or more virtual pylons and other racecourse data comprising coordinates for virtual tunnels; laps around various sub-portions of the racecourse; or combinations thereof. The racecourse or portions of it (e.g., virtual track 1434 discussed below along with FIG. 14B) can change from lap to lap or even randomly, which is optionally an added measure to excite the crowds. Spectators themselves may even be able to play a role in selecting from a matrix of pre-designated virtual tracks in the sky.

In the embodiment illustrated in FIG. 14A for racing configuration 1410, three-dimensional safety zones or safety bubbles 1413 are maintained around each rocket-powered vehicle while competing along the racecourse. Safety bubbles 1413 ensure that a safe separation distance is maintained between the rocket-powered vehicles, which is an even more significant concern for the head-to-head racing configurations of space competition 1410. In one configuration, safety rules for the competition preferably require that each rocket-powered vehicle have a virtual bubble around it according to pre-determined safety criteria. If a pilot maneuvers his rocket-powered vehicle into the bubble of another rocket-powered vehicle, such as from behind during head-to-head racing, then points are deducted from the violating rocket-powered vehicle and/or team. The bubbles can be generated and maintained through navigation data sent from the rocket-powered vehicles and monitored at the spaceport. Optionally, each rocket-powered vehicle may be required to fly within its own virtual tunnel. The vehicle-specific virtual tunnels may be spaced apart a sufficient distance to ensure safe navigation with respect to competitors, but may be located proximate to one another so that all vehicles follow a substantially identical course.

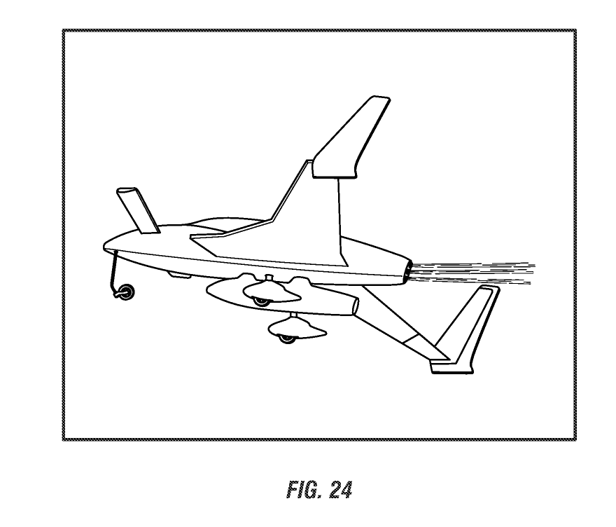

For example, in accordance with the navigational monitoring aspects of an embodiment of the invention discussed along with the description of rocket-powered vehicle 12 in FIGS. 6 and 24 and the spaceport of FIGS. 4, 5 and 5A, the rocket-powered vehicles of racing competition 1410 is preferably outfitted with position monitoring sensors, such as global positioning system (GPS) equipment, and preferably are outfitted with high precision position monitoring equipment, such as the GPS equipment known as “differential GPS.” Each rocket-powered vehicle preferably transmits its real time location to a ground control system, such as via the wireless telemetry to the ground discussed along with FIG. 7 and/or via communications with other rocket-powered vehicles. The rocket-powered vehicle flight system, the ground control system (e.g., mission control 96 illustrated in FIG. 5A), and other rocket-powered vehicles monitor the position of rocket-powered vehicles on racecourse 1429 and safety bubbles 1413 formed around each rocket-powered vehicle. Safety bubbles 1413 may be shown to spectators via televisions 86 shown in FIG. 5A, which may include JUMBOTRON displays, via wireless devices, and/or via other network-enabled devices monitoring the racing competition 1410 over the Internet.

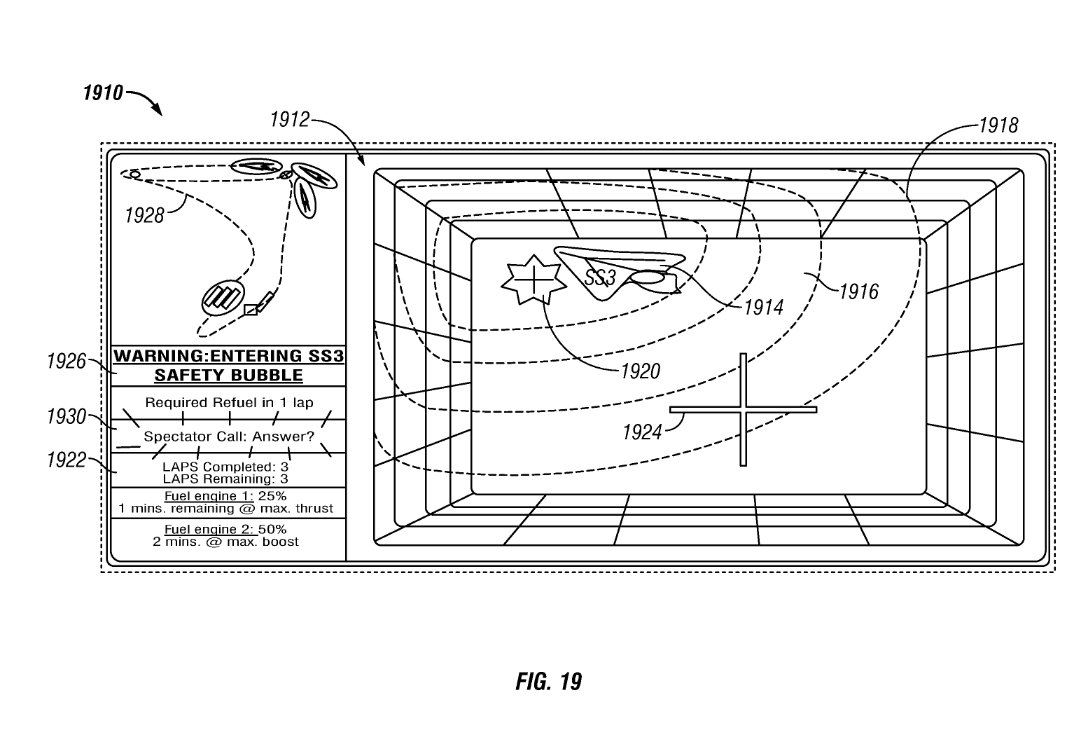

As discussed further along with FIG. 19, the pilots of each rocket-powered vehicle are optionally provided with a heads up display that may, in various combinations, display other competitors, the competitor's safety bubbles, the vehicle-specific virtual tunnel within which the vehicle should navigate, the overall racecourse tunnel, virtual pylons, physical data and/or obstacles. Each pilot preferably receives warnings as they approach bubbles of other aircraft or move out of their vehicle-specific tunnel, which can optionally be integrated into the control functions of the rocket-powered vehicle itself. Race moderators can optionally have the ability to increase or decrease the size of the bubbles to allow closer clustering of race participants or to provide deliberate separation.

As illustrated in FIG. 14B, racecourse 1429 may exist in a three-dimensional plane initially reaching into the sky, height 1436. Racecourse 1429 may include one or more tracks 1434, which may have a dimension 1438 in the downstream direction and a dimension in the cross plane direction. In one configuration, height 1436 and dimensions 1438 may be the same to form a generally circular track. Track 1434 may have a variety of sizes, shapes and dimensions. In one embodiment, height 1436 is between one-half and one and a half miles, which should be viewable by spectators via binoculars or another viewing aid, and preferably is about one mile, which is a relatively safe height that may also be viewable by the spectators. In other embodiments, racecourse 1429 and/or track 1434 may expand out to include larger and larger volumes of space beyond one and a half miles, reaching further into the sky vertically, and/or in the crosswise and downstream directions. In addition, the race can extend vertically to sub orbital altitudes, or can circle the earth or even extend to the moon or beyond. Constraints on the racecourse and tracks include performance limitations of the rocket-powered vehicles themselves, and may involve considerations of the ability to bring the race to the spectators through remote display technologies in a way that keeps it exciting and creates a shared sense of close-in participation.

In one configuration of rocket-powered vehicle competition 1410, each rocket-powered vehicle preferably has a pre-determined maximum quantity of rocket fuel as measured by mass or an estimated engine burn time at a certain thrust. Each rocket-powered vehicle may also be limited to a pre-determined maximum burn time for its rocket engine(s), which may be provided in concert with pre-determined maximum thrust parameters. The pre-determined maximums will be selected to ensure periodic refueling of each rocket-powered vehicle during the competition.

Rapid refueling via team-specific pits may be an option or a requirement for rocket-powered vehicle competition 1410. Rapid refueling can permit long duration races while providing the spectators with a close look at the race teams, which can occur during the actual race as the rocket-powered vehicles are being refueled and serviced. For instance, a quantity of rocket fuel sufficient for a burn time of four minutes may be established for the pre-determined maximums, which may permit a rocket-powered vehicle to navigate a single lap of racecourse 1429 in a rapid timeframe if the pilot burns the rocket engine continuously. However, based on this choice, the pilot may need to refuel relatively quickly. A second pilot can strategically choose to proceed at a slower rate that comprises gliding and periodically burning the fuel to maintain speed or to boost the rocket-powered vehicle speed when needed. The second pilot is preferably able to navigate two laps of racecourse 1429 without refueling, but at an overall slower rate than the rate at which the first pilot can complete each lap and undergo rapid refueling. The pre-determined maximums may be established to ensure each rocket-powered vehicle must refuel at least once during the competition or to ensure each rocket-powered vehicle must alternate between boosting and gliding. It will be up to the individual rocket-powered vehicle pilot to decide how to use the fuel throughout the race to conserve fuel, vary thrust, sustain velocity, taxi, etc. The race may be a collection of boost and glide modes as the pilot works to optimally manage the application of rocket thrust while conserving scarce fuel. After the fuel is expended, the pilot preferably glides to land the rocket-powered vehicle and undergo a rapid refueling.

In one embodiment of rocket-powered vehicle competition 1410, each participant may optionally be able to strategically develop his propulsion system to provide a selectively-applied booster engine configuration based on anticipated management of the limited supply of fuel and desired engine performance. Various combinations of rocket engines, types of propellants, and nozzle configurations, comprising various nozzle sizes, types and styles, may optionally be developed by each team to strategically meet the pre-selected maximums while attempting to maximize rocket-powered vehicle performance. For example, a participant team may develop a rocket-powered vehicle that has one or two primary rocket engines for vertical takeoff, as well as one or more smaller engines that can be selectively ignited and/or strategically controlled for navigating the racecourse.

FIG. 14C shows an example support station for a rocket-powered vehicle, which is part of landing and/or takeoff portion 1420 of the spaceport, and comprises one of airstrips 1420 located therein. Typically, each team has its own support station and a dedicated airstrip. Preferably, each rocket-powered vehicle has its own airstrip regardless of whether the rocket-powered vehicle's team may sponsor multiple rocket-powered vehicle entrants. The support station preferably comprises maintenance station 1442 and refueling station 1444. Maintenance station 1442 preferably houses necessary maintenance equipment and supplies for preparing a rocket-powered vehicle for the competition, supporting the rocket-powered vehicle during competition, and servicing the rocket-powered vehicle after the competition. Maintenance station 1442 may also provide a base camp for team personnel who are supporting the competition.

Refueling station 1444 is preferably proximate the maintenance station 1442 for logistical advantages and to provide parallel maintenance and refueling operations during a pit stop of the competition, such as a rapid refueling stop. Alternatively, the refueling station may be separated a safe distance from the maintenance station 1442 and other structures to reduce the likelihood of a fuel accident affecting a large number of people.

Refueling station 1444 may include filled replacement fuel tanks 1446, standard rate refueling equipment 1448, and rapid refueling equipment 1450. In a configuration in which the supported rocket-powered vehicle comprises removable fuel tanks and/or banks of fuel tanks (discussed below along with an example rocket-powered vehicle shown in FIG. 16), refueling station 1444 preferably has replacement tanks 1446 on hand, filled and ready for rapidly transferring to and installing in the supported rocket-powered vehicle during a pit stop. Refueling station 1444 preferably also has standard rate refueling equipment 1448 for fueling the rocket-powered vehicle during maintenance and race preparations, as well as for fueling the replacement fuel tanks in anticipation of a refueling pit stop. Refueling station 1444 preferably also comprises rapid refueling equipment 1450, which may provide high-flow rate refueling as needed on an emergency basis, for topping off a rocket-powered vehicle during an unscheduled pit stop, and for refueling fixed tank rocket-powered vehicles. Rapid refueling equipment 1450 may also include support equipment for transporting the filled removable fuel tanks to a rocket-powered vehicle and for quickly completing fuel tank replacement procedures.

For fixed tank rocket-powered vehicle configurations, rapid refueling equipment 1450 may include high-flow rate refueling equipment that provides fuel and oxidizer as needed to the tanks at a high-flow rate, which may also be at a high pressure to support the rapid refueling. In order to avoid potential safety issues that may be associated with high pressure/high velocity refueling, the high-flow rate equipment may have large cross-sectional conduits, which can provide a rapid volumetric flow rate without pumping the fuel at high velocities and/or at high pressures (beyond pressures required to maintain certain fuels and oxidizers in a liquid state). In conjunction with the rapid volumetric flow rate equipment, a corresponding rocket-powered vehicle would preferably have large cross-sectional ports to avoid narrowing the fuel flow and thereby increasing the flow velocity to maintain the rapid volumetric flow rate. The large cross-sectional ports may be in addition to standard fuel ports used for standard refueling procedures.

FIG. 16 shows an example rocket-powered vehicle 1610 that may be used to selectively-apply thrust to conserve fuel while providing desired performance characteristics. However, rocket-powered vehicle 1610 may be used to practice other aspects of the invention, comprising performing methods 50, 150 and 1510 and aspects related to rocket-powered vehicle competitions 10, 110 and 1410. Rocket-powered vehicle 1610 is generally the same as rocket-powered vehicle 12 shown in FIGS. 6-8 except as discussed hereafter. As shown, rocket-powered vehicle 1610 comprises flight system 1632 and propulsion system 1628. Propulsion system 1628 comprises primary rocket engine 1640, secondary rocket engine 1642, and propellant 1630. Rocket-powered vehicle 1610 is a fixed-wing aircraft having horizontal flight functionality and glide functionality similar to conventional jet aircraft, as well as vertical flight functionality as a rocket-powered spacecraft. As an example, rocket-powered vehicle 1610 may be based on the aircraft known as EZ ROCKET made by XCOR AEROSPACE having a place of business in Mojave, Calif., United States of America.

Propellant 1630 may include a variety of rocket fuels, including but not limited to an oxidizer (e.g., liquid oxygen, nitrogen tetroxide, nitrous oxide, air, hydrogen peroxide, perchlorate, ammonium perchlorate, etc.) plus a fuel (e.g., light methane, hydrazine-UDMH, kerosene, hydroxy-terminated polybutadiene (HPTB), jet fuel, alcohol, asphalt, special oils, polymer binders, solid rocket fuel, etc.). The fuel is preferably stored in fuel tank 1644 and the oxidizer is stored in another fuel tank 1646. The fuel tanks may be disposed within wings of rocket-powered vehicle 1610, within the body of rocket-powered vehicle 1610, or may be carried underneath rocket-powered vehicle 1610. In one configuration, fuel tanks 1644 and 1646 may be removable tanks, such as a single tank or a bank of smaller tanks that can be removed and installed on rocket-powered vehicle 1610 relatively quickly. For example, rocket-powered vehicle 1610 may include a pair of storage bays (not shown) into which a bank of tanks 1644 or 1646 may be secured. Rocket-powered vehicle 1610 may also include detachable couplings (not shown) for connecting to the bank of tanks. The detachable couplings may include a variety of clamps with seals (e.g., O-rings) connecting pressurized piping between the bank of tanks and the rocket-powered vehicle propulsion system. In another configuration, fuel tanks 1644 and 1646 may be fixedly attached or formed within rocket-powered vehicle 1610, such as being formed within the wings.

As shown in FIG. 16, propulsion system 1628 preferably further comprises piping 1650 for delivering propellant 1630 to primary rocket engine 1640 and secondary rocket engine 1642, as well as valves 1652 and pumps 1654 for controlling the delivery of propellant 1630 to the engines. Preferably, a single pair of fuel tanks 1644 and 1646 feeds both engines 1640 and 1642, which can simplify the design of rocket-powered vehicle 1610 and can assist with permitting fuel tanks 1644 and 1646 to be rapidly refueled. In addition, engines 1640 and 1642 preferably share as many common parts as possible, such as pumps and certain control valves, to avoid unnecessary mass and complexity of rocket-powered vehicle 1610. However, rocket-powered vehicle 1610 may also include separate tank systems for each engine 1644 and 1646 and other independent components. In addition, each engine, 1644 and 1646, may include its own combustion chamber and nozzles. The valves and pumps may be controllable to direct fuel and oxidizer to one combustion chamber or the other, and they may be controllable to direct fuel and oxidizer to both rocket engines depending at the desired level of thrust or fuel consumption. As shown in FIG. 16, secondary rocket engine 1642 may be placed underneath primary rocket engine 1640 to apply thrust along its longitudinal axis. However, secondary rocket engine 1642 may be placed at various locations on rocket-powered vehicle 1610 with respect to primary rocket engine 1640 and may include a plurality of secondary rocket engines 1642 placed at various locations.

In one configuration, primary rocket engine 1640 is used mainly for vertical takeoff while secondary rocket engine 1642 is principally used for maneuvering through the course, maintaining velocity, and boosting velocity. In another configuration, primary rocket engine 1640 has selectively controllable thrust settings and provides both thrust for vertical takeoff and for maneuvering through the course, whereas secondary rocket engine 1642 provides thrust for taxiing along runways. Both engines 1640 and 1642 can be used simultaneously in other configurations to provide a maximum amount of thrust, but at the expense of consuming fuel at the maximum rate. Alternatively, one engine can be run to conserve fuel while still maintaining a reasonable velocity. Generally, any desired configuration of primary rocket engine 1640 and secondary rocket engine 1642 is possible.

In one configuration, options for engines 1640 and 1642 may be dictated for the race to limit the variety of propulsion systems 1628. For instance, primary rocket engine 1640 may be required to be an on-off engine for all participants, which provides primary thrust for vertical take-off. Secondary rocket engine 1642 may be directed to have a finite number of thrust levels, such as low, medium and full thrust. It is understood that a wide variety of rocket engine types with a wide variety of thrust levels and control features may be possible for rocket-powered vehicle 1610. However, mandating parameters such as the number of rocket engines, the maximum thrust for the engines, thrust levels for the engines, controllability of the engines comprising directional controls, etc. can significantly add to the amount of strategic considerations for the race participants and can, therefore, add to the excitement for the event. Thrust levels may be controlled by adjusting the flow rate of fuel and oxidizer into the combustion chamber via controlling pumps 1652 and valves 1654 illustrated in FIG. 16.

As desired, one or both engines can have movable nozzles 1660 and thrust vector control mechanisms for maneuvering rocket-powered vehicle 1610 based on the orientation and magnitude of the rocket thrust vector. The selection of engine configurations and controls may be significant for a particular team according to their strategy for winning the race. As noted above, secondary rocket engine 1642 may be adapted to primarily provide boost augmentation rather than to taxi or sustain velocity. For example, once fired, secondary rocket engine 1642 can generate a significant boost and remain ignited until propellant 1630 burns out. In another configuration, secondary rocket engine 1642 can include a pair of small rocket boosters that are fired at various times as selected by the race team and pilots. In another example, secondary rocket engine 1642 can include a bank of small rocket boosters, such as about five boosters. In a further example configuration, secondary rocket engine 1642 can be powered via a solid propellant alone while relying upon atmospheric oxygen to be an oxidizer. However, such a configuration may have limited applicability to low altitude uses at which sufficient oxygen can be obtained when needed.

As further shown in FIG. 16, rocket-powered vehicle 1610 may include nozzle deflectors 1656 on a nozzle of secondary rocket engine 1642 that modify the exit cone from the engine to produce a unique sound. The spectators can use the unique sound to identify rocket-powered vehicle 1610 or its team. Placement of deflectors 1656 on secondary rocket engine 1642 in a configuration in which it acts as a taxi engine can be beneficial for providing the unique sound whenever rocket-powered vehicle 1610 is taxiing and, therefore, is within audible range of the spectators. Alternatively, nozzle deflectors 1656 can be placed on primary rocket engine 1640, which may be beneficial for providing the unique sound during vertical takeoff. Nozzle deflectors 1656 can be used at all times to produce a signature sound for rocket-powered vehicle 1610 and/or its team while that engine is being fired. Alternatively, nozzle deflectors 1656 can be selectively activated and deactivated to provide the signature sound as desired, such as whenever rocket-powered vehicle 1610 is within audible range of the spectators.

As further shown in FIG. 16, rocket-powered vehicle 1610 may include a sound generator 1658, such as a conventional horn or siren, which can augment the sound generation capabilities of nozzle deflectors 1656 or provide an alternative sound generation mechanism compared with nozzle deflectors 1656. The sound generator may augment the sound signature of nozzle deflectors 1656 (e.g., provide a similar sound to that generated via nozzle deflectors 1656), play a previously-recorded version of the unique sound, or even amplify the sounds generated via nozzle deflectors 1656 previously considered or may be relied upon alone to provide the sound signature for rocket-powered vehicle 1610. The flight system may be configured to activate the sound generator and/or nozzle deflectors 1656 on command from the pilot or another member of the team. In addition, the flight system may be configured to automatically activate it below a certain altitude or whenever the flight system receives a signal or other indication that it is located proximate the spaceport.

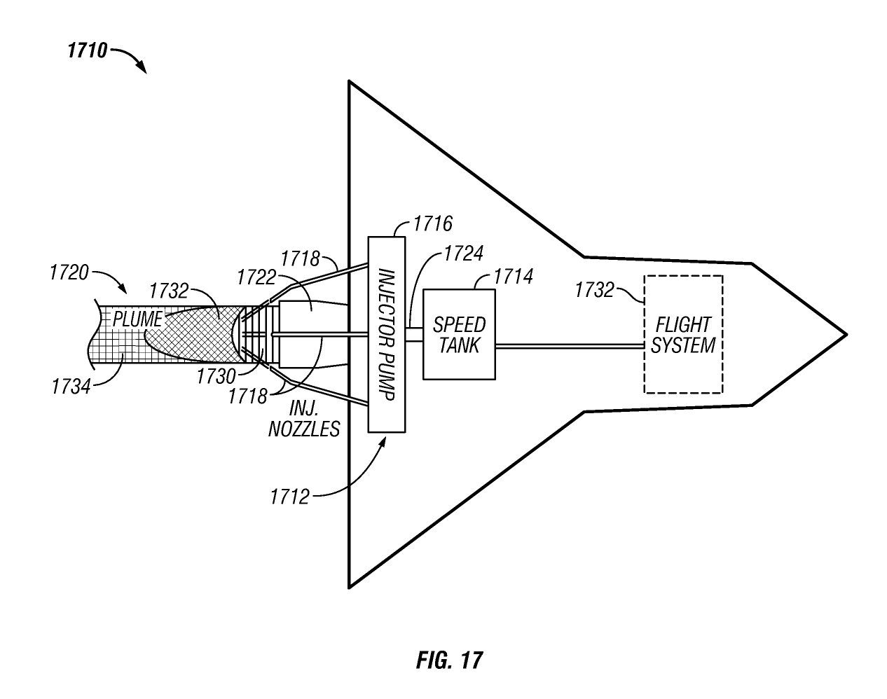

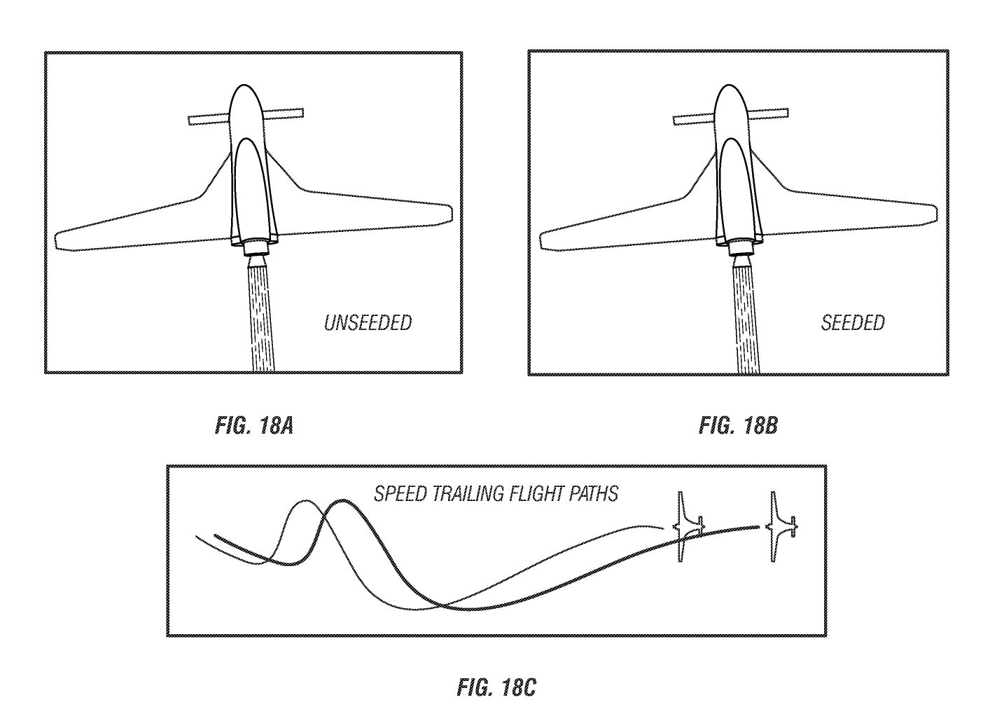

Referring now to FIGS. 17 and 18A-C, rocket-powered vehicle 1710 according to another embodiment of the invention is shown. Rocket-powered vehicle 1710 generally comprises the aspects and features of rocket-powered vehicle 1610, except as discussed hereafter. As shown, rocket-powered vehicle 1710 comprises plume visualization system 1712, which enhances the visibility of the rocket plume. In addition, plume visualization system 1712 may mark the plume from one or more of the rocket engines in a persistent manner such that the plume remains viewable for a period of time after rocket-powered vehicle 1710 creates it. For instance, the plume may mark the trail of rocket-powered vehicle 1710 for a period between 5 seconds to 1 minute, which permits spectators to easily follow rocket-powered vehicles 1710 along the directly viewable portions of the racecourse. In one configuration, each rocket-powered vehicle 1710 marks its plume in manner specific to that rocket-powered vehicle or racing team, such that the plume identifies rocket-powered vehicle 1710 and its path. For instance, each rocket-powered vehicle 1710 or team may have one or more colors associated with it. Thus, each rocket-powered vehicle 1710 may have a visual signature via its plume, and it may also have a sound signature as discussed above along with FIG. 16. Accordingly, spectators can be provided with multiple cues to help them keep track of the fast-paced race occurring overhead amid the excitement of the contest.

As shown in FIG. 17, according to one embodiment of the invention, plume visualization system 1712 preferably comprises a seed tank 1714 in communication with rocket-powered vehicle flight system 1732, an injector pump system 1716, and injector nozzles 1718. Plume visualization system 1712 preferably marks one or more plumes from rocket-powered vehicle 1710 via injecting plume seed containing chemicals into hot rocket plume 1720 as it exits one or more rocket nozzles 1722 of the rocket engine. Seed tank 1714 preferably retains the chemicals, which may be in a liquid form conducive for pressurized spraying. Injector pump 1716 preferably receives the chemicals from the seed tank via conduit 1724 between the two. The conduit may include components specific to the type of chemical used, such as a mixing tank for mixing one or more chemicals to form the chemical or place it in an active form, and/or for placing the chemicals in a mixture conducive for spraying, etc. Conduit 1724 may also include valves and other controllable devices for controlling the preparation and flow of the chemicals to injector pump 1716. Injector pump preferably 1716 delivers the chemical to injector nozzles 1718, which preferably spray it directly into the plume as it exits rocket engine nozzle 1722.

The visual identifier may be generated via a chemical reaction that occurs in response to the heat of the plume, which causes the chemicals to burn or radiate a particular color. In one configuration, the intensity of the color may vary according the thrust level of the engine. This may be accomplished by providing temperature-sensitive chemicals to the plume that cause radiant light energy at different temperatures, thereby displaying to spectators a piecewise spectrum of colors that vary in wavelength according to thrust level. For instance, as shown in FIG. 17, first portion of plume 1730 emits the natural colors of combustion for the particular propellant being burned, such as kerosene or alcohol. Second portion of plume 1732, which is located just downstream from entry of the chemicals, emits colors based on initial reactions with the chemicals injected into the plume, such as the burning of metal salts or pyrotechnic chemicals. Third portion of plume 1734 further downstream from second portion 1732 emits different colors, which may be produced by cooling combustion products, continuing reactions such as longer duration pyrotechnic reactions, continued reactions between chemicals and the atmosphere, etc. Preferably, however, first and second portions 1730 and 1732 include common colors identified with a particular rocket-powered vehicle or team, such as various blues for one team or various reds for another team.

In another configuration, the intensity of color may be deliberately varied based on the flow rate of plume seed sprayed from injector nozzles 1716. For example, an intense color may deliberately be provided during vertical take off or as rocket-powered vehicle 1710 crosses a finish line marker. The pilot may be able to control plume visualization system 1712 via controls of the flight system. Alternatively, plume visualization 1712 system may be controlled remotely via ground control communications to the flight system. In another configuration, the flight system may be programmed to control automatically plume visualization system 1712 according to location of rocket-powered vehicle 1710.

The chemicals of the plume seed may include one or more metal salts. When metal salts are exposed to the flame of the rocket plume, they typically give off light characteristic of the metal. The metal ions combine with electrons in the flame, which are raised to excited states because of the high flame temperature. Upon returning to their ground state, they give off energy in form of light (including but not limited to a line spectrum) that is characteristic of that metal. Several metal salts, for example alkali metal salts, give off a characteristic color visible to the human eye. Examples of chemicals that may be used various combinations include sodium, potassium, aluminum chloride, boric acid, calcium chloride, cobalt chloride, copper chloride, lithium chloride, magnesium chloride, manganese chloride, sodium chloride, and strontium chloride. Pyrotechnic chemicals commonly used in fireworks displays may used as well, comprising antimony trisulfide, ammonium perchlorate, ammonium chloride, aluminum, and more.

In an alternative configuration (not shown), rocket-powered vehicle 1710 comprises a non-reactive smoke generator, which provides non-reactive identification smoke when the rocket engine is not being fired. The non-reactive smoke generator preferably turns off when the rocket engine is being fired to capture the natural combustion colors, such as the yellow color of burning kerosene or the violet/blue of burning alcohol. When the rocket engine turns off and vehicle 1710 is gliding, the smoke generator may emit identification smoke to demonstrate the rocket-powered vehicle's glide path. Thus, rocket engine combustion highlights rocket-powered vehicle 1710's flight path when powered, and the non-reactive smoke generator highlights its flight path when gliding. In another configuration, a plume visualization system may be used during rocket firing to identify the plume of the particular rocket-powered vehicle or team, and a non-reactive smoke generator may be used by the same rocket-powered vehicle while gliding to produce identification smoke that generally matches the colors produced by the plume visualization system. Thus, regardless of the firing status of rocket engines, a visual signature may be constantly provided that highlights the rocket-powered vehicle's flight path.

Referring now to FIG. 19, heads up display 1910 is shown as part of a rocket-powered vehicle console in a rocket-powered vehicle, such as rocket-powered vehicle 1610 shown in FIG. 16, in accordance with embodiments of the invention. Heads up display 1910 may be shown on a rugged display device 1912, such as the rugged displays currently manufactured according to United States military specifications for use in military vehicles. Display 1910 can show a wide variety of information to the pilot in a variety of views comprising vehicle control information, racing information, maintenance information, navigation information, etc. Display 1910 may be connected to flight system 1632 and/or other systems and flight computers. FIG. 19 shows an example view of display 1910 during a racing competition, such as competition 1410 of FIGS. 14A and 14B. As illustrated, display 1910 may show, in various combinations, other competitors 1914; competitor's safety bubbles 1916; the vehicle-specific virtual tunnel within which the vehicle should navigate (not shown); overall racecourse tunnel 1918; virtual pylons 1920; physical data, such as an actual view of a competitor 1914, obstacles, or other physical objects; the location of pilot's vehicle 1924; and competition information 1922. The information shown may be generated by the flight computer based on information received from flight control (e.g., status of competitors), pre-loaded race information (e.g., racecourse tunnel), navigation information received from flight control (e.g., your current location), navigation information from various sensors (e.g., GPS receivers), vehicle sensors (e.g., fuel level sensors, cameras, etc.), etc. Display 1910 may also show an overall view of racecourse 1928 showing the status of other participants and the current location of the pilot's vehicle in relation thereto.

Competition information 1922 may include warnings 1926, such as a warning when a pilot approaches or enters bubbles of other vehicles, moves out of their vehicle-specific tunnel, moves out of the racecourse tunnel, or misses a virtual pylon or other waypoint of the race, etc. The warning can flash red or some other color on the display for certain warnings. In addition, tactile and audible warnings can be provided to the pilot, such as vibrating a control handle the pilot is using, or the seat or helmet, or playing an audible warning sound. Similarly, positive indications (not shown) can be provided when the vehicle successfully hits a waypoint, such as navigating around a virtual pylon or flying through a virtual gate. For instance, a green light or message can flash on the display to show the vehicle successfully passed a virtual pylon. In addition, tactile or audible indications can also be provided for successfully completing the task. Overall view 1928 may also include warnings 1926 and positive visual indicators, such as flashing in red a missed virtual pylon or flashing the same pylon in green when the pilot successfully navigates around it. Such visual, tactile and audible indicator techniques may also be applied to those who participate virtually, either through gaming or in another way, as a way to provide a further immerse and interactive experience.

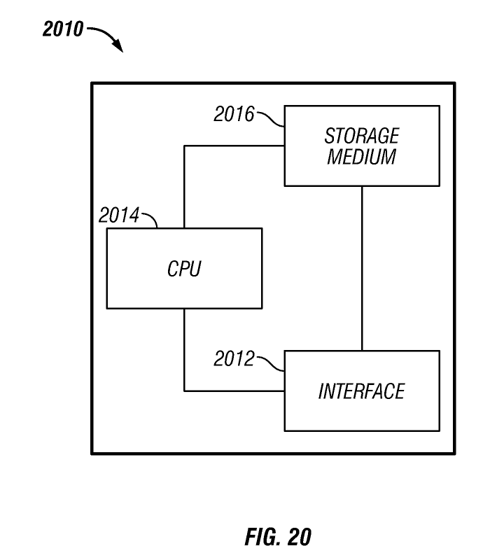

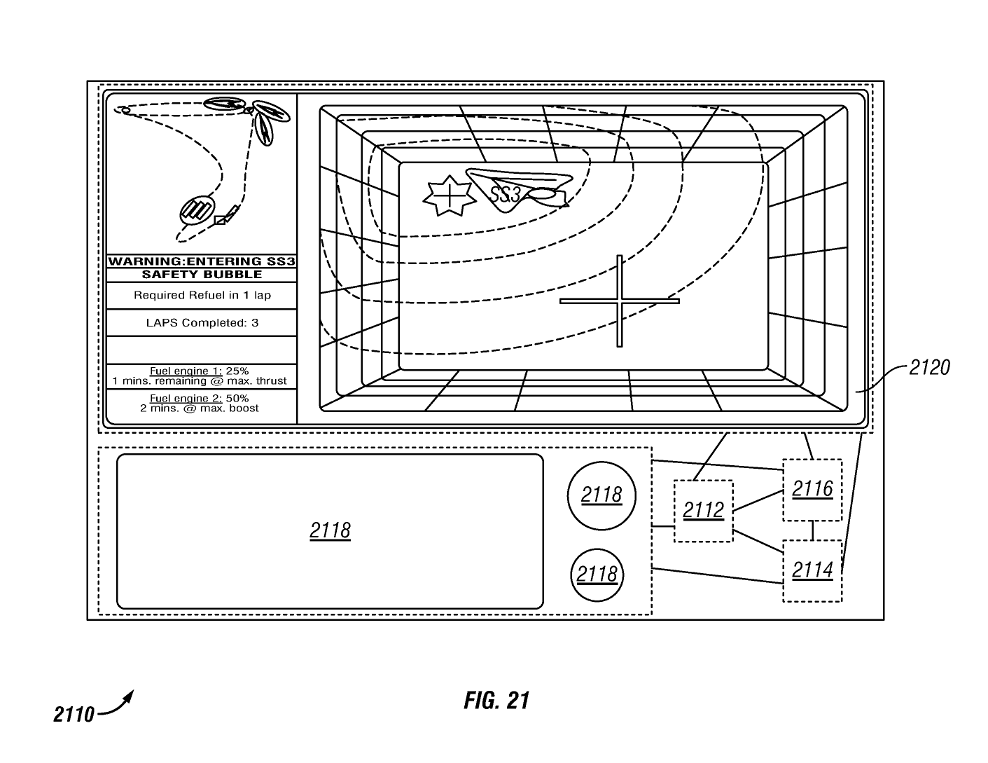

Referring now to FIGS. 20 and 21, spectator server 2010 (FIG. 20) and spectator computing device 2110 (FIG. 21) are generally shown according to embodiments of the invention. Spectator server 2010 generally comprises the same aspects as telemetry computer 87 and 34 discussed above along with FIG. 13, except as described hereafter. Spectator server 2010 may be a separate entity from the telemetry computer 87 and 34, it may be a separate logical entity from spectator server 2010 that resides on the same computer or group of computers, or it may be a completely separate entity from telemetry computer 87 and 34 that may or may not be in communication with telemetry computer 87 and 34. Spectator server 2010 is a computing entity that interacts with spectators to permit them to participate interactively in a racing competition, such as competitions 10, 110 and 1410. The interactivity may include providing status and other race related information to spectators, such as is described along with the description for telemetry computer 87 and 34. In addition, spectator server 2010 may permit spectators to interact directly with race participants and to be involved with aspects of the race itself, such as voting on racecourse options. In addition, spectator server 2010 may provide gaming information to spectators or other people to permit a variety of gaming options, such as virtual racing against actual participants. Spectator computing device 2110 is a device that spectators or other interested people may use to interact with the spectator computer for gaming purposes or other racing purposes. Spectator computing device 2110 may be specifically-designed device for the racing competition. Preferably, however, spectator computing device 2110 is a conventional computing device, such as a personal digital assistant or a laptop computer. Such a non-conventional computing device allows participation at remote locations across the world, the data feed provided over the Internet in near real time.

As shown in FIG. 20, spectator server 2010 preferably comprises an interface 2012, a CPU 2014 and a storage medium 2016, such as a hard drive, a network accessible storage location, local memory, etc. The interface may include one or more interfaces, such as a wired and wireless network interfaces. Storage medium 2016 preferably stores software for instructing the CPU to perform various steps such as providing updated racing information to spectator computing devices 2110, hosting racing games based on race information, and permitting spectators to interact with race participants. In addition, spectator server 2010 may act as web site to permit spectator computing device 2110 or other devices to have real time participation in race events.

As shown in FIG. 21, spectator computing device 2110 generally comprises interface 2112, CPU 2114 and storage medium 2116, such as a hard drive, a network accessible storage location, local memory, etc., input devices 2118, and display 2120. The interface may include one or more interfaces, such as a wired and wireless network interfaces. Storage medium 2116 stores software for instructing the CPU to perform various steps such as receiving updated racing information from spectator server 2010 and/or telemetry computer 87 and 34, playing racing games based on the race information, and interacting with race participants. Storage medium 2116 may have racing software stored locally thereon, which can permit the user to race a virtual rocket-powered vehicle at any time regardless of device 2110's connectivity status with other computers. When device 2110 is connected to other computers, however, the user may choose to race his virtual vehicle as part of actual ongoing races via data from spectator server 2010 and/or against other virtual competitors. Optionally, spectator server 2010 may host the gaming software and spectator computing device 2110 may interact with spectator server 2010 for racing games.

Browser-based software and/or racing specific software stored on spectator computing device 2110 may allow spectators to accomplish a wide variety of functions related to rocket-powered vehicle races, which may be selectable in an interactive manner to provide the user with a hands-on experience. In one configuration, a spectator may select a soft key that brings up an actual racecourse and shows a virtual vehicle thereon for the spectator to race. The display would preferably show computer generated images depicting the actual rocket racers, driven by differential GPS or the equivalent, so that the placement of the computer generated vehicles on the screen matches that which is taking place in the real live race. If the user clicks on a specific vehicle, the spectator may then select from a number of functions that might include listening in on the cockpit conversation and other audibles, viewing either a virtual instrument cluster driven with real-time telemetry data, or viewing a live video feed of the actual instrument cluster. Other options might allow the spectator to stream a video of the pilot's face, or stream a variety of video feed from a number of different cameras or telemetry stream from various instrumentation suites installed on the rocket vehicles. The spectator can bring up multiple pilots on the screen and pit one against the other.

In one configuration, preferably operated under stringent safety protocol, a spectator using the computing device may compete via spectator server 2010 for the opportunity to speak with a pilot during the race. Optionally, with safety being a primary concern, spectators can even compete for the opportunity to ignite remotely a rocket engine boost from their laptop computer by hitting a specific button during a pre-selected timeframe and after providing the winning username and password. Thus, spectators could actually and virtually participate in a rocket-powered vehicle competition. Optionally, a mock cockpit or other configuration can be established at a race event that allows the spectator an opportunity to ignite remotely a rocket engine boost or to activate or manipulate another function of the rocket powered vehicle. Such a process of allowing remote users to operate some portion of an actual rocket powered vehicle would need to be performed under guidance and with safety as a priority.

### Example 6

### Rangeless Air Racing Maneuvering Instrumentation Network

A system to enable the implementation of an immersive piloting, safety and entertainment experience may be referred to as a rangeless air racing maneuvering instrumentation network (“Network”). It preferably involves the capture, processing, distribution and display of data in a variety of formats with varying degrees of end-user interactivity.

Users of the Network include, but are not limited to, pilots, navigators, co-pilots, air crew, ground crew, race teams, race league officials, safety officials, Federal Aviation Administration (FAA) personnel, training personnel, on-site fans, remote fans, garners, technology developers, TV stations, satellite broadcast stations, mobile content providers, archival agencies, news broadcaster, online media sources, camera operators and automated data collection and data redistribution infrastructure.

The technological worldview of the Network embraces convergence of the real and virtual worlds to lift spectator perceptions of excitement, awe, thrill and danger to entirely new levels. Fans of rocket powered racing events are able to access the sport both live and remotely via use of the Network—and are rewarded with an accessible, information-rich environment no matter what their chosen interface with the sport. Formats can range from real, to melded real and virtual, to purely virtual.

The Network preferably uses simulation technology to enhance the experience of racing for all audiences. Simulation technology is an aspect of the Network that contributes to bringing the revolutionary sport of rocket powered vehicle race competition to millions of fans worldwide.

The Network is preferably a hybrid of live and virtual simulation action that blends live action with a virtual world of rich data overlays to create a hybridized form of entertainment.

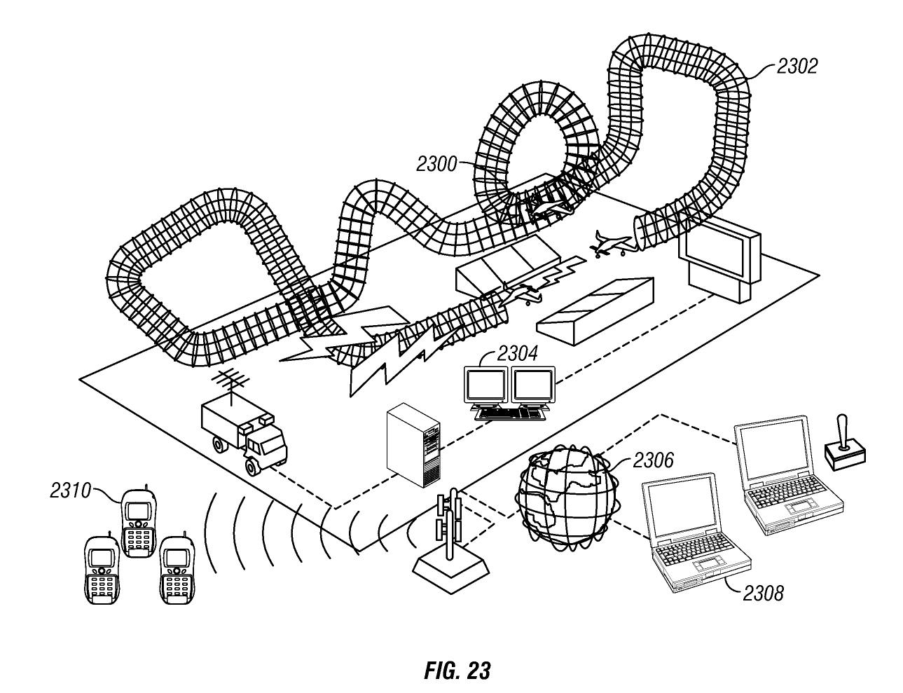

For illustrative purposes, the system may be visualized as a collection of rocket-powered vehicles connected to the ground through wireless telemetry links, as shown in FIG. 23.

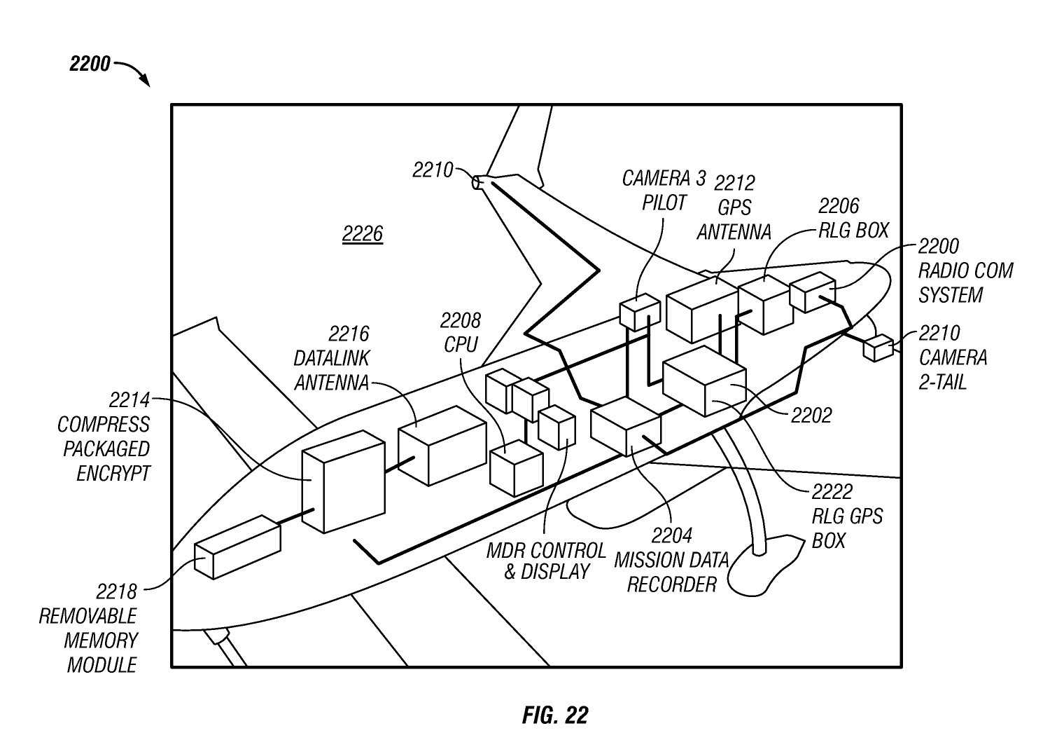

Referring to FIGS. 22-24, each rocket-powered vehicle, indicated generally as 2200, may carry on board an array of instrumentation and related hardware to connect it to the virtual networked race environment, and to project the simulated data overlays to end users. Each rocket powered vehicle 2200 may carry GPS receivers 2202, and recorder 2204 to track location and orientation at all times. In place of, or as an augmentation to GPS receivers 2204, inertial navigation system (INS) 2206 may be employed for the same purpose of generating information that characterizes position and orientation information for each of rocket-powered vehicles 2200 in three-dimensional space. The combination of GPS 2202 and INS 2206 preferably offer advantages in resolving both translational and rotational dynamics. Each rocket powered vehicle 2200 also preferably comprises CPU 2208 for processing data.

Each rocket powered vehicle 2200 may also carry one or more cameras or digital video recorders (“DVRs”) 2210 for the recording of digital video or stills. Transmitter/receiver 2212 in rocket powered vehicle 2200 can send the position and orientation data, the digital video data and other data to a ground station (not shown) at the broadcast center, and receive pertinent information for display and processing inside rocket powered vehicle 2200. Transmitter/receiver 2212 may optionally include compress/encrypt package 2214, datalink antenna 2216, and/or removable memory module 2218. Video may be captured in multiple resolution formats, from standard definition to high, and stored onboard in one format and transmitted to the ground in another. In one embodiment, high resolution video can be stored onboard, regardless of what is transferred to the ground over the telemetry system. This ensures that the best quality imagery is stored for post production, and that it is free from the degrading visual artifacts that are introduced over the telemetry system. Additionally, because of bandwidth limitations of the telemetry system, sending down a lower resolution video stream will allow for a higher number of video streams to flow. Composite techniques may be employed where multiple video streams are grouped into one, for example in quad format, for transferring down via telemetry, then they could either be shown as a quad display or the individual feeds can be extracted from the quad feed and the individual videos reproduced for view, though preferably at lower resolutions.

Each rocket powered vehicle may carry radio/com system 2210 for two-way interface, RLG/GPS box 2222 that is in direct link to mission data recorder (“MDR”) 2204, MDR control and display 2224 as well as control display unit (“CDU”) and display 2226.

Each rocket powered vehicle 2200 may have an in-panel, heads-up display (“HUD”) or head-mounted display (“HMD”), each equipped with a multi-function display (“MFD”) capability able to display simulated data overlay information from the onboard computer, as well as any received data from the ground. In the case of an in-panel display, the simulated data overall can be melded with the imagery from one or more forward looking cameras, such that the melded real and virtual forward looking world video show the forward line of sight imagery with virtual tracks and the like for the pilot to navigate or gain a higher level of situational awareness.

As part of each ground station support infrastructure, there may be an information hub/pod that keeps a constant, two-way data link with each racer, and with each ground team.

The hub/pod can be configured to manage all aspects of the race, the safety protocols, and also serve as a broadcast and media center for creation and transmittal of the official race broadcast streams to both spectators and at-home fans.

Each hub/pod preferably allows fans to connect wireless devices the race network for access and interface customizations available to the at-home fans. Each Race Site may be able to monitor racers in real-time that are within a designated radius.

All pods may be capable of GPS position determination, may have data recording capability, and may utilize pod-to-pod UHF data communications to facilitate rangeless communication.

All data transmissions may be unclassified or encrypted for secure transmission of sensitive data.

The system may accommodate at least two race participants, but may be capable of supporting many more vehicles of varying design, whether airborne or ground vehicles.

The hub/pod may execute race simulations and transmit results to the race site hub as well as wirelessly to spectator handsets or other devices.

The processing capability may be located either onboard the vehicle, on the ground, or draw from the combination of both, and can enable the real-time merging of real-time video with rich data overlays. The processing capability preferably enables the real-time insertion of synthetic objects into real-time video using sophisticated occlusion dynamics to designate what objects, real or synthetic, appear in the foreground, and what objects appear in the background. The data overlays preferably depict a virtual world that possesses rules, properties and dynamics that make it appear as though it is real, not an afterthought generated through computer simulation. In one configuration, the virtual data overlay preferably contains a series of parallel three dimensional tunnels in the sky, inside of which, individual rocket powered vehicles are directed to remain in order to affect vehicle to vehicle separation and guide the pilots of such vehicles through the sky on a race track that is both exciting to watch from the perspective of a viewer and, from an absolute level, is safe.

The virtual tunnel may be depicted by a series of rings or other shapes that are either connected along longitudinal paths about the ring circumference, or other means of connectivity, or stand alone. The rings may be positioned in three-dimensional space, along the desired track at intervals that give the pilot and viewers a good presentation of where the rocket powered vehicle should be traveling in this three dimensional space inside of which the rocket powered vehicle race is intended to occur.

The data characterizing the virtual tunnel system is made available to a variety of sources for a variety of purposes. In one configuration, pilots of the rocket powered vehicles are delivered to the virtual tunnel system on an in-panel, heads-up or head mounted display with the objective of providing the pilot with a visual guide inside of which he/she would be directed to pilot the rocket-powered aircraft for the purpose of maintaining separation from other vehicles engaged in the race, and for the purpose of flying a race course that is both entertaining for spectators to watch and safe to fly within the performance capabilities of the particular rocket powered vehicles.

In another configuration, the data characterizing the three-dimensional tunnel system is made available to various display outlets on the ground, for processing and display to a variety of end users. In such an embodiment, the data characterizing the virtual tunnel system is generated precisely in three dimensional space with a fixed earth reference system. Then, based on the location and orientation of various ground or airborne cameras, the virtual tunnel system is accurately overlaid in three dimensional space. If the camera angle or location were to change in real time, the manner in which the three-dimensional virtual tunnel system would also be adjusted.

One particular implementation feature of the virtual tunnel system is to preferably use the process of occlusion dynamics to portray the rocket powered vehicles as flying through the virtual rings that comprise the virtual tunnel.

In another configuration, the virtual overlay preferably contains not only the virtual tunnel, but additionally, a virtual bubble around each rocket powered vehicle depicting a safety bubble.

In yet another configuration, the data overlay may contain, in addition to the aforementioned overlay elements, virtual depictions of other rocket powered vehicles, data containing information of position within the race, vehicle performance information, predictive artificial intelligence designed to improve pilot performance, general race information and other artificially generated synthetic objects that tend to improve the race safety posture or deliver enhanced visual entertainment to fans.

FIG. 23 illustrates components of an integrated rangeless air racing maneuvering instrumentation system. Beginning with rocket powered vehicles 2300, also known as airborne units, data is collected, processed, stored, displayed and telemetered both to other airborne units and ground receiving stations 2304. This comprises, but is not limited to, airborne geospatial parameters 2302, performance parameters and video feeds. From ground receiving station 2304 the data is preferably passed on to a processing capability where it is preferably merged with virtual world 2306 prior to redistribution to end users 2308. Once virtual world 2306 is suitably merged with appropriate video feeds from either airborne units 2300 or grounds camera units, it is preferably processed for redistribution. Users of the processed hybrid real/virtual data include, but are not limited to pilots, safety officials, race teams, grounds crews, race officials, on site fans, remote fans, TV broadcast units, training infrastructure and gaming infrastructure. Handsets 2310 feeds and receives data as well.

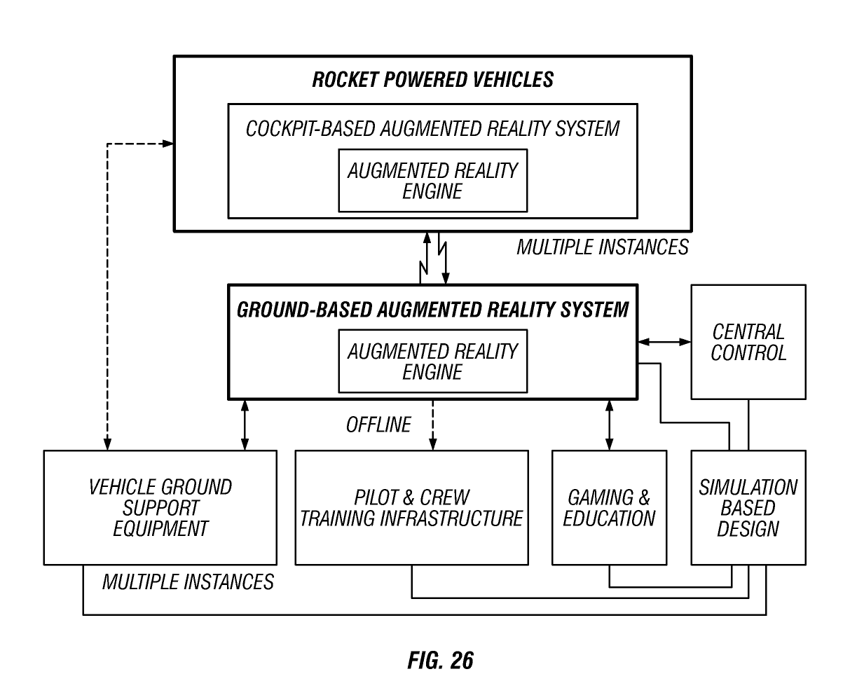

The connectivity of the technology modules is show in FIG. 26. All activity hubs around the ground-based augmented reality system and all other modules are slaved to it during an individual race event. Safety and compliance are prevalent throughout. Each module is integrated to yield a system that gives rise to an interactive mobile networked infrastructure that provides data-rich interactive connectivity.

A description of each module follows:

Rocket-Powered Vehicles

The rocket powered vehicles are the combined airframe and propulsion means, including tanks for fuel and oxidizer, configured for the purpose of rocket-powered vehicle racing.

There are preferably up to 10 or more rocket-powered vehicles during an individual race event, although there may be only one vehicle or more than 10 vehicles.

Vehicle Ground Support Equipment

The vehicle ground support equipment is the supporting infrastructure enabling the rapid refueling and general servicing of rocket-powered vehicles during pit stops. Vehicle ground support equipment allows connectivity to the individual rocket-powered vehicles to facilitate the monitoring of performance and maintenance of an audio communications link between the ground crews and their pilots.

The cockpit-based augmented reality system may contain other service elements that are needed during pit stops. For example, because the rocket-powered vehicles rely on batteries to power all electrical systems, including engine ignition, it may be required that batteries are swapped out during pit stops. Depending on the on-board data storage, it may also be necessary to swap digital storage media.

There are preferably up to ten or more vehicle ground support equipment systems or stations, and most preferably one for each competing rocket powered vehicle.

Augmented Reality Engine

The augmented reality engine is the primary subsystem that performs the insertion of synthetic objects into a video stream based on inputs characterizing the time variant line of sight of the viewing object, which may be a camera (onboard or ground) or the actual line of sight of the pilot of the rocket powered vehicle.

The augmented reality engine comprises the stored digitized depiction of the race course in three-dimensional space relative to a fixed inertial reference frame. Depending on the position and attitude of the viewing object, the race course may be dynamically inserted into the line of sight of the viewing object such that the rocket-powered vehicle(s) appear to be flying through a network of clustered tunnels in the sky. For cases where the viewing object is outside of the cockpit (for example ground based cameras), accounting for occlusion dynamics becomes a necessary step in the insertion of the synthetic objects.

Both the ground-based augmented reality system and the cockpit-based augmented reality system use the same augmented reality engine, modified slightly to perform the functions specified above.

Occlusion Dynamics

Occlusion dynamics, or the process of creating the perception that synthetic objects are dynamically inserted into a live or offline video feed that are in front of or behind other real objects in the video image, is accomplished in a number of ways. One such method uses information on the position and attitude of a real object within or passing through the camera field of view to determine what parts of a synthetic object inserts are in front and what parts of the synthetic object inserts are behind the real object within or passing through the field of view.

In the case of rocket-powered vehicles, the real object(s) are the rocket-powered vehicle(s), the sky, the terrain, other airborne vehicles, ground vehicles, etc. In such a case, the primary objects that are moving in the video are the rocket-powered vehicles. Knowing the position of each rocket-powered vehicle in three-dimensional space, along with the angular orientation of the vehicle at each specific point in three-dimensional space, one creates a raceway in the sky that is dynamically inserted into a real-time or off-line video such that the rocket-powered vehicles appear to be flying through the synthetic race way in the sky; not on top of, or behind, but through.

With regard to the synthetic objects that are inserted into the offline or real time video, each of the objects is inserted in such a way that it has the correct position and orientation in three-dimensional space within the frame of reference that is captured.

Such a process is well suited to a ground-based camera system that is dynamically tracking the fleet of rocket-powered vehicles as they compete through a virtual track in the sky. In this case, a wireless data telemetry link communicates to a ground station the position and attitude of the all the rocket-powered vehicles through this process, each of the rocket-powered vehicles are made to appear as if it they are traveling inside of a three-dimensional tunnel instead of sitting on top of or behind it. This process for handling occlusion dynamics is unique because the ground cameras know the position and attitude of the objects that are moving dynamically though the field of view of the camera. In most all other industry-standard methods for handling occlusion dynamics, there is no such information. In making it available, the real and virtual worlds that are created have a look and feel that is far more realistic than would otherwise be achievable.

Occlusion dynamics may be applicable to both the cockpit and ground-based augmented reality systems. In the cockpit, a camera scan in any direction may show other race vehicles. Use of occlusion dynamics in the cockpit may make the host vehicle, as well as the other vehicles, appear as if they are either in front of or behind certain synthetic objects that are inserted, creating a more realistic presentation of the combined real-virtual video stream.

Taking the occlusion dynamics discussed above to still a further application, and in more generalized terms, where there exists a camera with line of sight information, and objects moving through the field of view that are recording and transmitting their position and attitude through three-dimensional space, the invention may use that information to properly display the objects in front of and/or behind the synthetic objects that are dynamically or statically inserted.

In general, the invention for handling occlusion dynamics is readily applied to a variety of display means other than video from a camera. Such alternate applications include but are not limited to convention heads-up displays commonly found on military aircraft and less frequently found on civilian aircraft. An additional alternate display means includes, but is not limited to, head-mount displays, which are also commonly found on military aircraft. In both cases, instead of looking at the displayed image of a video to view the surroundings, the user uses a direct line of sight to view the surroundings through a transparent screen which forms an important part of the heads-up or head-mount display. The insertion of synthetic objects to merge the real world with the virtual is then accomplished by projecting the synthetic objects onto the transparent screen. The result for the user is to see the real world through direct line of sight and to also see the virtual world as a projected overlay onto the transparent screen component of the heads-up or head mount display. The process of using recorded and transmitted object metrics from the real world to properly position the synthetic object inserts as described above is effective, yielding a highly realistic and intuitive merging of the real and virtual worlds.

In another embodiment of the cockpit based augmented reality system (“CBARS”), the creation of the track-related synthetic objects which are inserted into the in-panel display, HUD or HMD, are created in real time as opposed to being retrieved from a predetermined set. For example, typically the virtual track inside of which the rocket powered vehicles will race is known in advance of the race and is programmed into the computers of each of the rocket powered vehicles. During the race, the track is pulled from storage on the computer and presented to the pilot along with a variety of other information that collectively allows him to successfully navigate his way through the race course. In one embodiment, the track is not pulled from storage on the computer but is instead created in real time depending on predictive algorithms that forecast where the rocket plane will be in the next segment of time based on its current position and flight dynamics. Such a system is called real time adaptive CBARS and is primarily used for demonstration, flight test and training purposes. In its implementation, the pilot flies normally through the sky in his rocket powered vehicle and the real time adaptive CBARS create and overlay a racetrack and other navigation aids such that they appear normally in front of the rocket powered vehicle on the normal flight path being flown without any deviations. If the pilot is flying at a constant altitude with zero rates in roll, pitch and yaw, the real time adaptive CBARS will simply lay down a straight track. If the pilot then pulls up, the real time adaptive CBARS will sense and measure the change in flight path and will create a modified track that pulls upwards keeping the new track in front of the vehicle at all times. To accomplish this, real time adaptive CBARS measures position, attitude, rates and accelerations (both linear and angular) and lays down a track in front of the vehicle that projects itself forward a distance which is preferably several hundred vehicle lengths. As new information comes into real time adaptive CBARS and the vehicle moves further along the track, a new track is preferably extended. In extreme cases wherein the flight characteristics are not accurately predicted by the real time adaptive CBARS due to extreme changes in orientation, the track may be adjusted in real time as the new information flows in. The net result is a system that lays down a track that is perfectly centered around the rocket powered vehicle, regardless of where the rocket powered vehicle flies. Such a system can be used for demonstration purposes to the viewing public, teaching viewers about the melded real and virtual worlds, training pilots and ground crews, proving out instrumentation onboard the rocket powered vehicles, or a wide variety of other uses.

### Other Applications

The inventions described above and the more general inventions of augmented reality systems are used in a very wide variety of applications outside of racing rocket-powered vehicles. The invention is applicable to competition of any vehicle that travels through three-dimensional space, regardless of propulsions system. Such vehicles can be traveling underwater, on the surface of the Earth, in the air, in space or along a path that spans multiple domains, for example a vehicle that first travels along the surface of the Earth, transitions to the air, then space and back. Any combination is possible, the point being that there exists significant value in augmenting the reality through the realistic dynamic insertion of synthetic objects. In one embodiment of the invention described herein, the dynamic object insertion creates a virtual track or path that the user navigates along to get from one point to another with some deliberate purpose, or for pure entertainment. The virtual track overlay allows for better and more rapid navigation, safer travel, gaming, and general entertainment.

In a more generalized sense, the synthetic object inserts allow for the virtual insertion of almost anything, including but not limited to virtual advertisements, virtual products, virtual objects, etc. An architect may use it to visualize a new building by wearing augmented reality goggles as a client is shown a new home site, taking in the actual land view then synthetically inserting the buildings to give a realistic sense of what it would ultimately look like. In such a case, the client completes a walk through the virtual house on the actual land. In yet another application, a golfer may be given a variety of virtual tracks to drive along without requiring actual physical trails to be constructed.

Within the embodiment related to the racing of rocket-powered vehicles, and in any other application of the augmented reality system described herein, the synthetic objects that are inserted into either a video or the line of sight of a user may be dynamically adjusted based on external inputs. For example, in the racing of rocket-powered vehicles, if an in flight emergency occurs, rapidly creating an emergency tunnel that provides the pilot with an optimal flight path to safely glide back to the surface has great value. Or in another application, a new virtual tunnel or track can be created to assist the pilot in navigating to a more competitive position within the race. In the more generic embodiments, using external information to dynamically alter the stream of synthetic objects that are inserted is of great value. Even for the golf cart invention contemplated here, if a golfer decides at any time that it is time for a visit back to the club house, on the selection of a button, for example, a path is calculated and dynamically inserted regardless of the golfer's location on the course.

Such applications of static and dynamic augmented reality systems are of great value to the general aviation markets, as well as military, both for general navigation and emergency operation. For example, the current invention can be used for rapidly presenting a pilot with the best path to an emergency landing site, providing a tunnel to fly within, navigation aids to assist in flying through the tunnel, detailed approach information to the landing site, and any other information that may assist the safe return home. The synthetic inserts presented to a general aviation pilot take into account external conditions and are changed in real time. Such external inputs include traffic, weather, vehicle performance, desired destination, emergency declaration and type, keep out zones as mandated by the FAA, other information from the FAA or aircraft advisory agencies, and more.

### Example 7

### Cockpit-Based Augmented Reality System

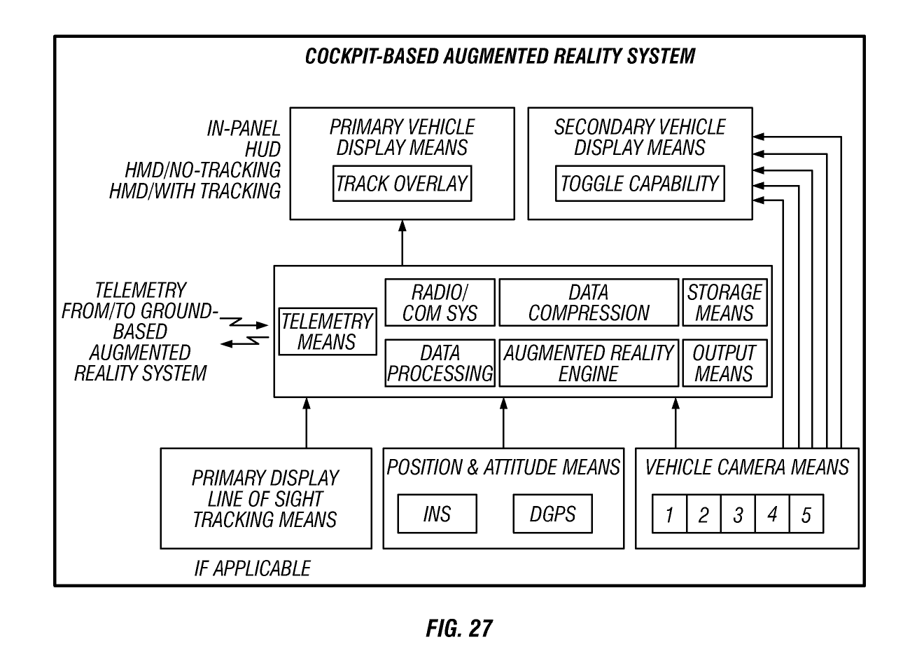

FIG. 27 shows the cockpit-based augmented reality system of the invention. During the race, simulation technology supports the pilots and benefits the fans and league referees as well. The in-cockpit display is the pilot's lifeline to the race course. Each pilot flies within a virtual tunnel, separate from the other racers and delineated by geospatial waypoints. The ‘course’ thus exists purely in virtual space. The pilot's heads-up, or in-cockpit, display visually projects this course in front of the pilot. Overlaid to its exact locations, the simulation technology enables the racer to pilot his or her way through the course in a safe and accurate fashion, exactly as planned from the pre-race training. Information from the team, the league and the craft safety systems are also overlaid in-cockpit for maximum connectivity during flight.

The automated safety systems built into the rocket craft preferably have visual representations displayed both in-cockpit and streamed to the ground crews in real time. The pilot is riding a rich flow of information as well as throttling his or her rocket-powered vehicle through the sky.

The cockpit-based augmented reality system comprises avionics, display means, cameras, data collection means, data processing means, the augmented reality engine, data storage means and telemetry means.

The cockpit-based augmented reality system is manufactured to:
collect, process and display navigation data to the pilot, allowing the pilot to visualize and navigate his or her way through his or her designated tunnel within the virtual race track in the sky;
produce or receive from the ground-based augmented reality system synthetic aids and other safety provisions; and
collect, process and telemeter data to the ground-based augmented reality system linking the fleet of rocket-powered vehicles to the outside world and allowing remote viewers to visualize the virtual track and the position of the rocket powered vehicles within.

The cockpit-based augmented reality system enables the rocket racers to run autonomously through the three-dimensional race track during the course of a race. The system runs independently from the ground-based augmented reality system. There is no connectivity from vehicle to vehicle expect for emergency broadcasts. However, queues and certain data elements are made available to the individual rocket powered vehicles from the ground-based augmented reality system to improve the safety posture of the race. For example, information characterizing the position of the other rocket powered vehicles in three dimensional space may be made available over the telemetry link from the ground-based augmented reality system. Additionally, safety information or emergency broadcasts are made available to each rocket-powered vehicle from the ground-based augmented reality system.

Avionics play a critical role in driving the augmented reality engine with high-fidelity information that characterizes the line of sight of the viewing object, specifically, its position and angular orientation (attitude) in three-dimensional space relative to a common reference system. In order to ensure safe navigation of individual rocket powered vehicles, the position and attitude data must be of sufficiently high resolution throughout the duration of the race event. Any significant build up of errors will cause the pilot to fly outside of his or her designated track. The avionics position and attitude solution may draw INS or GPS-based technologies, individually or in combination.

There are two primary display means embedded within the cockpit-based augmented reality system. The primary means of display shows the virtual track overlay. The secondary means of display allows for the toggling of camera views without the virtual assist. Depending on the phase of implementation, the primary display may take on one of four forms:
in-panel;
heads-up (HUD);
head-mount without line of sight tracking (HMD); or
head-mount with line of sight tracking.

The in-panel display requires a forward-looking video feed along the longitudinal axis of the rocket-powered vehicle. Drawing from the position and attitude data source, the augmented reality engine creates a data overlay that shows the tunnel in three-dimensional space which is designed for the flight path of a particular rocket-powered vehicle. Each rocket-powered vehicle will have its own tunnel in three-dimensional space inside of which the pilot is instructed to remain to provide adequate separation of one rocket-powered vehicle from another. In total, there are multiple individual tunnels (one for each rocket-powered vehicle) clustered together along a primary flight path.

The remaining three primary display options (HUD, HMD without line of sight tracking and HMD with line of sight tracking) do not require a video feed to drive the augmented reality engine. In this case, the virtual track is made available to the pilot on a transparent screen through which the pilot is able to see the real world ahead. In the case of a HUD and the HMD without line of sight tracking, the line of sight information remains fixed relative to the rocket-powered vehicle. In the case of the HMD with line of sight tracking, the line of sight information fed to the augmented reality engine, varies according to the direction the pilot is looking; for example, forward, up the lift vector, or some other variation. In any case, the viewing object line of sight information is simply an input to the augmented reality engine.

### Example 8

### Ground-Based Augmented Reality System

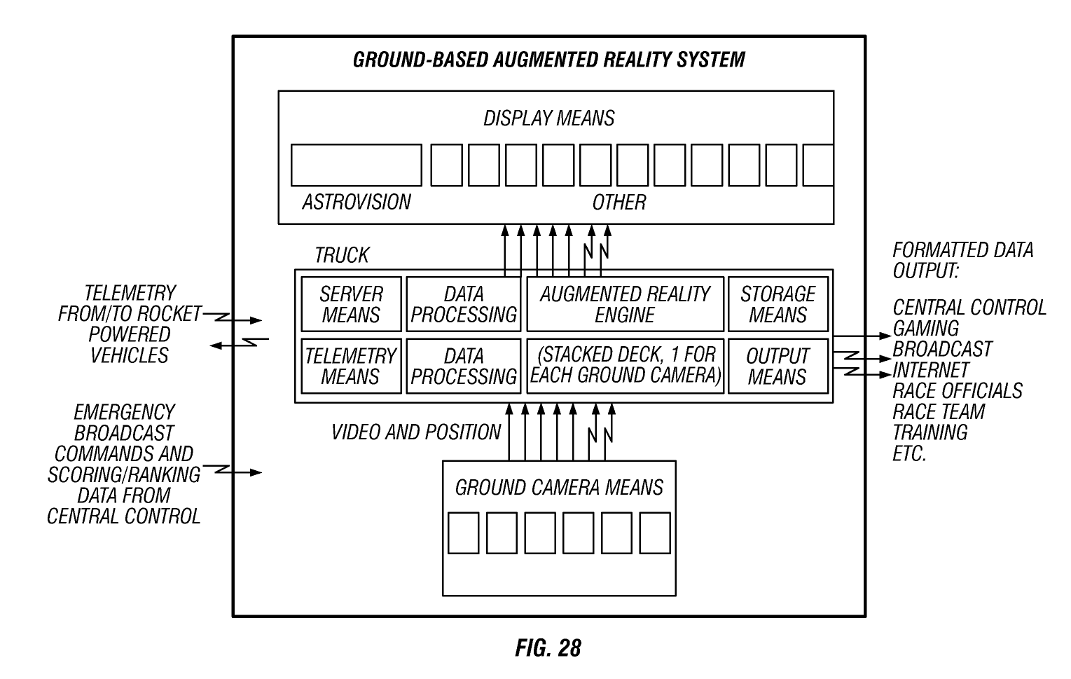

FIG. 28 shows the ground-based augmented reality system of the present invention. The simulation technology has a very public face. The same technology platform that enables the planning and execution of the races also provides the interface to the fans to make rocket-powered vehicle racing immediately accessible to a world audience. Race fans who attend league events are treated to the truly unique experience of watching rocket-powered vehicle competitions first-hand. The rich world of simulated data overlays provide the key to fans full immersion in the race. Each rocket-powered vehicle records the geospatial location and orientation data and transmits it in real time to the ground-based augmented reality system. Giant display screens stationed around the grandstands, and data streamed wirelessly to fans' handheld devices, displays simulated re-creations of the vehicles overlaid onto photo-realistic terrain and even streamed digital video. All of this data is combined in real-time and broadcast to spectators for a rich, immersive look at the details of the race, even as the vehicles soar overhead.

At the same time, fans at home are treated to broadcast feeds to their home media centers. There is a lot going on in the air during the race, and the broadcasts tell the story of the race as it unfolds. The simulation technology platform driving the broadcast allows each fan to customize his or her view of the race, and experience it at home in an infinite variation of viewpoints, information overlays, and virtual camera angles.

The ground-based augmented reality system is at the core of all activity. It provides the primary connectivity between the rocket-powered vehicles and the outside world. It collects, processes and redistributes data in a similar manner to the cockpit-base augmented reality system.

The ground-based augmented reality system comprises display means, cameras, camera trackers, data collection means, data processing means, an augmented reality engine, data storage means, telemetry means and signal conditioning/output means.

Specific functions of the ground-based augmented reality system include, but are not limited to:
collect real-time video, audio, performance, geospatial data from multiple rocket-powered vehicles over a telemetry link;
collect real-time high definition video from a variety of ground-based cameras along with precision tracking information of the camera location and angular orientation;
perform the real-time insertion of the virtual race track and other synthetic objects (“augmented reality”) into select video feeds for the purpose of presenting a combined real-virtual depiction of the race to a variety of end users including, but not limited to, entertainment, safety, scoring and performance monitors;
display augmented reality on a variety of display platforms in public areas throughout the race venue;
store and archive data;
allow for the retrieval and redistribution of archived data to end users, or as formatted statistics during the course of a race;
format and compress data for redistribution to a variety of ground-based end users including but not limited to central control, gaming elements, broadcast elements, Internet, race officials, race teams, training platforms;
format and compress data for redistribution to other rocket-powered vehicles over the telemetry link, (such data may include emergency broadcast, location of other rocket-powered vehicles, timing metrics, ranking information, etc); and
maintain an emergency radio communications link to all rocket-powered vehicles.

Physically, the bulk of the ground-based augmented reality system is contained within a mobile truck or other vehicle. Once the truck is located at a race venue, the network of high-definition cameras, camera tracking capability and display means, are unloaded and located about the venue.

The inputs to the ground-based augmented reality system are the telemetry from the multiple rocket-powered vehicles and the emergency broadcast information from central control. Input from the rocket-powered vehicles is wireless. Input from central control is preferably wired.

Output to the fleet of rocket-powered vehicles is wireless. Output to the remainder of end user outlets preferably is a combination of wired and wireless.

The video and tracking information from the ground-based cameras are part of the ground-based augmented reality system and are not treated as external inputs. The connectivity from the ground cameras and tracking are both preferably wired and wireless.

Representative building blocks for the ground-based augmented reality system are shown below.

### Central Control

Central control is a multi-station console presenting its user with selectable information necessary to monitor safety, broadcast emergency protocol, maintain a scoring of the race and provide play-by-play commentary to the venue.

Central control draws its data from the ground-based augmented reality system and naked-eye inspection. Output is in the form of emergency broadcast data to the ground-based augmented reality system. Certain scoring information may also be made available to the ground-based augmented reality system so that the fleet of rocket-powered vehicles are made aware of their ranking and also so the ground display means may also broadcast the ranking and scoring of the rocket-powered vehicles throughout the course of the race.

### Simulation-Based Platform

The simulation-based platform is the simulation technology platform that applies itself to each individual interfacing with the league. This platform adapts itself, due to the versatile applicability of simulation technology, to all end users. Simulation-based platform touches each one of the cited technology modules.

Examples of specific applications of the simulation-based platform not already addressed within individual technology modules include, but are not limited to:

Rocket-powered vehicle specifications are as follows: The league develops a suite of simulation-based platform (“SBP”) tools for licensing to all teams and airborne components manufacturers. This software program runs on a commercial off-the-shelf (“COTS”) PC, and is suited to developing and testing components for league-sanctioned airborne activities. The system allows anyone involved in air platform manufacturing to develop and test new configurations in a simulated, physics-based environment developed to the league's exacting specifications. The air platform design tools provide a rich, virtual world that fosters innovation (and a culture of safety) within the racing community.

The race course design is as follow: The league uses this SBP tool for course and race design. The true-physics, simulated environment of the air platform design tools are tools for designing courses the vehicles can actually fly, and that have maximum entertainment value. The league develops new course designs for the different races, and the simulation tools at its disposal allow for rapid and collaborative design through all levels of decision-making.

Race team pre-race planning is as follows: Beyond the design of air platforms and race courses, the racing teams use the league simulated environment for true-to-life mission planning. Team management uses the tools to plan the flow of each race upon receipt of the course specifics. The league releases the race path configuration to all teams before each event (e.g. 24 hours prior to the event). Team managers use the simulation platform for race “mission planning” to accommodate all variables inherent in each race. Rocket burn-time, course difficulty and layout, pit stops and other items are combined in myriad ways until the team's optimal flight and race plan are achieved. Again, the true physics environment of the simulation gives an accurate representation of what to expect in the race itself, and is easily accessible to any user familiar with a Windows PC.

### Pilot and Crew Training Infrastructure

The pilot and crew training infrastructure includes but is not limited to:
Pilot and crew instruction;
Simulation-based training;
Flight simulators;
Piston-powered flight vehicle trainer;
Rocket-powered flight vehicle trainer;
Ground support equipment training infrastructure;
Qualification testing; and
Event recorders and interactive playback systems.

Pilots and crews undergo live instruction from league staff in all areas of the league primarily focusing on vehicle and GSE operation and safety. Simulation plays a significant role in this process.

Both rocket racer pilots and their ground crews train and prepare for races using a custom designed simulation technology platform. The same simulated environment that is used for design and management of the races is applicable to individual and group training.

Pilots use the league technology platform for simulation based training (“SBT”) curricula for initial pilot training and recurrent flight operations training. Pilots may have the flexibility to train at any time, in any location. When the virtual course is released to the teams at a specified time (e.g. 24 hours) before the race, the pilots find the data transmitted to their approved training devices. Pilots fly the course over and over as they “cram” for the race the next day. Each pilot thus enters the race with a flight path through his or her course already mapped out. Additionally, the pilots interface with the crew training exercises and race planning being held in parallel for final integration of all race personnel in a simulated, distributed environment mimicking race conditions for optimal readiness, competitiveness and safety.

The ground support crew takes part in the race planning and train on the timing and flow of pit stops and likely service issues during the race. The crew is thus optimally prepared to function seamlessly as part of each racing team. The league technology platform keeps the crews up to date on proper safety procedures, and allows them the flexibility to customize their approach to race support.

Flight simulators may be made available on standard PC platforms and as cockpit mock-ups of the rocket-powered vehicles.

Pilot and crew instructions using actual race qualified hardware may be mandatory for all pilots and crew. Flight training occurs in both piston and rocket-powered trainers. Ground crew operation training occurs with actual GSE hardware using non-volatile and actual fuel sources.

Qualification testing may be mandatory for all pilots and crew prior to being given authorization to engage in a racing event.

During each race event, the ground-based augmented reality system and the cockpit-based augmented reality system records all events for offline playback, review and study.

All aspects of the pilot and crew training infrastructure are designed for a safe event, in full compliance with the FAA.

### Example 9

### Business Process of Revenue Generation Through Rocket-Powered Vehicle Competition, Gaming and Education

The invention can operate as part of business process leading to revenue generation as one form of entertainment through racing competition. Such an infrastructure ultimately yields a model where the racing property takes on value as a form of entertainment.

Rocket-powered vehicle racing competitions can allow for the generation of revenue from a multitude of traditional sources comprising media (broadcast, theatrical, internet, reality, cartoon, documentary, etc.), sponsorship (races, venues, ships), ticket sales, merchandise (toys, apparel, etc.), land development, video games, and touring exhibitions. Each of these can be enabled and enhanced via the rangeless air racing maneuvering instrumentation network, such as the example Network discussed above and illustrated in FIGS. 22 and 23.

Sponsorships can be a major revenue driver for racing events, racing teams and racing promoters. Racing competitions attract racing fans of all ages, ranging from 8-year old children enthralled with the idea of spaceflight, to 40-year old car race fans looking for bigger thrills, to 70-year-old grandparents inspired by Sputnik and the Apollo moon landings. Sponsorship opportunities can be available both in exclusive and non-exclusive categories. Sponsors have the opportunity to be “official” racing sponsors and/or sponsors of individual vehicles. Sponsors can also serve as “race event sponsors,” “racing series sponsors,” and/or could sponsor race awards similar to race car events such as “fastest lap,” “fastest pit stop,” “half way leader,” and “overall series champ,” as examples.

Revenues from sanctioning fees and ticket sales may be generated when promoters pay an annual fee or a portion of ticket sales and race revenues to the owners of the racing competition for the rights to host a sanctioned racing competition event at their facility. In exchange, promoters may recoup their investment and profit from ticket sales, concessions, merchandise, corporate sales, and sponsorship.

Revenues generated from media and broadcast venues may offer a broad range of opportunities to increase awareness about the racing competitions and to drive revenue from the packaging of media comprising, for example, reality television, an animation series, a feature film, an IMAX documentary, dramatic series and broadcast rights to the racing competitive series. The racing competitions may support a media strategy with the production and distribution of a number of DVDs following the race events and series, rocket race vehicle development, and profiles of independent teams/pilots. The racing competition may establish these opportunities as revenue opportunities independently and may also explore “packaged deals” with major producers.

Revenues may be generated through merchandising and licensing of racing competition brands and may serve the market's demand for racing-branded items memorabilia such as hats, t-shirts, posters, bomber jackets, etc. The rocket racing competition may market these offerings both at racing events and through a variety of websites. The racing competition may also license trademark and marketing rights to merchandisers for the production and distribution of toys and other related merchandise.

Revenues may be generated through related racing touring and theme parks. A racing competition tour of major U.S. cities may be instituted where racing fans may be able to seeing a rocket-powered vehicle up-close, meet pilots and enjoy educational initiatives that focus on aviation and aeronautics. The racing competition may pursue theme park sales through offerings such as a racing ride and a racing interactive package comprising film, simulators and games.

Revenues may be generated through gaming. A rocket-powered vehicle based video game and flight simulation package may operate on popular platforms such as the X-BOX, GAME CUBE, PLAYSTATION and personal computers (PCs). Video gaming and flight simulators may enable fans and enthusiasts to race their own virtual rocket race vehicles and compete against friends online while learning about aviation and aerospace.

Fans are able to purchase the league gaming platform and enjoy all of the benefits of being their own racing team without having to actually buy and fly a rocket racer. The simulation technology adopted by the league allows for a rich, immersive gaming environment where they can design, build and fly their own racers on their own, or networked online with each other. Entire competitions of future and armchair racketeers may take place year-round on the gaming platform.

During the races, fans can take their involvement in racing activity further: they can fly in real-time against the racers. Combinations of virtual and live pilots can square off in the simulated world of the distributed simulation platform. Guest racers may appear virtually on the race broadcasts going up against the live racers for promotions or any other league purpose.

The range of gaming and education applications includes but is not limited to a variety of networked and non-networked flight simulators and video games operating on popular platforms, such as the X-Box, Game Cube, PlayStation and PC, enabling fans to race their own virtual x-racers in real time against actual rocket-powered vehicles during race events, as well as compete against friends online while learning about aviation and aerospace.

Specifically, gaming and education applications include but are not limited to:
Stand-along PC-based flight simulator;
Networked PC-based flight simulator with scoring;
Microsoft flight simulator;
X-Box, Game Cube, PlayStation class of games;
X-Box, Game Cube, PlayStation class of games with interaction virtual racer;
Cockpit-based flight simulators; and
Cockpit based flight simulators with augmented reality HMD.

Revenues may be generated through the licensing of intellectual property associated with technologies realized throughout the development and evolution of racing competitions, such as, aircraft designs, navigation systems, fueling capability, and other research and development (R&D) initiatives. This may lead to licensing agreements and the opportunity to sell different applications of the intellectual property.

Revenue may be generated through a variety of other ancillary manners as well. Rocket-powered vehicle competitions may cause technical developments that may have markets outside of the entertainment industry. NASA and the US Department of Defense may be interested in developments in airframes, engines, electronic systems as well as in navigation and position systems.

Many, if not most, of the revenue sources may benefit significantly from use of a Rangeless Air Racing Maneuvering Instrumentation Network, such as the example Network discussed above. Sponsors may target specific audiences by tailoring messages in the virtual world that makes up a significant element of the racing competition. By manipulating synthetic objects, images or messages and combining with real time video of the rocket competition, sponsors gain a new and unmatched level of flexibility of controlling what they display, when it is displayed and to what selective audience certain information is channeled.

### Example 10

### Data Collection and Archival System

In another embodiment, data is collected, archived and available to many end users, preferably in real time. For example, data from an aerial vehicle is collected, archived and available to end users. Examples of data from aerial vehicles include, but are not limited to geospatial data, position, thrust, throttle, velocity, speed, distance from another vehicle or object, engine data, pilot's heart rate and other functions or parameters, G-force, temperature, altitude, location, pressure, photographs, video, audio, and other data streams. This data is available for each vehicle and is distributed to multitudes of end users.

Venue data is also preferably collected, archived and distributed to end users. Examples of venue data available to end users includes but is not limited to photographs, audio, and video streams from ground, aerial or satellite cameras, information from pit crews, augmented reality data, fuel and refueling information, data from racing officials such as scores and rules, penalties and real time modification of a race course and data from the spectators or fans.

In addition, data from other end-users is also collected, archived and distributed to the same or different end-users. This data includes but is not limited to, for example, a person from anywhere in the world can race on a desktop in real time and that person can then distribute his data to other end-users. Or, that end user can provide any other data collected, and/or modified.

End-users for this system can include, but are not limited to garners, FAA officials, TV and cable and radio networks, race officials, online broadcast companies, engineers, designers and advertisers.

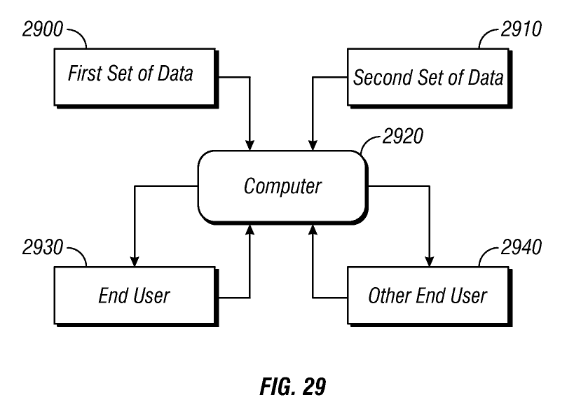

FIG. 29 illustrates an embodiment of the present invention wherein first set of data 2900 and second set of data 2910 is collected. At least a portion of first data 2900 and second data 2910 is preferably provided to one or more computers 2920. Computer 2920 preferably processes the data provided to it before providing the processed data to one or more end-users 2930, 2940. End users 2930 and 2940 may provide their own data to one or more computers 2920 for sharing with other end users.

### Example 11

### Safety in Aircraft/Spacecraft

Aircraft avionics have recently experienced the introduction and increasing adoption of the “glass” cockpit, whereby conventional clusters of analog gauges are replaced by one or several computer driven displays that present to the pilot a large and customizable volume of information never before possible. An example is the Garmin G-1000. Another example is the Rocket Racing League's RITS system (“Raceway in the Sky”) that enables a pilot to fly pre-constructed “boxes” that act as guidance queues through three-dimensional space, particularly useful in giving a pilot a “track” to glide home through, following, for example, the loss of an engine. Other advances in the areas of advanced materials, design, electronics, communications networks, information technology, computing processing power, extended wireless networks, bandwidth and advanced manufacturing have each individually advanced the state-of-the-art within their respective domains, making far better in recent years what once was the accepted norm. An embodiment of the present invention melds these advances together in a way that has not yet been implemented, redefining safety as the grounds-up, deliberate and integrated outcome flowing from the merging of these many disciplines and technologies.

An embodiment of the present invention comprises an aircraft/spacecraft safety, security, diagnostics and convenience system (“ASSDC system”) that is preferably located in the aircraft/spacecraft. In this embodiment, the ASSDC system is preferably live and establishes an integrated architecture that, through activating a button, preferably a single-click highly visible call button, allows a user to connect to a variety of ground-based services. The ground-based services are preferably both manned and automated and provide audible and visual feedback data. The ground-based services also preferably give general guidance on matters of both emergency and convenience.

In another embodiment of the present invention, an activation button comprises an emergency aircraft-specific guidance service that is preferably live, easily accessible, universal and activated in case of emergency. In this embodiment, the ground-based service is comprised of a network of people with access to relevant information to address the matter, whether emergency or convenience. To facilitate a state of readiness, service centers are preferably alerted as soon as an aircraft comes online, and then an ASSDC system is preferably activated. In this embodiment, once an aircraft comes online, the ASSDC system provides appropriate back-end queues to ensure that aircraft-specific expertise is available should the need arise. The ASSDC system preferably comprises tracking, impact assessment, and emergency beacons. As an aircraft moves toward its destination, geographic updates are preferably collected to further enhance the readiness of the system. Updates can include, but are not limited to, preloading information on nearest airports, connectivity to control towers, and the like.

A further embodiment of the present invention comprises a back-up power source such that users remain confident of an ASSDC system's availability in the event of an emergency involving a main power outage. In this embodiment, the ASSDC system connects and communicates with aircraft using wireless technology. Examples of wireless technology include but are not limited to, satellite, cell phone signal, or any other form of wireless technology known to those skilled in the art.

In another embodiment of the present invention, an ASSDC system requires a monthly subscription or use fee or some combination thereof.

In yet another embodiment of the present invention, an ASSDC system comprises remote monitoring of aircraft/spacecraft that further comprises a safety diagnostics report preferably for the pilot and the pilot's family, trajectory plotting and user enhanced browser-based graphics. These features make the flying experience friendly, educational and informative. In an alternative embodiment, the ASSDC system comprises remote diagnostics that evaluate an aircraft's diagnostics prior to take-off. Examples of diagnostics include, but are not limited to, fuel level, oil level, necessary maintenance checks, engine condition, tire pressure and condition of safety devices, such as but not limited to, air bags. In this embodiment, the ASSDC system preferably collects high resolution tracking information, and monitors the vehicles for signs of anomalies through the use of on-board diagnostics instrumentation that are monitored and fed back to the ground where they are analyzed remotely. On-board diagnostics instrumentation can include, but is not limited to, load sensors, accelerometers, attitude indicators, engine diagnostics, environmental sensors, temperature, and possibly physiological indicators from the pilot and crew (pulse, heart rate, etc.), where applicable and combinations thereof.

In a further embodiment of the present invention, an ASSDC system preferably communicates with the ground wirelessly. The ASSDC system preferably draws from already installed infrastructure and is patched together in such a way that multiple levels of redundancy are provided with minimal bandwidth and range limitation, free from dropout associated with moving from one coverage area to the next. Such infrastructure can make use of, but is not limited to making use of, satellite, cellular and other short and long range communication systems currently in use in North America and around the rest of the world. In this embodiment, as wireless communications systems mature, the ASSDC system can make use of the enhanced capability.

In one embodiment of the present invention an ASSDC system comprises remote diagnostics for the aircraft or spacecraft owner to check on the craft prior to arrival for use. The types of diagnostics fed back to the owner, preferably through a browser based system, include but are not limited to, oil and fuel level checks, local temperature, maintenance intervals, and other parameters relevant to safe operation. Connectivity is preferably enabled through a variety of devices, portable or otherwise, including but not limited to, cell phones, PDA's, Blackberry devices, tablets, laptop computers, standard televisions sets and the like.

In another embodiment of the present invention, an ASSDC system comprises family remote monitoring, preferably through a special browser-based interface, or other means. In this embodiment, families or interested parties receive a real-time safety diagnostics report designed to give loved ones peace of mind. Such a system also provides trajectory plotting with user-enhanced and user-personalized browser-based graphics to make the flying experience friendly, educational for children and the rest of the extended family, exciting and informative for all. Graphical based safety checklists are preferably provided, certifying to others that safety features such as impact seats, air bags and ballistic parachute are all operable and ready for use should the need arise. In a preferred embodiment, the ASSDC system comprises built-in provisions allowing communication from a personal computer or grand station to the aircraft, both visual and audible, all designed to enhance the flying experience for the entire extended family, regardless of whether they are in the air or on the ground. Such an ASSDC system is a major selling point to prospective buyers as it helps reduce or remove the barrier associated with perceptions of risk and safety that prevent many from not only taking the initial plunge into aircraft ownership but also sticking with it.

An embodiment of the present invention comprises an ASSDC system that further comprises a theft protection and recovery function. This embodiment provides tracking information that is preferably fed back to ground service and can assist in recovery. Additionally, a station-keeping function alerts the owner or law enforcement by cell phone, text message, email and/or other means, should an aircraft be moved from its primary location by more than a pre-designated distance. Such functionality is useful in monitoring when an aircraft is moved form its tie-down and hangar location, regardless of whether a theft is in process or an aircraft is being moved for a service call or some other authorized activity. A user can locate an aircraft on a conventional satellite map source such as, but not limited to, Google Earth. The display illustrates integrated graphic time-stamped “trajectory” information from location to location. In this embodiment, a user can preferably monitor G-loads during movement, temperature and other parameters, as well as monitors when electrical is activated and the engine is turned over, among other parameters.

In a further embodiment of the present invention, an aircraft comprises safety features that allow the aircraft capable of withstanding more gravitational force, roll and impact. In this embodiment and within the scope of integrated mechanical design enhancements that enhance safety, lies the convergence of materials, design methodologies and the understanding of human tolerance to high G impact and resulting injuries. The automobile race industry has produced a variety of design enhancements that make survivable today what would have resulted in sure death 20 years ago. This embodiment of the present invention draws from best practices in the auto race industry and applies them to the unique situation of aircraft safety. Technologically advanced safety enhancements include, but are not limited to, the following:

1. Roll and crash cage designs capable of absorbing energy on impact and effectively withstanding more G's during impact or subsequent rolling that may occur after impact. For example, cockpit seats are reinforced to withstand impacts of up to 20 G forces.

2. New advanced composites materials and manufacturing techniques that are strong, lightweight and fire resistant

3. Airbags for passenger and pilot

4. Flotation apparatuses for water landings addressing water landing buoyancy issues

5. Ballistic parachute systems

6. Collapsible structures to absorb impact, including modern collapsible foam and composite seats

7. Conformal seats that are triggered by a user once and emergency is established, or are rapidly converted once certain parameters are measured onboard the spacecraft or aircraft. Such conformal seats change through inflation or other means to better capture and restrain where appropriate a passenger to minimize or altogether remove the potential for harm resulting form the emergency situation, such as a crash landing.

8. Wing release or breakup devices that when in crash landing situation are a benefit if it would otherwise cause a spaceship or aircraft the process of making an emergency landing tumble. In such a case, the wings are designed in such a way that they separate from the main fuselage on impact, preventing them from “catching” and causing a tumbling motion to ensue.

9. Carbon nanotubes and other advance materials are preferably used in the manufacture of certain aircraft or spacecraft parts or subassemblies. As safety becomes an always-on design feature, use for light weight strong materials becomes increasingly important.

In a preferred embodiment of the present invention, an ASSDC system responds to an emergency using state of the art electronics. This embodiment removes the burden of responding to the emergency from the pilot of the aircraft and shifts the burden to the system. Pilots very often become overwhelmed with process in the event of an emergency. In a preferred embodiment, an ASSDC system comprises a “go home” or “safe” button that, once activated, will quickly diagnose an emergency and take appropriate actions. For example, in the case of an engine failure, the “safe” function equates to establishing the best glide. Establishment of best glide may be audibly delivered guidance queues by the ASSDC system, or the ASSDC system could alternatively take over in autopilot mode and establish best glide for the aircraft or spacecraft through feedback use of control surfaces. Additionally, once best glide is established, the ASSDC system contemplated herein then provides navigation queues to the nearest airport, and provides audible and visual feedback to users. In a preferred embodiment, the ASSDC system flies the aircraft or spacecraft to the nearest airport, the ultimate goal being a system that, in event of emergency, removes the burden from the pilot.

In another embodiment of the present invention, an ASSDC system comprises a network of visible and/or infrared cameras that are positioned around an aircraft or spacecraft to provide human-in-the-loop or automated inspection capability. Camera inspection is preferably provided for all main areas including but not limited to, engine compartment, wheel wells, prop area behind aircraft and control surfaces. In one embodiment, an infrared camera is capable of detecting hot spots and is useful in low light conditions. This embodiment further comprises synthetic vision and melded vision.

In yet another embodiment of the present invention, powering critical electronics is of paramount importance to effective use of emergency aircraft systems. This embodiment preferably comprises a ram air turbine that extracts energy from an air stream to turn a turbine that powers an electrical generator and recharges batteries or provides power direct to critical components. Such a device may be located anywhere on a vehicle as long as an air passageway is included which channels outside airflow to the face of the turbine, thereby creating the face pressure necessary to drive such a device such that it produced electricity.

Another embodiment of the present invention comprises a rocket propulsion system capable of being installed in a conventional aircraft for the purpose of providing the aircraft with an emergency rapid-action method of thrust augmentation during take-off for the purpose of gaining sufficient altitude to enact recovery and/or abort procedures. This embodiment further comprises providing an aircraft with an emergency rapid-action method of thrust augmentation during any other in-flight condition for the purpose of gaining altitude to enact recovery and/or abort procedures.

In yet another embodiment of the present invention, a rocket propulsion system comprises a solid and/or liquid propulsion system. In a preferred embodiment, the system uses self-contained tanks of liquid oxygen and alcohol, such as, but not limited to, ethanol. In an alternative embodiment, the propulsion system comprises liquid oxygen and kerosene. In a preferred embodiment, a salt water solution is added to the fuel to produce a bright yellow glow from the aircraft/spacecraft.

In a further embodiment of the present invention, a rocket propulsion system comprises a self-contained module enabling the rapid addition of the system into a conventional aircraft. In this embodiment, the propulsion system alternatively comprises a specified number of subsystems to facilitate the rapid integration to an aircraft in its various stages of manufacture.

In another embodiment of the present invention, a rocket propulsion system comprises one or more ignition times during the course of any flight event. This provides the pilot with a low cost, light weight on-demand method of rocket boost that is safe and reliable. Examples of such rocket propulsion systems include, but are not limited to, liquid propulsion systems manufactured by XCOR Aerospace in Mojave, Calif. These rocket propulsion systems are developed and proven at thrust levels that range from tens of pounds of thrust to many thousands of pounds, completely scalable at all intermediate thrust levels. This embodiment differs from previous systems in that conventional rocket assist devices are one-time firing and run to burnout, without the ability to be restarted more than one time.

In yet another embodiment of the present invention, a rocket propulsion system comprises a safe, low-cost, reliable rocket propulsion module capable of being toggled on and off and reused from flight to flight. This embodiment can preferably be used for all civilian and/or military aircraft applications regardless of primary propulsion methods.

### Example 12

### The Rocket-Powered Vehicle

An embodiment of the present invention comprises a rocket powered airborne vehicle or rocket plane. The application of the rocket plane is preferably in the area of rocket racing or exhibition flying with the objective of generating direct or indirect revenue sources or providing entertainment. Other applications include, but are not limited to, adventure seeker experiences, space tourism, satellite insertion, terrain mapping, pilot/astronaut training, and a variety of government/military applications both defensive and offensive.

In one embodiment of the present invention, a rocket plane comprises a multi-role rocket powered aircraft (“MRPA”). The MRPA is essentially an airplane that is powered by a rocket engine, or combination of rocket engines and other means of airplane propulsion. The MRPA is a performance vehicle used in airborne competitions within the sports and entertainment business. The MRPA can also be used recreationally by individuals wishing to own a unique flying machine.

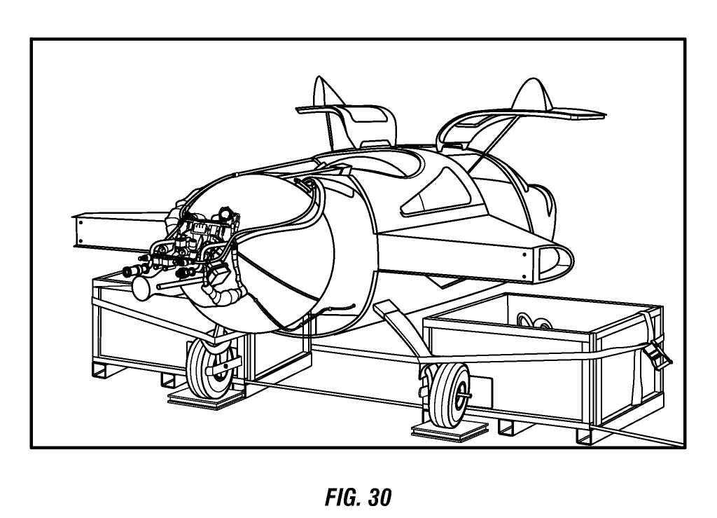

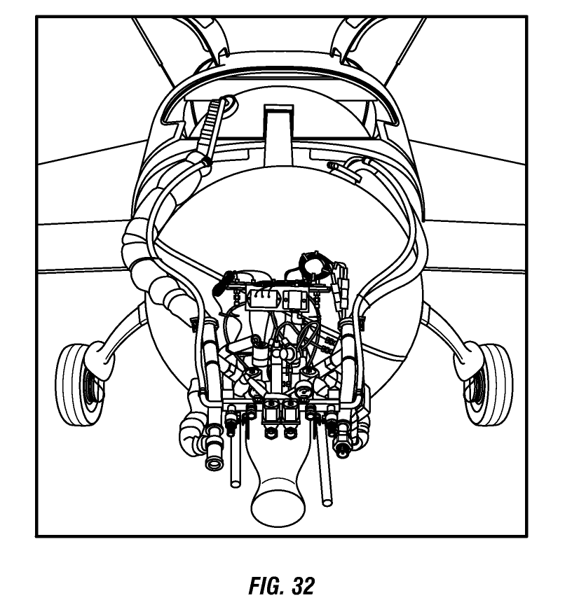

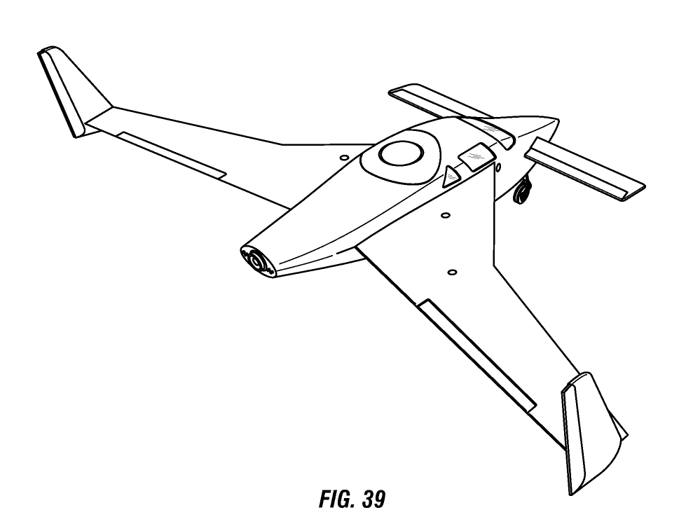

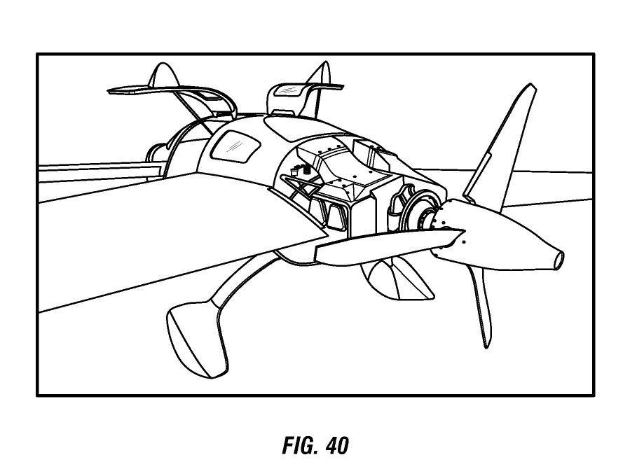

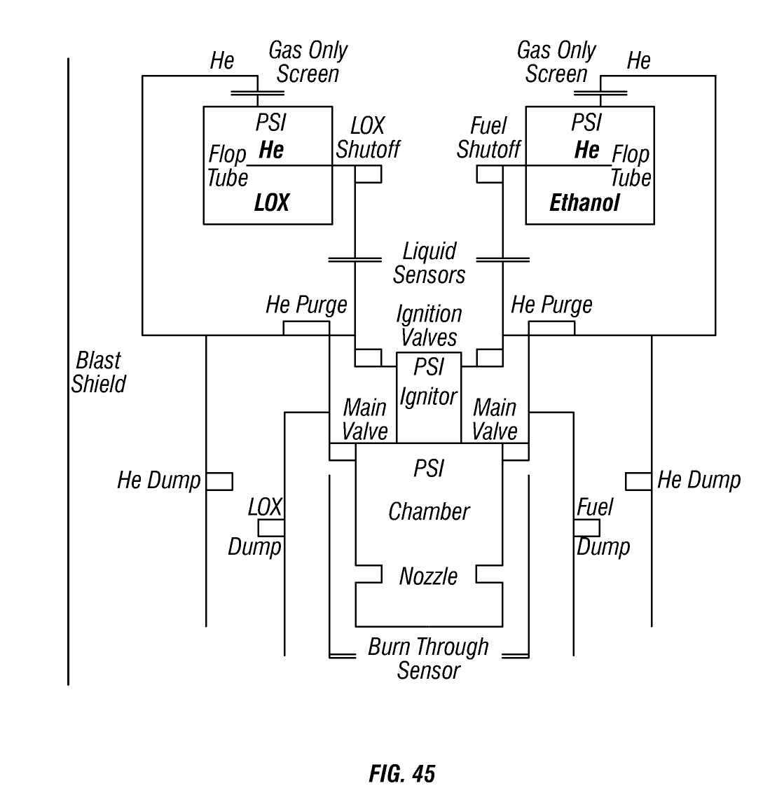

An embodiment of the present invention comprises methods of manufacturing and fielding a rocket plane. This embodiment preferably comprises a rocket plane further comprising unique performance characteristics that make it different from other planes of conventional propulsion means. Design features of this embodiment preferably create a unique flying platform, different from conventional airborne vehicles. Examples of rocket planes are illustrated in FIGS. 30-32 and 39-40. Further, an example of a rocket schematic is illustrated in FIG. 45.

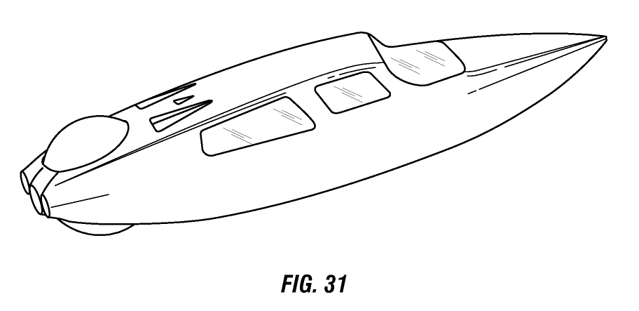

One embodiment of a rocket plane comprises a winged vehicle, capable of horizontal take-off and landing. However, in a secondary embodiment of the invention, a wingless vehicle is contemplated that takes off and lands vertically (see FIG. 31). In this embodiment, the wingless rocket plane takes off under rocket power and flies a substantially vertical path, along with minor horizontal movements to comply with track geometry. Once a flight is completed, the wingless rocket plane may undergo the descent portion of the trajectory under the control of opposing rocket power, or, in addition to and/or in place of a parachute to control descent. Wingless rocket planes may be manned or unmanned. In the case of an unmanned version, the rocket plane is preferably controlled remotely from a ground control station over a wireless link or via artificial intelligence, or both.

In either embodiment of winged or wingless rocket planes, certain features can be included so that viewers from afar can readily distinguish one plane from another. At a fundamental level, visual aids are used to distinguish one rocket plane from another. Color or other markings can also serve this purpose. It is further possible to seed the plume with certain substances in order to color the plume a unique color, thereby enabling the rocket plane to be identified by the color of its plume. In such a case the seed that is injected into the plume is designed to react to produce color when exposed to the heat of the plume in the wake of the rocket plane. Smoke generators that release colored smoke can also be used to correlate specific signatures to specific rocket planes. This is particularly useful for those periods when the rocket engine is off and therefore a plume is not otherwise present.

### Major Components of a Rocket Plane

In one embodiment of the present invention, a rocket plane comprises an airplane that is powered by a rocket engine. As illustrated in FIGS. 30-32, this embodiment preferably comprises an airframe, a rocket propulsion module, an avionics package and ground support equipment (see FIG. 7) necessary to field and operate the rocket plane.

### Airframe Selection and Manufacture

The airframe can be custom designed specifically for the intended purpose of fielding a rocket plane, or it can be a modified version of an airframe typically used with propeller or jet engines.

The airframe preferably provides the structural integrity to house the pilot, propulsion module, and avionics package, and provides the aerodynamic shape necessary to support and control the rocket plane throughout its entire operating range. The airframe can be made from any of a variety of conventional methods involving composite materials that provide strength, are light weight and lend themselves to forming a variety of shapes that are typically more difficult to achieve with conventional sheet metal based designs. One preferred feature of the rocket plane is extended glide capability, which allows other functionality of the system that involves significant glide portions of flight, while facilitating more robust power-off landing scenarios during normal flight procedures, as part of a competition where total time aloft may dictate combinations of boost and glide, and in any emergency where procedure or necessity dictate that the rocket plane land in a power-off mode.

In another embodiment of the present invention, the process of designing and fielding a rocket plane with a conventionally designed airframe originally intended as a propeller or jet powered aircraft, is preferably modified such that the airframe can accept a rocket propulsion system. This modification is preferably known as a conversion package. In this embodiment, modifications to an airframe preferably include, but are not limited to, structural enhancements to carry unique static and inertial loads associates with propellants and engines of rocket planes, relief areas to allow for the protrusion of propellant tanks through the normal envelope of the airframe, rerouted and enhanced control systems, enhanced braking systems to accommodate high takeoff and landing speeds, a custom instrument panel to allow the pilot and flight engineer to safely operate and monitor the rocket propulsion system, and combinations thereof.

### Basic Components of Propulsion Module

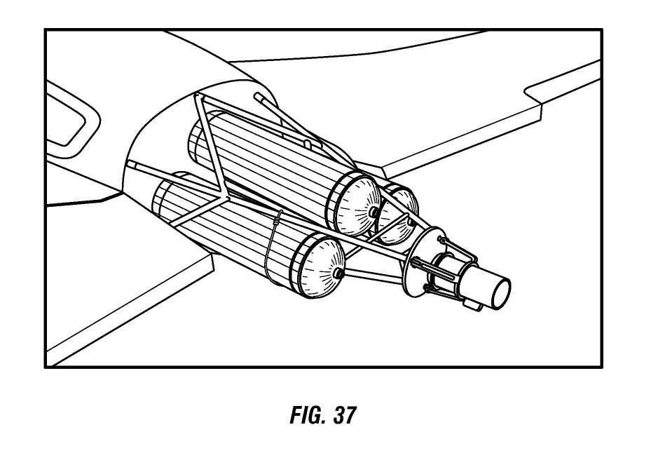

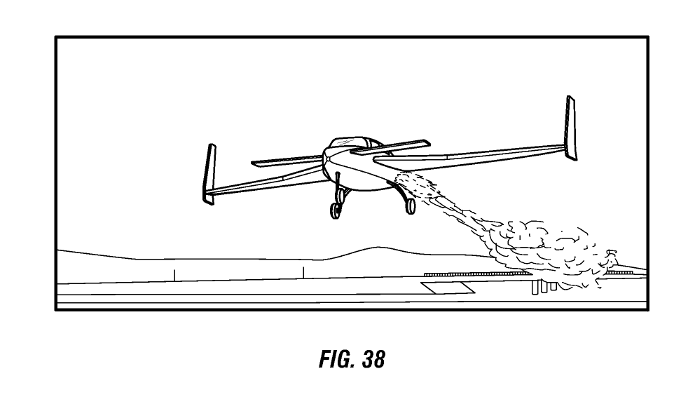

As illustrated in FIGS. 30, 32, and 37, another embodiment of the present invention comprises a rocket propulsion system that powers a rocket plane. The propulsion system preferably contains one or more methods of producing thrust. The airframe may contain one or more types of propulsion systems. Different propulsion systems can accomplish redundant or unique functions. Within the function of boost, there can be a variety of levels, and perhaps propulsion modules, suited specifically for take-off, horizontal acceleration, vertical climb, high G acceleration, low G acceleration, sustain, landing and taxi. While all of these functions can be accomplished with a single propulsion system, it can also be accomplished with a variety of propulsion systems designed to both optimize travel, and for example travel through the race track and the entertainment value to the viewer, whether live, by television, or through some other means.

The rocket propulsion system preferably includes, but is not limited to, a method of carrying and storing propellants, a method of delivering propellants to the engine, an ignition source, a plurality of valves for venting lines, purging lines, loading propellants, unloading propellants, dumping propellants, and combinations thereof. The rocket propulsion system further preferably comprises a combustion chamber, a nozzle, a blast shield system to contain debris should there be an engine failure, instrumentation for operations, diagnostics, monitoring operation, an injector plate through which propellants are preferably delivered to the combustion chamber, a mounting apparatus, one or more pressurant tanks, one or more propellant pumps, engine controls, one or more engine control computers, a fire suppression system, a video systems for diagnostics and entertainment means, custom avionics for flying a virtual raceway in the sky, one or more batteries, burst disks for emergency pressure relief, plume seeding systems for coloring the plume different colors, mechanical mounting systems for components, custom burn-though detectors to detect the burn through of gases, preferably high temperature gases, through the engine wall or critical weld lines, and combinations thereof.

### Propellants for a Rocket Plane

In an embodiment of the present invention, propellants for the rocket plane comprise fuel and an oxidizer. In one embodiment, the rocket plane contains a single liquid rocket engine. The propulsion module is made of propellant tanks, flight computer and engine, as well as all of the enabling components to enable the safe and reliable operation during all phases of the activity including but not limited to pre-flight inspection, propellant and pressurant loading, and leak checking, to flight, pre-flight test firing, boost, relight, shutdown, propellant and pressurant dumping, landing, offloading propellants and pressurant, and post flight activities. The propellants are preferably liquid oxygen (LOX) and ethanol. Other propellants are possible, such as liquid oxygen and kerosene, among others. In one embodiment of the present invention, the main propulsion systems run at two power settings, either zero power (off) or 100% power (on). In another embodiment, the single propulsion module is capable of being set at an increasing number of throttle positions, which provide continuously throttleable power from zero to 100%. It is not the intent of this embodiment to detail the various designs and functional capabilities of such a propulsion module, but instead to point out that in the limit, the rocket plane need be powered by only one propulsion system. By contrast, it is the intent of this embodiment to disclose a form of rocket plane with multiple propulsive means, drawing from any combination of liquid rocket engine, solid fuel rocket motor, hybrid rocket engine, turbojet, turbofan, turboramjet, ramjet, scramjet, conventional propeller or turboprop, or other forms. This embodiment considers every propulsive method a viable candidate for the rocket plane in order to enable it to fly.

In a preferred embodiment, the oxidizer comprises liquid oxygen (LOX) and the fuel comprises ethanol and/or a form of kerosene. Other fuels and oxidizers are possible. In an alternative embodiment, the oxidizer is preferably extracted from the atmosphere at low altitudes, then transitioned into a contained source of oxidizer at altitudes where the atmosphere is thin and the concentration levels of oxygen drops. In a further embodiment, a rocket plane is preferably fielded with solid propellant boosters instead of, or in addition to, liquid rocket propulsion systems.

### Propellant Storage and Delivery to Engine

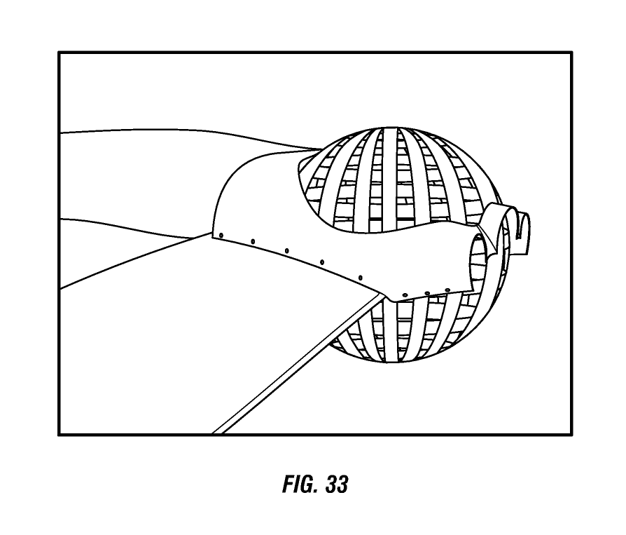

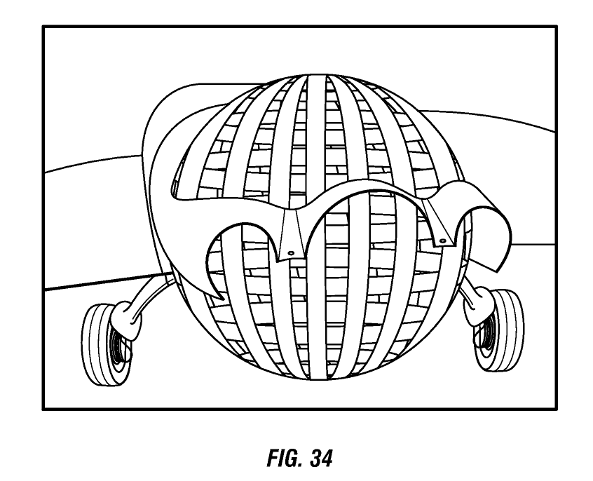

Propellant storage is typically dictated by propellant type, temperature and propellant delivery method. LOX is a cryogen, operating at subzero temperatures which creates a very harsh environment. LOX is preferably kept cool to prevent it from boiling. If LOX boils, the vessel containing it must be vented. Equally important to LOX boiling off is the loss of a useful working load—the more boiling that occurs, the less LOX is available as propellant. Time over which the engine runs prior to depleting its propellant reserves is generally short (2-4 minutes for the current embodiments). Thus, any reduction in LOX through boil-off can degrade overall system performance. To avoid boil off and to ensure that the containment system can withstand the harsh environment of the cryogen, LOX is preferably stored in spherical stainless or aluminum tanks that are insulated, as illustrated in FIGS. 30 and 32-34. This creates a unique design constraint as a sphere does not lend itself to conformal integration of tankage along the natural lines of a typical airframe without wasting considerable space.

Two methods for delivering propellants to an engine are disclosed; pump fed and pressure fed. In one embodiment of the present invention, pump fed propellant delivery uses any of a variety of pumps to transport the propellants from storage tanks to an engine under pressure. While a variety of pump types may be used, a piston pump that is driven by high pressure helium is preferred. In an alternative embodiment, no pump is used and the propellant is driven by overhead pressure introduced into a storage tank.

In a further embodiment of the present invention, LOX is pressure fed by introducing a high pressure gas, preferably helium, into the empty space above the LOX in a tank, preferably a spherical tank. In this embodiment, helium is introduced at preferably approximately 100-500 psi and more preferably approximately 200-400 psi and most preferably approximately 300 psi. The helium is preferably either regulated to a pressure with an onboard source of preferably between approximately 1000 to 10000 psi helium, more preferably between approximately 2000 to 6000 psi helium, and most preferably 4,000 psi helium, or simply allowed to “blow-down” over time. In a non-limiting example, three high pressure bottles of helium are regulated to deliver a constant approximately 300 psia driving pressure to the spherical LOX tank throughout the entire duration of the burn cycle.

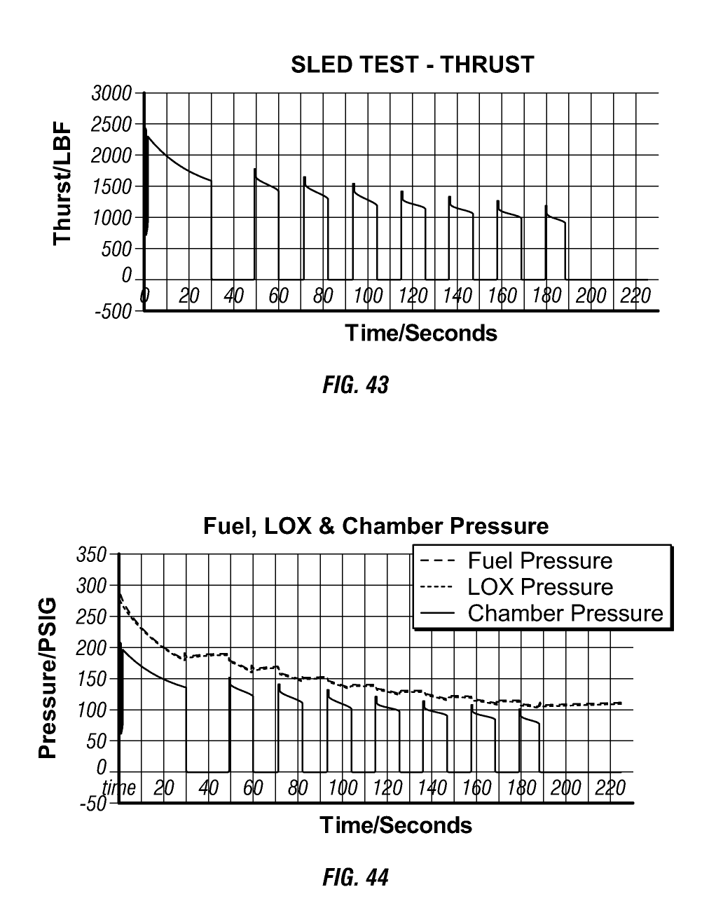

In yet another embodiment of the present invention, helium is preferably introduced into the empty space in the spherical LOX tank pre-flight and allowed to blow down over time. This results in less driving pressure as the LOX is depleted and the helium drops in pressure. This embodiment creates a situation where the amount of LOX delivered to the engine decreases over time, in turn this results in a thrust profile that decays over time (see FIGS. 43-44). One advantage of this type-of blow-down operation is in system simplicity.

In one embodiment of the present invention, the delivery of fuel to the engine is preferably at a pressure that is higher than atmospheric. A constant thrust level throughout is preferred. Conventional wing tanks to hold the fuel is also preferred. However, because wing tanks cannot support a significant level of pressurization without failure, a pump can be used to transport the fuel from the wings to the engine under pressure. The pump is preferably a piston pump that uses regulated helium from the same high pressure sources as described above. In an alternative embodiment, fuel is stored in a tank, preferably a spherical tank that is not insulated, and uses an overhead “ullage” pressure technique to pressure feed the fuel from the tank to the engine, under pressure.

One embodiment of the rocket plane comprises a throttleable LOX-alcohol liquid rocket engine for primary boost, a bank of 10 small solid rocket motors for secondary boost, and a small turbojet for sustain, taxi and landing. The primary boost may be located along the centerline of the rocket plane. The 10 solid rocket motors can be located in clusters of 5 on either side of the aft fuselage, and the turbojet may be located on top of the aft fuselage. The turbojet is used: (1) to taxi during ground operations when not under tow; (2) for sustain mode in flight when the primary of secondary boost are off; (3) during landing to facilitate best approach and provide for emergency go-arounds; (4) during emergencies; and (5) in other scenarios. The primary boost is preferably used during the take-off roll and for acceleration through the second and third gates as contemplated above. The secondary boost is preferably fired to push through a vertical portion of the course to a finish. The secondary boost, preferably comprised of two sets of 5 solid rocket motors, can be fired in pairs to eliminate the induced yaw on the rocket plane. One or more “pairs” of solid rocket motors can be reserved for purposes other than boost along the vertical. For example, it may be desired to hold one pair for emergency climb to altitude, or go-arounds, or pure entertainment during a post-run low-altitude fly-by.

Other combinations of propulsion are easily contemplated to accomplish the purpose of flying a specified mission along a given course. The combination of propulsion systems can be means chosen to meet the needs of performance, safety and entertainment within the design limitations of the rocket plane itself.

### Use of Pressurant in System Purge

Regardless of which storage and propellant delivery scheme is employed, both preferably rely on the use of helium. This creates the requisite need for onboard storage. Helium can be stored in high pressure bottles, and/or as overhead pressure within the LOX and/or fuel tanks, both preferably spherical. In either case, helium preferably serves a second function, that of serving as a high pressure gas to purge the lines, injector plate, manifolds, and engine. This is intended to clear the lines of residual propellants or other contaminants. Purging is preferably performed at a variety of points along the timeline that begins before propellants are loaded and ends after propellants are dumped or unloaded. Purging can occur at any time, for example, in-flight, before and/or after an in-flight engine restart, on the ground between powered taxis and/or static runs. Purging is a safety measure that prevents unintended mixing of propellants and the pooling of unburned propellants, clears lines of water, water vapor or other contaminants.

### Ground Support Equipment

Rocket planes are preferably reusable. For example, a rocket plane can preferably turn around from a flight and fly again in under 10 minutes between flights. During this time a quick inspection occurs, the propellants are reloaded, batteries and recording media would be swapped if necessary, pressurants are reloaded, igniter consumables are replenished, and any other consumable are replaced as necessary. Key to this operation is rapid turn around of ground support equipment that preferably reloads propellants quickly and safely.

### Performance Features

The rocket planes of the several embodiments preferably possess a variety of unique performance features. Examples of performance features include but are not limited to:

An engine that operates unencumbered at points above typical engines. Because the engine carries it own oxidizer source on-board, it does not need to be in the sensible atmosphere to operate. Instead, it can fly to points high in the sky where normal propeller or piston engines would cease to function.

Where rockets typically take off vertically, a rocket plane preferably takes off and lands horizontally on a conventional runway.

Rockets known in the art are typically not reusable. The rocket planes disclosed in these embodiments can be restarted and reused tens if not hundreds of times without a rebuild or major refurbishment.

Rockets known in the art typically cannot be turned around for another flight in a short period of time. The rocket planes of these embodiments are preferably able to be flown again within a very short period of time, ranging from about 5 minutes to 1 hour. This is not at all typical of conventional rockets of any type.

The propulsion modules are also preferably able to be restarted many times in flight. This is not typical for rocket engines.

One embodiment of the present invention comprises a rocket plane with a modulated thrust. The thrust is preferably modulated between two points, zero and 100%. More preferably, the thrust modulates in steps, for example, from zero, to 50% to 100%. As the sequence evolves, the stepwise thrust modulation eventually becomes continuous.

Because of the unique characteristic of the rocket planes of these embodiments, the ability to generate high thrust levels for a given system weight allows for the realization of thrust to weight ratios that are high, and in some instances exceeds 1, and allows for acceleration in purely vertical flight. This typically is not possible except for a certain class of military jets.

In an embodiment of the present invention, airframes are made from composite materials. Generally these materials enable a strong and lightweight airframe in comparison to conventional sheet metal style airframe designs. The light weight composite design further makes realizable the high thrust to weight ratios discussed, giving the rocket planes the ability to perform certain aerobatic routines that would otherwise not be possible if the airframe were driven by a propeller based power plant.

### Instrumentation

In one embodiment of the present invention, instrument suites employed by the rocket plane designs require a unique set of reporting and display functions (see FIG. 8). Such functions include, but are not limited to, nozzle and combustion chamber temperature, continuity sensor for burn-through detector, chamber pressure, igniter pressure, propellant feed line pressures, propellant tank pressures, propellant tank temperatures, strain sensors for critical structural components, liquid/air sensor, burn time, number of burns, igniter voltage, battery voltages, to name a few. In a preferred embodiment, many of these parameters are displayed to the pilot and/or flight engineer so that decisions can be made in real time concerning the health, safety, and continued operation of the rocket plane. Some or all of the parameters are also preferably made available to the flight computer where they are both processed, recorded and wirelessly transmitted to the ground for real-time diagnostics and post-run analysis, at varying data rates depending on the parameter being sensed.

In one non-limiting example, a Blue Mountain EFIS (electronic flight control system) was modified to accept inputs from a variety of instrumentation used for performing monitoring and diagnostic of the rocket propulsion module. This information was converted to digital form and presented on the EFIS display to the pilot. In this example, the data refresh rate was set for use with a conventional propeller driven aircraft. This data refresh rate was insufficient to capture the more aggressive and higher rate maneuvers that are preferable for rocket planes. The result was that the instruments lagged the rocket plane, and the pilot could not rely on the instrumentation. Thus, in an embodiment of the present invention, a refresh rate preferably ensures that the time response and dynamic range of each of the instruments feeding the EFIS are sufficient to properly capture high rates of change.

In another non-limiting example, a custom VGA display was used to display relevant parameters. In this example, a flight computer collected the data, converted the data to the proper digital format for display, and the data was then displayed both numerically and graphically on a display preferably mounted in the instrument panel in front of the pilot.

### Computer Control

In an embodiment of the present invention, rocket planes use computer control to varying degrees. The operation of a propulsion system and a flight control system are preferably controlled using a combination of computer control, electro-mechanical and mechanical control. Computer control systems preferably comprise back-ups. In this embodiment, a rocket plane comprises a secondary computer to preferably monitor the performance of the first computer. This secondary computer is preferably called “the watchdog”. In one embodiment, if “the watchdog” detects a malfunction of the primary engine control computer, a signal is sent to the pilot, flight engineer and ground support. The watchdog may then take over and proceed to shut the engine down if warranted, or put the control and shutdown of the engine in the hands of the pilot. In an alternative embodiment, ground support intervenes, shutting down the engine from a ground computer that is linked wirelessly to the flight computer on board the rocket plane. In these embodiments, if a pilot needs to shut down the engine, a number of options are available that all eventually shutdown flow of propellants to the combustion chamber. This process is preferably performed by shutting the valves in the lines that feed the injector plate that in turn feeds the combustion chamber.

Computer control of the rocket propulsion module is one preferable method of operating a rocket plane.

### Camera Systems

In an embodiment of the present invention, a rocket plane preferably comprises a plurality of embedded video systems that preferably provide visual diagnostic information to the pilot during operation and the ground crew post-flight. For example, video cameras point from the wingtip back toward the engine. This video camera position shows a pilot a visual method of monitoring the engine for anomalous behavior. These video cameras preferably provide the pilot with a visual queue, enabling him to interrogate other sensors and/or take immediate corrective action.

### Throttling and Control

Another embodiment of the present invention comprises a fly-by wire throttle system. In this embodiment, there is preferably no mechanical linkage from the throttle to the valves that allow propellants to flow into the engine.

In one embodiment, the throttle comprises a two position lever that causes an electrical switch to change position when the throttle is moved forward. On changing position, an electric change in state is recorded and the ignitions sequence is initiated.

In a second embodiment, the throttle position is preferably a continuous or stepwise-continuous function of position that is translated by electrical or electronic means into appropriate propellant valve positions necessary to achieve the commanded thrust levels. In an alternative embodiment, a pilot has two throttle positions, zero and 100%. In a preferred embodiment, there are three throttle positions, the pilot is able to command zero, 50% and 100%. In a more preferred embodiment, a pilot is ultimately able to command thrust levels continuously along the entire power curve.

### Engine Cooling

Cooling the combustion chamber and nozzle on the rocket propulsion systems disclosed herein is critical to the life, integrity and safety of the engine. There are a variety of methods available for cooling the walls of the chamber and nozzle. In one embodiment of the present invention, case fuel is circulated through a jacket surrounding the nozzle and chamber thereby picking up heat and reducing the temperature of the nozzle and chamber walls sufficiently to maintain steady state operation. Once the fuel has picked up heat from the chamber and nozzle wall, it is forced into the injector and ultimately burned in the chamber on mixing with the oxidizer.

In another embodiment of the present invention, fuel is injected in a circumferential ring of holes along the inner surface of the combustion chamber and nozzle walls. In this embodiment, up to approximately 25% of the total fuel flow is used for this purpose.

### Safety

There are a variety of design features that enhance the safety of rocket planes.

In an embodiment of the present invention, a burn-through sensor activates when hot gases inside the combustion chamber and nozzle burn through the wall. The sensor is preferably a wire that is wrapped in a deliberate pattern around and along the outer surface of the engine. When the wire is broken, continuity of signal is interrupted and an appropriate signal is presented to the pilot and engine control computer so that corrective and appropriate action maybe taken.

In another embodiment of the present invention, the LOX tank is isolated from the crew compartment by a composite bulkhead to prevent gaseous oxygen from migrating forward in the event of a leak. The LOX tank compartment is maintained at a positive pressure so that any escape of gaseous or liquid oxygen is forced through a vent in the fuselage to the outside atmosphere. Positive pressure is maintained by running a blower fan forcing air from the crew compartment through an opening into the LOX compartment. In this embodiment, an air scoop is preferably set in place on the upper surface of the fuselage above the LOX tank such that ram air is captured and forced into the LOX compartment to maintain a positive pressure.

Another embodiment of the present invention comprises a fire suppression system that is used in the engine compartment behind the firewall and also in the LOX compartment. In this embodiment, a standard Halon fire suppression system is preferably employed. In an alternative embodiment, helium is vented into the compartments to starve the fire and displace combustibles.

In situations where the pilot may be unaware of certain safety issues, a ground crew is preferably always monitoring the rocket plane both visually and through computer driven interrogation of data received back from the rocket plane in real time on a board wireless telemetry system. By placing the ground crew in the loop, a second level of safety is provided. The ground crew further preferably maintains the option to issue a certain set of commands that are uplinked to the rocket plane wirelessly such that corrective action is taken to mitigate safety concerns in the absence of the pilot's direct authority or intervention. The number of actions available from the ground is affected by where the pilot is operating the rocket plane and under what conditions. Intervention from the ground without pilot consent is not always allowed.

### Navigation

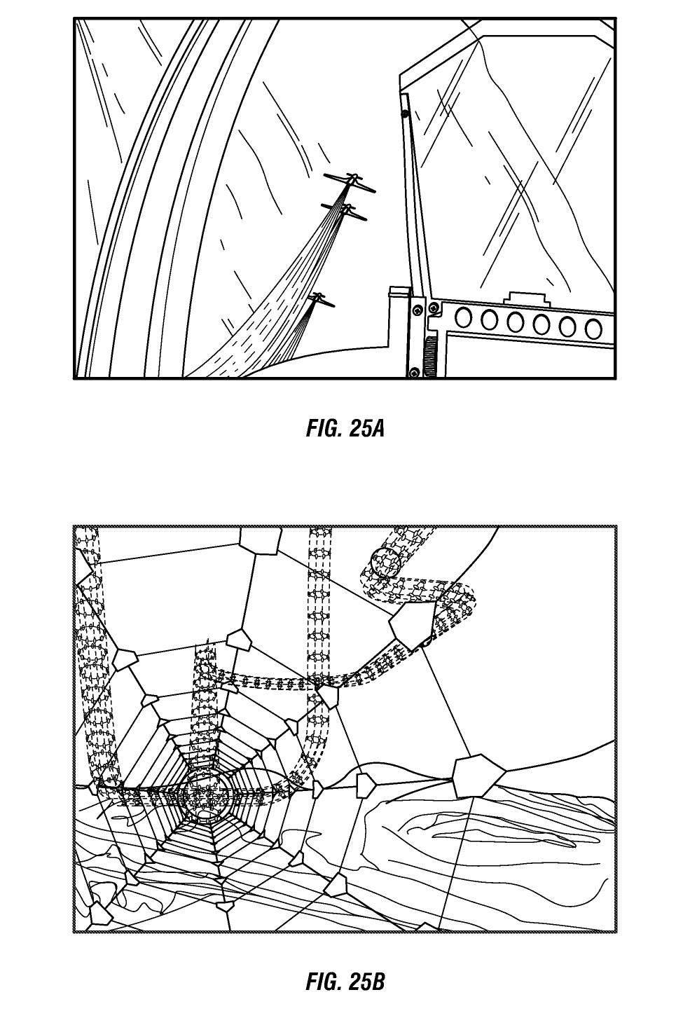

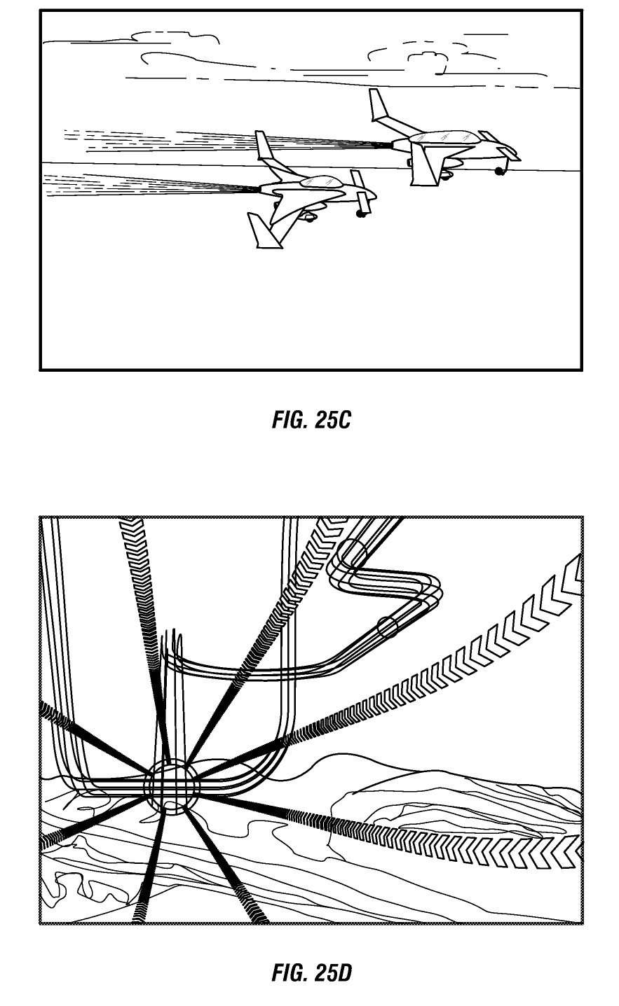

Another embodiment of the present invention comprises navigation that melds the real and virtual worlds (see FIGS. 25A-25B). In this embodiment, a pilot is presented with a visual depiction of the environment that is rich in visual navigation aids. By knowing the time-dependent position in space of one or more rocket planes, and by sharing this information between planes, a user synthetically inserts into the field of view of a forward looking calibrated camera, synthetic objects of a variety of form and function. One example of a synthetic object comprises pathways in the sky inside of which pilots are guided to accomplish certain goals including but not limited to precision flying to serve the purpose of maintaining separation from other vehicles, performing maneuvers, and a combination thereof. Another example includes providing visual aids to indicate the presence of other vehicles in the sky. Still another example creates a view of the rocket plane from a perspective outside the vehicle, an exocentric view.

### Entertainment Platform

In one embodiment of the present invention, rocket planes comprise components of a larger entertainment platform having certain features that allow fans an unprecedented interactive experience. These features include, but are not limited to:

1. On-board camera network: each rocket plane is preferably equipped with a variety of video cameras, each capturing a different view of the space in and around the rocket plane (see FIG. 22). Coverage can include forward looking from the point-of-view of the pilot for flight engineer, a view of the instrument panel, a view of the pilot, a view of the engine from a wing tip, a view of the rocket plume, a view of the ground, and potential views upwards and to either side of the rocket plane. Capturing these streams of video, storing them in high resolution for later retrieval, transmitting them to a ground receiving station in real time for real time production of broadcast content, and redistribution to other end users including the Internet, are all available uses for the video. This on-board camera network brings the experience of flying in a rocket plane to fans, whether they are live onsite, live on the other side of the world, or are in front of a TV screen some number of months after the flight itself. Camera bands are visible, infrared, combinations thereof and the like.

2. Audio capture: There are a variety of audio feeds that lend themselves to the goal of recreating the experience of flying in a rocket plane at remote locations, either live or post-event. These audio feeds include, but are not limited to, interaction of the pilot with flight engineer, interaction of the pilot with the ground crew, interaction of the pilot with the air boss, interaction of the pilot with air traffic control, the sounds of flight created by air passing over the rocket plane, the sound of the rocket engine firing from the cockpit, the sound of the rocket engine firing from outside the aircraft, the sounds experienced in the cockpit from other rocket planes passing nearby, and combinations thereof. Each of these audio streams are preferably recorded onboard the rocket plane for post-production activities, and are also transmitted to the ground for live production. It is also preferable to allow audio/visual interaction between the fans on the ground.

3. Crew biometrics: As part of the on-board entertainment platform, the health of the crew, in particular the pilot, is monitored as a means of recreating the experience for remote viewer. Heart rate and pulse are well known to vary with the intensity of an experience and are useful in conveying to remote viewers the experience of being in a rocket plane. Other biometrics, such as temperature and blood pressure are also preferably monitored.

4. Augmented Reality: The on-board entertainment platform preferably comprises an augmented reality system that melds the real world with the virtual world (see FIGS. 26-28). The augmented reality system preferably incorporates synthetic objects into real time video such that the stream scene is augmented to serve a variety of purposes. One such purpose is to introduce a track or path into the video stream coming from a forward looking camera such that the pilot flies his rocket plane through it. The use of such a function is in racing within such a virtual track in the sky. Such a melded video of a forward looking camera is stored on board for post production and wirelessly transmitted to the ground for live production, all designed to recreate for fans what the pilot experiences in the cockpit. By collecting position and attitude data on each of a fleet of rocket planes, and sharing that information in real time, or offline for post production, a user recreates the playing field from a variety of perspectives in purely synthetic space, or melds real world and synthetic. For example, upon receiving all the position and attitude data from a fleet of airborne rocket planes, a ground station creates any of a variety of perspectives of the playing field complete with synthetic depiction of terrain, sky and other rocket planes. The perspective can preferably be from a moving point in the sky trailing a rocket plane, from the cockpit look forward, from the engine compartment looking backwards, or any of an infinite number of perspectives.

The preferred avionics suite is standard to conventional aircraft except for the inclusion of the cockpit based augmented reality system (“CBARS”) (See FIGS. 26, 27 and 28). In summary, CBARS is preferably the system that melds the real and virtual worlds in such as way that the output presented to the pilot is augmented with navigation, safety and competition queues, including but not limited to, presentation of virtual track to be flown in competition, flight director queues to assist pilot in staying in course, presentation of virtual scoring elements, scoring and placement in competition, location and score of other competition vehicle within the playing field, virtual gates, augmentation of physical gates, safety aids, navigation aids, best path home in case of emergency presented to the pilot as a series of gates, purely synthetic exocentric view of the entire playing field so that the pilot can access where he stands with respect to the competition, combinations thereof and the like.

### Racing Platform

In one embodiment of the present invention, rocket planes lend themselves to serving as a racing vehicle as part of a larger racing platform and comprise the entertainment features discussed above.

### Training Platform

In another embodiment of the present invention, rocket planes comprise training opportunities for astronauts flying other rocket powered vehicles in the suborbital or orbital classes.

### Education Platform

In yet another embodiment of the present invention, rocket planes educate people interested in learning about flight, rockets, or other aspects within the aviation or space industries.

### Performance Enhancements

In one embodiment of the present invention, rocket planes comprise a plurality of performance enhancements. These enhancements can include, but are not limited to:

### Ram Air Power Generator

Rocket planes of this embodiment are preferably battery powered. Powering critical electronics assists in effective use of emergency aircraft systems. This embodiment comprises a ram air turbine that preferably extracts energy from the air stream to turn a turbine that powers an electrical generator and recharges batteries or provides power directly to critical components. The ram air turbine can be located most anywhere on a rocket plane as long as an air passageway is included. The air passageway preferably channels outside airflow to the face of the turbine, thereby creating the face pressure necessary to drive the ram air turbine such that it produces electricity.

### Helmet-Mount, Visor-Mount and Heads-Up Display

The display which presents to the pilot and flight engineer the augmented reality system, navigation aids or other performance and monitoring metrics is preferably configured along a user's line of sight and not in the instrument panel. There are a variety of heads-up display options, as well as helmet and visor mount options. A key feature of helmet mount and visor mount display is to preferably track the movement of the user's head and adjust the augmented reality system as a function of look angle.

### Suborbital

In one embodiment of the present invention, a rocket plane is configured for higher altitudes. This embodiment preferably comprises an airframe design capable of high G aerodynamic loading. Pressurization of the cabin and a heat shield protection system are also included in this embodiment. The rocket plane of this embodiment preferably reaches suborbital altitudes and more preferably orbital altitudes. In an alternative embodiment, a rocket plane comprises point-to-point flight, whether city to city, state to state or continent to continent.

### Sustain, Ferry and Taxi

One embodiment of the present invention comprises methods to sustain, ferry and taxi, thereby expanding the mobility and usability of rocket planes. Rocket planes using these methods comprise either a separate propulsion system or a fully throttleable system. For the sustain method, when the rocket engine is not firing, a lower level of thrust is preferably provided to sustain flight and maintain altitude. Likewise, the rocket plane is preferably ferry capable, and increases its range to a staging where it would then fire its rocket engine. A low level of thrust enables taxi capability while on the runway without firing the rocket engine. There are a variety of engine options to perform these functions including but not limited to, microjets and small propeller engines,

### Solid Rocket Boosters

Solid rocket boosters are preferably used in place of or as a supplement to, the liquid rocket engine. As a supplement, solid rocket boosters enhance performance for specific maneuvers. As a replacement to liquid rocket engines, solid rocket boosters are preferably the primary propulsion mechanism, and are preferably in clusters such that one booster is fired between extended glides.

### Igniter as Thrust Enhancer

As an alternative means of providing a low level of thrust for sustain, taxi or ferry, an embodiment of the present invention comprises an igniter which produces a low thrust level when it runs, and is powered by the same fuel used by the primary rocket propulsion module.

### Safety

Pilots very often become overwhelmed with procedure in the event of an emergency. One embodiment of the present invention comprises a “go home” or “safe” button that, once activated, quickly diagnoses the emergency and takes appropriate actions. In a non-limiting example, in the case of an engine failure, the “safe” function equates to establishing the best glide. Establishment of best glide is preferably audibly delivered guidance queues by the “safe” button system, or alternatively, the system takes over in autopilot mode and establishes best glide for the rocket plane through feedback use of control surfaces. Once best glide is established, the system provides navigation queues to the nearest airport, providing audible and visual feedback to the users. In a preferred embodiment, the system flies the aircraft or spacecraft to the nearest airport, removing the burden of an emergency situation from the pilot.

### Transportation

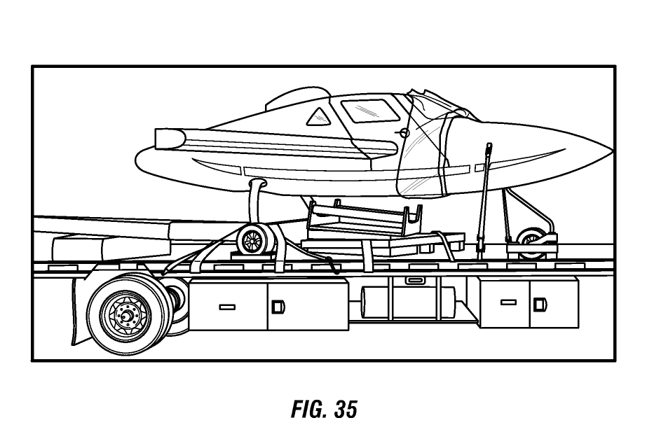

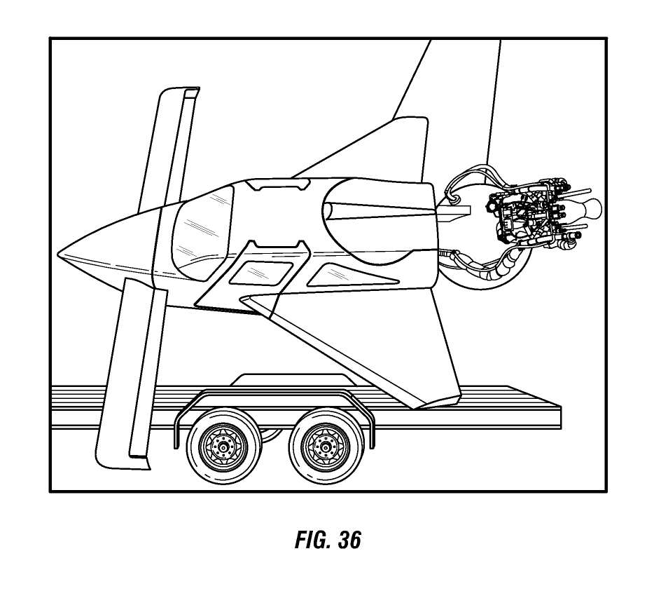

In an embodiment of the present invention, towing on a flat bed truck is the primary method for transporting the rocket plane. As illustrated in FIGS. 35 and 36, this embodiment comprises a trailer that secures and transports the airframe in a horizontal position or tilts the airframe with the wings off in order for the width to remain within standard width load restrictions. The trailer preferably uses a hydraulic lift to tilt the rocket plane and otherwise secure it such that it remains stationary under normal loading conditions while driving.

### Mechanical Design Enhancements

The automobile race industry has produced a variety of design enhancements that make survivable today what would have resulted in sure death 20 years ago. Embodiments of the present invention draw from best practices in the auto race industry and apply them to the unique application of rocket plane safety. An embodiment of the present invention comprises advanced safety enhancements, including but not limited to:

1. Roll and crash cage designs capable of absorbing energy on impact and effectively withstanding more G's during impact or subsequent rolling that may occur after impact.

2. New advanced composites materials and manufacturing techniques that are strong, lightweight and fire resistant.

3. Airbags for passenger and pilot.

4. Flotation devices for water landings addressing water landing buoyancy issues.

5. Ballistic parachute systems.

6. Collapsible structures to absorb impact, including a modern collapsible foam and composite seat.

7. Conformal seats that are triggered by the user once an emergency is established, or are rapidly converted once certain parameters are measured onboard the rocket plane. Such conformal seats change through inflation or other means to better capture and restrain where appropriate a passenger to minimize or altogether remove the potential for harm resulting from the emergency situation, such as a crash landing.

8. Wing release or breakup in crash landing when making an emergency landing tumble. In this design, the wings separate from the main fuselage on impact, preventing them from “catching” and causing a tumbling motion.

9. Carbon nanotubes and other advanced materials are preferably used in the manufacture of certain rocket plane parts or subassemblies. These nanotubes and other advanced materials are light weight and strong materials.

### Example 12

This non-limiting example comprises an engine specification for a rocket plane.

Construction:

Fully welded

All 310 Stainless Steel

Integral igniter w/ radial injection

Double concentric rings of FOOF injector elements (Fuel-Oxidizer-Oxidizer-Fuel)

Annular film cooling holes

No parts consumed in the normal operation except propellant

Reusable with loading of new propellants

Dimensions:

| Propulsion Module Dry Weight | ~500-lbm (includes tanks and valves) |
|---|---|
| Engine (chamber, nozzle) | ~15-lbm (without valves or tanks) |
| Overall Length of chamber + | 21.0″ (from exit bell to top of |
| nozzle | mounting pin) |
| Chamber Diameter | 6.39″ (ID max) |
| Throat Diameter | 3.50″ |
| Chamber Wall | 0.10″ |
| Throat Wall | 0.25″ |
| Exit Bell Diameter | 5.00″ |

Propellants:

| | |
|---|---|
| Oxidizer | LOX (Liquid Oxygen) |
| Fuel | Ethanol (Ethyl Alcohol) |
| Propellant Load | ~1,400-lbm (800 lbm Ethanol, 600 lbm LOX) |
| O/F Ratio | 1.35:1 (Includes the Film Cooling Fuel) |
| Film Cooling | 25% (Of total fuel load) |
| LOX Tank Size | 40″ diameter sphere |
| Ethanol Tank Size | 40″ Diameter Sphere |

Igniter:

| | |
|---|---|
| Oxidizer | GOX (Gaseous Oxygen) |
| Fuel | Ethanol (Ethyl Alcohol) |

Performance:

| | |
|---|---|
| Max Thrust | 2,000-lbf (at 300-psig tank pressure) |
| Min Thrust | 750-lbf (at 120-psig tank pressure) |

Operation:

| | |
|---|---|
| Total run time | 2-4 minutes |
| # restarts per full load | 10-40 |
| Minimum burn time | ~1 second |
| Maximum burn time | >20 seconds on climb, otherwise short bursts |
| Start up time | Less than one second |

Throttle: Three position (engine OFF, HALF power, FULL)

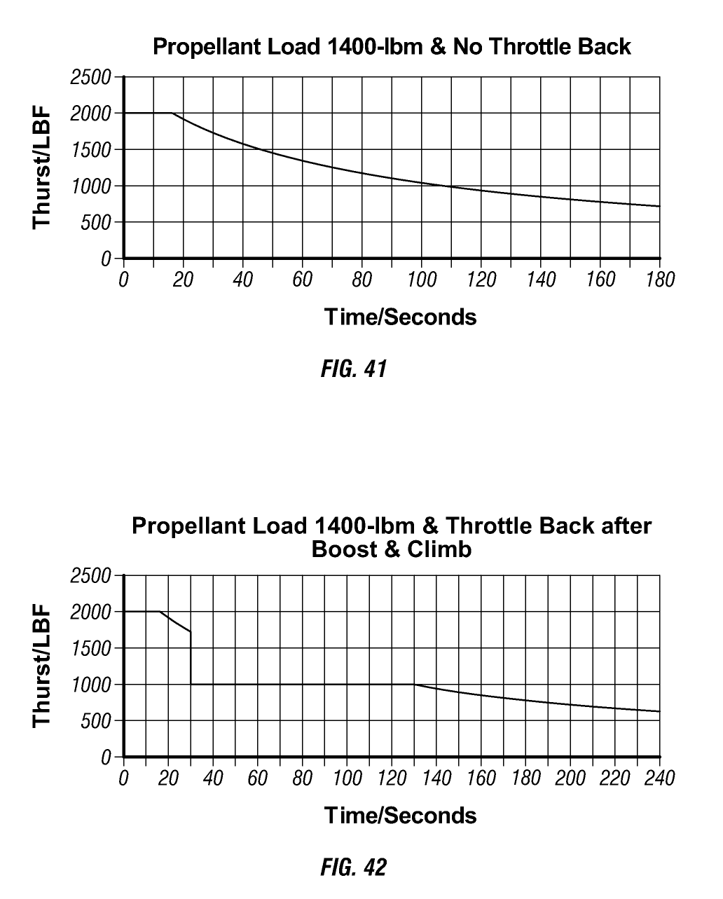

Typical provisional burn profiles are illustrated in FIGS. 41-42. FIG. 41 is for running at the FULL throttle position throughout the mission. FIG. 42 is for HALF power burns after the initial 30-second burn for take-off and altitude gain. In practice, the period between 30-seconds and propellant depletion is a series of 10-15 second bursts totaling the residual time. More burns deplete the helium ullage pressure and reduce the thrust by a small factor.

A typical burn profile is illustrated in FIG. 43. Please note that this particular run was with less propellants and smaller test tanks. The propellant burn rate varies with tank pressure and valve opening fraction, but it is in the range of 15-lbm/sec maximum to 5-lbm/sec minimum. The motor also decreases in efficiency as the mission progresses because of thermodynamic effects related to operating pressures inside the engine and flow characteristics. Typical ullage pressure and chamber pressure decay curves are illustrated in FIG. 44. Again these refer to the sled test above and are shown as an example only.

In one embodiment of the present invention, the rocket plane serves as a racing vehicle that competes with other like vehicles in pursuit of the fastest time to the finish line. In such an embodiment, one or more rocket planes line up at the start line for the competition. The start line may be a physical line drawn across the width of a runway where each of the rocket plane lines up to compete. Alternatively, the starting line may be a point in the sky, governed by a three dimensional point or line in space. Such a starting line in the sky can be visualized by suspending a string or fabric between multiple points supported by structures protruding from the ground, or suspended by other airborne vehicles such as, but not limited to, blimps, balloons or helicopters. Alternatively, the starting line can be a virtual element that is fixed in space as governed by a set of three dimensional coordinates describing its position, but viewable only with the aid of special display means that present either a purely virtual depiction of the world that the users (pilots, viewing public, race officials, pit crews, TV networks, safety officials, etc.) view or some form of melded real and virtual depiction of the playing field.

Such display means are preferably presented to the pilot in one or several of a variety of forms including but not limited to a display in the instrument panel of his rocket plane, a display separate from his instrument panel but not in his direct line of sight, a conventional “heads-up” display of the type commonly employed by the military and by high end jets, or so-called visor-mount or head-mount display where the display means is worn by the pilot or attached to his helmet. In the latter example of head-mount or visor-mount display, the graphic presented to the pilot can be allowed to vary depending on where the pilot is looking. This is accomplished through a tracking capability where the look angle of the user is monitored and tracked through one or more of a variety of means and the graphic that is presented to the pilot is adjusted according to the where he is actually looking.

The starting line is an established place in three dimensional space where the competition begins. If the starting line is on the ground and runs across the runway, then the race may begin with each of the rocket planes sitting statically on the runway, waiting for the appropriate queue to begin the race, at which time the engines are engaged and the pursuit for victory commences. Alternatively, if the starting line is in the sky, then commencing the race from a static or zero-velocity condition is not realistic. In such a case, one contemplates a moving start where the competition vehicles (rocket planes) position themselves in the sky such that they are flying toward the starting line in a manner that causes them to arrive at the same velocity within some allowable variability. At that time the race begins and the pilots engage the engines in pursuit of victory. In one scenario, the rocket planes glide to the starting line in the sky so that the engines are ignited simultaneously with reaching the starting line. In another scenario, the rocket planes reach the starting line by modulating the thrust level from a propulsion means that may or may not be the primary propulsion means used during the official portions of the race. In either case, on reaching the starting line the competition begins.

The competition itself is in one embodiment a simple race to the finish. The shortest time from the starting line to the finish line wins. However, there are a variety of race features that can further influence the outcome of the competition such that best time alone is not enough to win. Opportunities for extra points and penalties for non-adherence to a nominal rule set can also influence the outcome of a race. For example, pilots can be given the opportunity to gain extra points by performing certain maneuvers, or a pilot can lose points for starting the engine early. Regardless, once the rocket plane hits the starting line the race commences.

In one embodiment of the present invention, the rocket planes begin from a runway in a static position, engage the propulsion system, undergo a low transition take-off, then fly low over the runway to a series of gates. A gate is a physical or virtual element that may be presented to the pilots in a manner similar to the starting line. In one embodiment, the entire track forms an “L” with four gates: [1] starting line, [2] gate 1 of first turn, [3] gate 2 of first turn, and [4] finish line. In such a case, the rocket planes may undergo a short-roll take-off from gate 1 (starting line), high powered flight down the runway at low altitude to the second gate where the pilot may fly beneath it, immediately turn vertical such that the third gates passes beneath the rocket plane, then powered vertical flight to the forth gate (finish line). The gates 2 and 3 can be positioned such that upon flying under the first gate the pilot can pull up hard in order to fly over the second gate that is located some distance behind and above the first gate, staggered in such a way to force the pilot to pull an aggressive, high acceleration maneuver to pass. In this embodiment of a race course, gates 2 and 3 form the corner of the “L”. Gate 4, or the finish line, can be at any altitude from several thousand feet to many hundreds of thousands of feet.

There are an infinite number of racetrack shapes, with an infinite combination of turns at an infinite number of altitudes. The desirable outcome of shape and gate selection is to create content that is valuable to the viewing public as a live spectator sport or sport for television. In either case, the rocket planes are preferably heavily rigged with multiple video cameras, data acquisition systems and other capabilities designed to capture content in real time that can be produced live for display to end users whether they are on site viewing content on a large panel or hand-held displays, or on the other side of the world with a streaming video being pulled down from the World Wide Web. Programs for delayed viewing are, of course, also possible.

Within the variety of track shapes and collection of gates, there can be opportunity for pilots to gain extra points or suffer a penalty. Gains or losses preferably show up on the pilot's display as they are incurred, as well as on display means for the public. It is the general goal to be able to communicate to all viewer and end users of the content the real-time and race running summary of point gains and losses as the race progresses.

As may be the case with a physical gate suspended between two or more fixed points or airborne stations, should a physical string or ribbon-like element be cut, or not, can dictate whether the gate was properly passed and whether points are gained or lost. If, for example, it is required that the pilot passes beneath one gate that forms the beginning of the corner of the “L” and above the other, should the pilot sever the ribbon, points can be lost. Alternatively, the goal may be to sever the ribbon, and the absence of such action at, for example, the finish line would result in a penalty.

It is contemplated in an embodiment of the present invention that there exist multiple types of race series. In one scenario, all the rocket planes are identical and edge is gained through better piloting and energy management. In another scenario, competitive teams are allowed to draw from a mixed set of propulsion systems from a specified inventory in order to attain the mix that best meets their competitive strategy. At the far end of the spectrum is an unlimited class where competitors can bring vehicles to the competition that are of their own custom design as long as they meet basic criteria in, for example, safety, weight and propellant load.

It is further contemplated in embodiments of the present invention that a closed loop can be formed between the scoring elements of the competition and the rocket plane itself. For example, if the competition's rules authority sets a limit on the maximum acceleration, or “G's”, that can be pulled by a pilot as he traverses the course, should the G limit be exceeded, it can cause some physical adjustment to be imparted on the rocket plane itself. In one scenario, should the pilot violate the G limit, the system can be set up so that a certain amount of pressurant would be bled off resulting in a reduced performance potential for the rocket plane. Likewise, if points are gained by flying through a secondary gate that serves as an “extra point” the pilot can be given extra boost capability for a finite period of time. There are many other ways in which point gains or losses can be translated into vehicle performance gains or losses.

In yet another example, the pilot can be presented with a variety of virtual elements that he may “hit” during the race in order to gain extra points. By “hit” the pilot can be required to fly through the virtual element. Knowing the real-time position of the rocket plane and the equivalent three-dimensional position of the virtual element allows scoring officials and the viewing public, as well as other end users, to know whether the attempted hit is successful so that appropriate scoring and/or performance adjustments can be made. Hitting a virtual element may or may not translate into added performance potential. Such virtual elements or “cherries” can be scattered about the track and fixed, can vary with time, can vary with performance, can be controlled in whole or in part by race officials, the viewing public or the users, and/or can be purchased through sponsorship opportunities by corporations or other entities.

The invention also allows for private ownership of the rocket plane ships under a variety of propulsion packages, such that those people wishing to own a race vehicle may do so outside of the boundaries of the organization running the competitions. This can involve retrofitting the rocket plane with a piston engine only or turbojet only.

While the present invention has been described in connection with the illustrated embodiments, it may be appreciated and understood that modifications may be made without departing from the true spirit and scope of the invention. In particular, the invention may apply to various types of racing competitions, comprising races between vehicles on land, on water, in the air, and/or in outer space. In addition, the invention may apply to manned vehicles (human occupied) and to unmanned vehicles, such as remotely controlled vehicles.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A rocket powered vehicle comprising:
an airframe;
a propulsion module;
a propellant storage tank;
an avionics package; and
an entertainment platform.

2. The vehicle of claim 1 wherein said airframe is a winged airframe.

3. The vehicle of claim 1 further comprising a pressure fed propellant delivery system.

4. The vehicle of claim 1 further comprising a pump fed propellant delivery system.

5. The vehicle of claim 1 further comprising at least one pressurant to enhance rocket propulsion.

6. The vehicle of claim 1 wherein said entertainment platform comprises an onboard video network for transmitting streams of video to end users being entertained.

7. The vehicle of claim 1 wherein said entertainment platform comprises an augmented reality system that melds the real world with a virtual world.

8. The vehicle of claim 1 wherein said entertainment platform comprises audio collectors for transmitting sounds to end users being entertained.

9. The vehicle of claim 1 wherein said entertainment platform comprises biometric measurements of a pilot transmitted to end users being entertained.

10. (canceled)

11. (canceled)

12. The vehicle of claim 1 wherein said avionics package comprises virtual aids for monitoring at least one item selected from the group consisting of engine performance, flight dynamics, navigation, and competition.

13. The vehicle of claim 1 wherein said rocket propulsion module comprises different throttle positions.

14. The vehicle of claim 1 wherein said rocket propulsion module is selected from the group consisting of a liquid rocket engine, a solid fuel rocket engine, a hybrid rocket engine, a turbojet, a turbofan, a turboramjet, a ramjet, a scramjet, a propeller, and a turboprop.

15. The vehicle of claim 1 wherein said airframe comprises a housing for a pilot.

16. The vehicle of claim 1 comprising combinations of boost and glide during flight.

17. The vehicle of claim 1 comprising extended glide capability during flight.

18. The vehicle of claim 1 comprising at least two propulsion module applications selected from the group consisting of take-off, horizontal acceleration, vertical climb, high G acceleration, low G acceleration, sustain, landing, and taxi.

19. The vehicle of claim 1 further comprising a plume seeding system.

20. The vehicle of claim 1 further comprising a modulated thrust.

21. The vehicle of claim 1 further comprising an igniter for enhancement of thrust.
